(19) United States
(12) Patent Application Publication
(10) Pub. No.: US 2017/0185991 A1
(43) Pub. Date: Jun. 29, 2017

(54) MOBILE DEVICE AND OPERATING METHOD HEREOF

(71) Applicant: LG ELECTRONICS INC., Seoul (KR)

(72) Inventors: Jinhyoung PARK, Seoul (KR); Saeyoung AHN, Seoul (KR); Wonjoo PARK, Seoul (KR); Youngjun KIM, Seoul (KR); Eunjeong RYU, Seoul (KR)

(21) Appl. No.: 15/353,295

(22) Filed: Nov. 16, 2016

(30) Foreign Application Priority Data
Dec. 23, 2015 (KR) 10-2015-0185432
Dec. 29, 2015 (KR) 10-2015-0188237

(51) Int. Cl. G06Q 20/32; G06Q 20/10; G06Q 20/34; H04W 4/02

(52) U.S. Cl. CPC G06Q 20/3223; H04W 4/023; G06Q 20/10; G06Q 20/351

(57) ABSTRACT

An operating method of a mobile terminal includes determining a payment mode of the mobile terminal; and when the payment mode of the mobile terminal is a first mode for general transaction, performing a payment by using one-time payment information and when the payment mode of the mobile terminal is a second mode for provisional approval transaction, performing a payment by using fixed payment information.

### CROSS-REFERENCE TO RELATED APPLICATIONS

The present application claims priority under 35 U.S.C. 119 and 35 U.S.C. 365 to Korean Patent Application No. 10-2015-0185432 filed on Dec. 23, 2015 and Korean Patent Application No. 10-2015-0188237 filed on Dec. 29, 2015, which is hereby incorporated by reference in its entirety.

### BACKGROUND

The present disclosure relate to a mobile terminal for performing a payment by selectively using fixed payment information and one-time payment information and an operating method thereof.

As the mobile communications industry develops rapidly, a mobile terminal becomes the personal necessity. Accordingly, a mobile terminal gradually changes into a terminal for performing a complex function as including various additional functions besides conventional voice call and data communication functions.

With the development of society, as a payment means becomes free from cash in various transactions, various forms of credit payment means such as credit cards appear and with the development of mobile communications industry, techniques for utilizing a mobile communication terminal as a payment means by storing information relating to user's credit cards in the mobile communication terminal are widely suggested.

Additionally, in addition to online payment using a mobile terminal, offline payment using a mobile terminal that transmits payment information to a POS terminal directly, that is, mobile payment, is widely used recently.

Moreover, during offline payment using a mobile terminal, in order to protect credit card information or personal information, a method of generating one-time payment information with tokenization technique and transmitting it is utilized.

An offline payment method using such one-time payment information is beneficial for security reasons because a virtual card number is transmitted. However, since an offline payment method using one-time payment information has a structure in which one-time payment information is changed by a specific time unit, it is required to be completed within a specific time from the generation of one-time payment information to payment completion.

Accordingly, in relation to such an offline payment method using one-time payment information, an offline payment using a mobile terminal is impossible in a provisional approval payment system in which a provisional approval payment, a provisional approval payment cancellation, and an actual payment approval are accomplished with one-time payment information transmission.

Additionally, an offline payment method using a mobile terminal cannot be applied to a fee payment system of the current transportation means.

### SUMMARY

Embodiments provide a mobile terminal for performing a payment by selectively using fixed payment information and one-time payment information and an operating method thereof.

Embodiments also provide a mobile terminal for automatically performing a payment for a transportation means and an operating method thereof.

In one embodiment, an operating method of a mobile terminal includes: determining a payment mode of the mobile terminal; and when the payment mode of the mobile terminal is a first mode for general transaction, performing a payment by using one-time payment information and when the payment mode of the mobile terminal is a second mode for provisional approval transaction, performing a payment by using fixed payment information.

In another embodiment, a mobile terminal includes: a wireless communication unit configured to transmit payment information; and a control unit configured to determine a payment mode of the mobile terminal; and when the payment mode of the mobile terminal is a first mode for general transaction, perform a payment by using one-time payment information and when the payment mode of the mobile terminal is a second mode for provisional approval transaction, perform a payment by using fixed payment information.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a transaction method in a self gas station.

FIG. 2 is a block diagram illustrating a mobile terminal according to an embodiment of the present invention.

FIG. 3 is a flowchart illustrating a method of operating a mobile terminal according to an embodiment of the present invention.

FIG. 4 is a view illustrating an execution screen of a payment application.

FIG. 5 is a view illustrating a method of outputting a notification for representing that a payment method at a business where a mobile terminal is disposed is a provisional approval payment according to an embodiment of the present invention.

FIGS. 6 to 12 are views illustrating various user inputs for switching a payment mode of a mobile terminal to a second mode when the payment mode of the mobile terminal is a first mode.

FIG. 13 is a view illustrating a display screen of a mobile terminal that enters a second mode.

FIG. 14 is a view illustrating a mobile terminal where a UI corresponding to the business type of a business where a mobile terminal is disposed is displayed according to an embodiment of the present invention.

FIGS. 15A and 15B are views illustrating a display screen when information on a business where a mobile terminal is disposed is not stored according to an embodiment of the present invention.

FIGS. 16A and 16C are views illustrating a display screen when information on a business where a mobile terminal is disposed is not stored according to another embodiment of the present invention.

FIGS. 17A and 17C are views illustrating a method of newly registering a business where a payment is performed through a provisional approval payment method when information on a business where a mobile terminal is disposed is not stored according to another embodiment of the present invention.

FIG. 18 is a view illustrating a payment performing method according to an embodiment of the present invention.

FIG. 19 is a view illustrating a screen displayed when a payment is performed in a second mode according to an embodiment of the present invention.

FIGS. 20A and 20B are views illustrating a method of representing a payment expiration time according to an embodiment of the present invention.

FIGS. 21A to 21C are views illustrating an operating method of a mobile terminal when a payment is in progress in a second mode according to an embodiment of the present invention.

FIGS. 22A to 22C are views illustrating an operating method of a mobile terminal when a payment is cancelled in a second mode according to an embodiment of the present invention.

FIG. 23 is a flowchart illustrating an operating method of a mobile terminal according to an embodiment of the present invention.

FIG. 24 is a flowchart illustrating an operating method of a mobile terminal according to another embodiment of the present invention.

FIG. 25 is a view illustrating a method of obtaining information on a payment method of a business where a mobile terminal is disposed and a method of updating information on a business where a provisional approval payment is performed, according to an embodiment of the present invention.

FIG. 26 is a view illustrating an operating method of a mobile terminal when a transaction method of a business where a mobile terminal is disposed is a provisional approval transaction according to an embodiment of the present invention.

FIGS. 27 and 28 are views illustrating a method of performing a primary payment in a first mode for provisional approval transaction according to an embodiment of the present invention.

FIG. 29 is a view illustrating a method of obtaining information on a transaction method of a business where a mobile terminal is disposed by using a mobile receipt according to an embodiment of the present invention.

FIG. 30 is a view illustrating a method of outputting a notification for inducing a secondary payment according to an embodiment of the present invention.

FIG. 31 is a view illustrating a method of performing a secondary payment depending on a user's fingerprint authentication according to an embodiment of the present invention.

FIG. 32 is a view illustrating an authentication method for payment according to another embodiment of the present invention.

FIG. 33 is a view illustrating a method of inducing the tagging of a mobile terminal after an authentication for secondary payment is completed according to an embodiment of the present invention.

FIG. 34 is a view illustrating a tagging method for a secondary payment according to an embodiment of the present invention.

FIGS. 35A to 35B are views illustrating an operating method of a mobile terminal when a user leaves a place before a secondary payment is performed according to an embodiment of the present invention.

FIG. 36 is a view illustrating an operating method when location information of a mobile terminal is not obtained according to an embodiment of the present invention.

FIGS. 37A and 37B are views illustrating a shield device according to an embodiment of the present invention.

FIG. 38 is a flowchart illustrating an operating method of a mobile terminal according to an embodiment of the present invention.

FIG. 39 is a view illustrating a method for transmitting payment information for a provisional approval transaction to a transportation means according to an embodiment of the present invention.

FIGS. 40 and 41 are views illustrating a method of setting a destination of a transportation means according to an embodiment of the present invention.

FIG. 42 is a view illustrating a method of specifying a moving path of a transportation means according to an embodiment of the present invention.

FIG. 43 is a view illustrating a method of editing a path through which a transportation means moves according to an embodiment of the present invention.

FIG. 44 is a view illustrating a method of transmitting a destination or a moving path according to an embodiment of the present invention.

FIG. 45 is a view illustrating a screen displayed on a mobile terminal while a transportation means moves to a destination according to an embodiment of the present invention.

FIG. 46 is a view illustrating a method of changing at least one of the destination and moving path of a transportation means according to an embodiment of the present invention.

FIG. 47 is a view illustrating a display screen of a mobile terminal when a transportation means arrives at a destination according to an embodiment of the present invention.

FIG. 48 is a view illustrating a method of detecting the getting off of a mobile terminal and calculating a fee according to an embodiment of the present invention.

FIG. 49 is a view illustrating a mobile terminal where a usage fee of a transportation means is displayed according to an embodiment of the present invention.

FIGS. 50A and 50B are views illustrating a method of guiding a walking path to a destination according to an embodiment of the present invention.

FIG. 51 is a view illustrating a destination setting method according to another embodiment of the present invention.

FIG. 52 is a view illustrating an operating method of a mobile terminal according to another embodiment of the present invention.

FIG. 53 is a view illustrating a user of a mobile terminal boarding a transportation means.

FIG. 54 is a view illustrating an operating method when a user of a mobile terminal boards a transportation means.

FIG. 55 is a view illustrating a destination setting method when an itinerary management application is executed after a user boards a transportation means according to an embodiment of the present invention.

FIG. 56 is a view illustrating a method of providing information relating to a movement to a destination according to an embodiment of the present invention.

FIGS. 57 and 58 are views illustrating a method of charging an additional fee according to an embodiment of the present invention.

FIGS. 59A and 59B are views illustrating a method of providing a notification when a handicapped people boards according to an embodiment of the present invention.

FIG. 60 is a view illustrating a display screen of a mobile terminal when a transportation means arrives at a destination according to an embodiment of the present invention.

FIG. 61 is a view illustrating a method of detecting the getting off of a mobile terminal and calculating a fee according to an embodiment of the present invention.

FIG. 62 is a view illustrating a screen of a mobile terminal where a UI for setting an automatic payment is displayed.

FIGS. 63A and 63B are views illustrating a fee payment method according to another embodiment of the present invention.

### DETAILED DESCRIPTION OF THE EMBODIMENTS

Hereinafter, embodiments of the present invention are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present invention is not limited thereto. It should be understood that all of variations, equivalents or substitutes contained in the concept and technical scope of the present invention are also included.

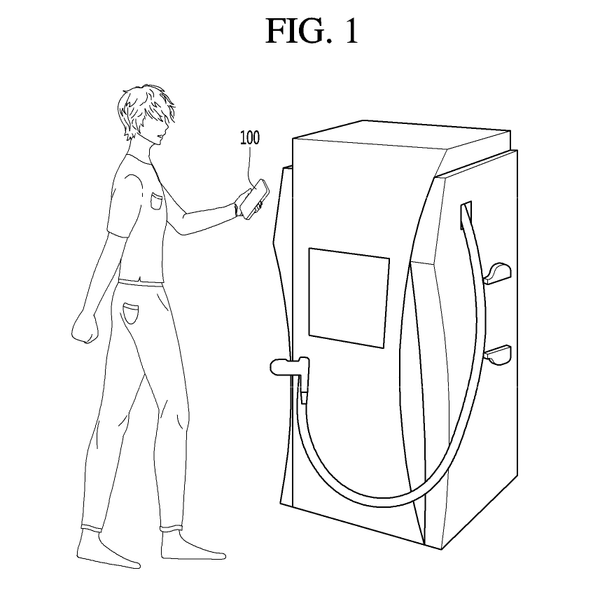

FIG. 1 is a view illustrating a transaction method in a self gas station.

Although a self gas station is described exemplarily with reference to FIG. 1, the present invention is not limited thereto.

In more detail, a transaction is performed at a gas station through a provisional transaction (for example, a provisional approval payment, a provisional approval payment cancellation, and an actual payment approval) method, such a transaction method may be used for a transportation means and a hotel in addition to a self gas station.

In relation to a general card payment system, when a purchaser requests a card payment, a seller requests the approval of a transaction for a payment amount from a card company, and when the card company approves the transaction, the card company pays money for the payment amount to the seller, and the card company charges the purchaser for the money for the payment amount. Hereinafter such a general card payment method is referred to as “a general transaction method” and described.

However, since a final payment amount is not determined at a self gas station, when a purchaser requests a card payment, a seller requests a transaction approval for a guarantee amount from a card company and when the purchaser has payment ability for the guarantee amount, the card company approves the transaction. Then, when the final payment amount is determined, the seller request the approval cancellation for the existing transaction-approved guarantee amount and the transaction approval for the final payment amount, and the card company cancels the approval for the existing transaction-approved guarantee amount and approves the final payment amount, so that the credit card payment is performed. Hereinafter, as in a self gas station, a payment method in which a provisional approval payment, a provisional approval payment cancellation, and an actual transaction approval are completed is referred to as “a provisional approval transaction method” and described.

Moreover, in relation to a payment method using one-time payment information, a mobile terminal generates one-time payment information including a token that is a one-time virtual card number and an authentication value linked to a payment time and transmits the generated one-time payment information to a POS terminal. That is, a card payment using a one time card (OTC) method is performed. Since such one-time payment information uses a virtual card number, there are advantages for security.

Such one-time payment information is renewed (or changed) at each specific time periodically and after a specific time elapses, new one-time payment information is generated and used for a payment. Accordingly, in order to apply a payment system using such one-time payment information at a self gas station, provisional approval payment, provisional approval payment cancellation, and actual transaction approval are all required to be completed within a specific time but this is impossible in reality.

Moreover, in an offline payment using a mobile terminal, a payment method using fixed payment information is also utilized. In a payment method using fixed payment information, a mobile terminal generates fixed payment information including a fixed token and transmits the generated fixed payment information to a POS terminal. Compared to a payment method using one-time payment information, such a payment method using fixed payment information may be somewhat venerable in terms of security, but may be utilized in a system in which provisional approval payment, provisional approval payment cancellation, and actual transaction approval are completed because a regular update at each specific time is not required. Furthermore, unlike a payment method using one-time payment information, in relation to a payment method using fixed payment information, since specific card information is replaced with fixed payment information corresponding to specific card information, mileage saving, membership service, and on-site discount are possible.

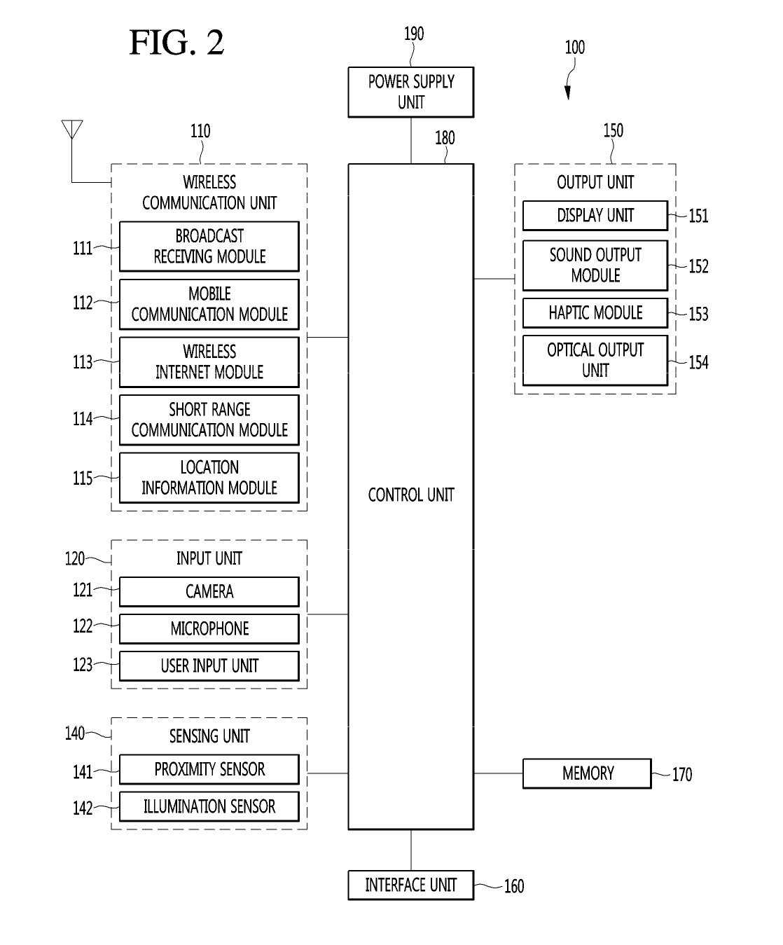

FIG. 2 is a block diagram illustrating a mobile terminal according to an embodiment of the present invention.

The mobile terminal 100 may include a wireless communication unit 110, an input unit 120, the sensing unit 140, an output unit 150, an interface unit 160, the memory 170, a control unit 180, and a power supply unit 190. In implementing a portable device, components shown in FIG. 1 are not necessary, so that a portable device described in this specification may include components less or more than the components listed above.

In more detail, the wireless communication unit 110 in the components may include at least one module allowing wireless communication between the mobile terminal 100 and a wireless communication system, between the mobile terminal 100 and another mobile terminal 100, or between the mobile terminal 100 and an external server. Additionally, the wireless communication unit 110 may include at least one module connecting the mobile terminal 100 to at least one network.

The wireless communication unit 110 may include at least one of a broadcast receiving module 111, a mobile communication module 112, a wireless internet module 113, a short-range communication module 114, and a location information module 115.

The input unit 120 may include a camera 121 or an image input unit for image signal input, a microphone 122 or an audio input unit for audio signal input, and a user input unit 123 (for example, a touch key and a mechanical key)) for receiving information from a user. Voice data or image data collected by the input unit 120 are analyzed and processed as a user's control command.

The sensing unit 140 may include at least one sensor for sensing at least one of information in a watch-type mobile terminal, environmental information around a watch-type mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, the camera 121), a microphone (for example, the microphone 122), a battery gauge, an environmental sensor (for example, a barometer, a hygrometer, a thermometer, a radiation sensor, a thermal sensor, and a gas sensor), and a chemical sensor (for example, an electronic noise, a healthcare sensor, and a biometric sensor). Moreover, the mobile terminal 100 disclosed in this specification may combine information sensed by at least two or more sensors among such sensors and may then utilize it.

The output unit 150 is used to generate a visual, auditory, or haptic output and may include at least one of a display unit 151, a sound output unit 152, a haptic module 153, and an optical output unit 154. The display unit 151 may be formed with a mutual layer structure with a touch sensor or formed integrally, so that a touch screen may be implemented. Such a touch screen may serve as the user input unit 123 providing an input interface between the mobile terminal 100 and a user and an output interface between the mobile terminal 100 and a user at the same time.

The interface unit 160 may serve as a path to various kinds of external devices connected to the mobile terminal 100. The interface unit 160 may include at least one of a wired/wireless headset port, an external charger port, a wired/wireless data port, a memory card port, a port connecting a device equipped with an identification module, an audio Input/Output (I/O) port, a video I/O port, and an earphone port. In correspondence to that an external device is connected to the interface unit 160, the mobile terminal 100 may perform an appropriate control relating to the connected external device.

Additionally, the memory 170 may store data supporting various functions of the mobile terminal 100. The memory 170 may store a plurality of application programs (for example, application programs or applications) running on the mobile terminal 100 and also data and commands for operations of the mobile terminal 100. At least part of such an application program may be downloaded from an external server through a wireless communication. Additionally, at least part of such an application program may be included in the mobile terminal 100 from the time of shipment in order to perform a basic function (for example, an incoming call, a transmission function, and a message reception) of the mobile terminal 100. Moreover, an application program may be stored in the memory 170 and installed on the mobile terminal 100, so that it may run to perform an operation (or a function) of the mobile terminal 100 by the control unit 180.

The control unit 180 may control overall operations of the mobile terminal 100 generally besides an operation relating to the application program. The control unit 180 may provide appropriate information or functions to a user or process them by processing signals, data, and information inputted/outputted through the above components or executing application programs stored in the memory 170.

Additionally, in order to execute an application program stored in the memory 170, the control unit 180 may control at least part of the components shown in FIG. 1. Furthermore, in order to execute the application program, the control unit 180 may combine at least two of the components in the mobile terminal 100 and may then operate it.

The power supply unit 190 may receive external power or internal power under a control of the control unit 180 and may then supply power to each component in the mobile terminal 100. The power supply unit 190 includes a battery and the battery may be a built-in battery or a replaceable battery.

At least part of the each component may operate cooperatively in order to implement operations, controls, or control methods of a mobile terminal 100 according to various embodiments of the present invention described below. Additionally, the operations, controls, or control methods of a mobile terminal 100 may be implemented on the mobile terminal 100 by executing at least one application program stored in the memory 170.

Hereinafter, prior to examining various embodiments implemented through the mobile terminal 100, the above-listed components are described in more detail with reference to FIG. 1.

First, in describing the wireless communication unit 110, the broadcast receiving module 111 of the wireless communication unit 110 may receive a broadcast signal and/or broadcast related information from an external broadcast management server through a broadcast channel. The broadcast channel may include a satellite channel and a terrestrial channel. At least two broadcast receiving modules for simultaneous broadcast reception for at least two broadcast channels or broadcast channel switching may be provided to the mobile terminal 100.

The mobile communication module 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless signal may include various types of data according to a voice call signal, a video call signal, or text/multimedia message transmission.

The wireless internet module 113 refers to a module for wireless internet access and may be built in or external to the mobile terminal 100. The wireless internet module 113 may be configured to transmit/receive a wireless signal in a communication network according to wireless internet technologies.

The wireless internet technology may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A) and the wireless internet module 113 transmits/receives data according at least one wireless internet technology including internet technology not listed above.

From the viewpoint that wireless internet access by WiBro, HSDPA, HSUPA, GSM, CDMA, WCDMA, LTE, and LTE-A is achieved through a mobile communication network, the wireless internet module 113 performing wireless internet access through the mobile communication network may be understood as one type of the mobile communication module 112.

The short-range communication module 114 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, Wireless Universal Serial Bus (USB), and magnetic security transmission (MST) method technologies.

Herein, the MST method is a system for converting information in the mobile terminal 100 into a magnetic field and transmitting it. For example, when the mobile terminal 100 is tagged to a POS terminal, payment information of the mobile terminal 100 may be converted into a magnetic field and transmitted to a POS terminal.

The short-range communication module 114 may support wireless communication between the mobile terminal 100 and a wireless communication system, between the mobile terminal 100 and another mobile terminal 100, or between networks including the mobile terminal 100 and another mobile terminal 100 (or an external server) through wireless area networks. The wireless area networks may be wireless personal area networks.

The short-range communication module 114 may detect (or recognize) another mobile device around the mobile terminal 100, which is capable of communicating with the mobile terminal 100. Furthermore, if the other mobile terminal is a device authenticated to communicate with the mobile terminal 100, the control unit 180 may transmit at least part of data processed in the mobile terminal 100 to the other mobile terminal through the short-range communication module 114. Accordingly, a user of the other mobile terminal may use the data processed in the mobile terminal 100 through another mobile terminal. For example, according thereto, when a call is received by the mobile terminal 100, a user may take a phone call through another mobile terminal or when a message is received by the mobile terminal 100, a user may check the received message through another mobile terminal.

The location information module 115 is a module for obtaining the location (or the current location) of a mobile terminal and its representative examples include a global positioning system (GPS) module or a Wi-Fi module. For example, the mobile terminal may obtain its position by using a signal transmitted from a GPS satellite through the GPS module. As another example, the mobile terminal may obtain its position on the basis of information of a wireless access point (AP) transmitting/receiving a wireless signal to/from the Wi-Fi module, through the Wi-Fi module. If necessary, the position information module 115 may perform a function of another module in the wireless communication unit 110 in order to obtain data on the location of the mobile terminal substitutionally or additionally. The location information module 115 is a module for obtaining the position (or the current position) of the mobile terminal and is not limited to a module directly calculating and obtaining the position of the mobile terminal.

Then, the input unit 120 is used for inputting image information (or signal), audio information (or signal), data, or information inputted from a user and the mobile terminal 100 may include at least one camera 121 in order for inputting image information. The camera 121 processes image frames such as a still image or a video obtained by an image sensor in a video call mode or a capturing mode. The processed image frame may be displayed on the display unit 151 or stored in the memory 170. Moreover, a plurality of cameras 121 equipped in the mobile terminal 100 may be arranged in a matrix structure and through the camera 121 having such a matrix structure, a plurality of image information having various angles or focuses may be inputted to the input terminal 100. Additionally, the plurality of cameras 121 may be arranged in a stereo structure to obtain the left and right images for implementing a three-dimensional image.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and when information is inputted through the user input unit 123, the control unit 180 may control an operation of the mobile terminal 100 to correspond to the inputted information. The user input unit 123 may include a mechanical input means (or a mechanical key, for example, a button, a dome switch, a jog wheel, and a jog switch at the front/back or side of the mobile terminal 100) and a touch type input means. As one example, a touch type input means may include a virtual key, a soft key, or a visual key, which is displayed on a touch screen through software processing or may include a touch key disposed at a portion other than the touch screen. Moreover, the virtual key or visual key may have various forms and may be disposed on a touch screen and for example, may include graphic, text, icon, video, or a combination thereof.

The sensing unit 140 may sense at least one of information in a mobile terminal, environmental information around a mobile terminal, and user information and may then generate a sensing signal corresponding thereto. On the basis of such a sensing signal, the control unit 180 may control the drive or control of the mobile terminal 100 or may perform data processing, functions, or operations relating to an application program installed in the mobile terminal 100. Representative sensors among various sensors included in the sensing unit 140 will be described in more detail.

First, the proximity sensor 141 refers to a sensor detecting whether there is an object approaching a predetermined detection surface or whether there is an object around by using the strength of an electromagnetic field or infrared, without mechanical contact. The proximity sensor 141 may disposed in an inner area of a mobile terminal surrounded by the touch screen or around the touch screen.

Examples of the proximity sensor 141 may include a transmission-type photoelectric sensor, a direct reflective-type photoelectric sensor, a mirror reflective-type photoelectric sensor, a high-frequency oscillation-type proximity sensor, a capacitive-type proximity sensors, a magnetic-type proximity sensor, and an infrared proximity sensor. If the touch screen is a capacitive type, the proximity sensor 141 may be configured to detect the proximity of an object by changes in an electric field according to the proximity of the object having conductivity. In this case, the touch screen (or a touch sensor) itself may be classified as a proximity sensor.

Moreover, for convenience of description, an action for recognizing the position of an object on the touch screen as the object is close to the touch screen without contacting the touch screen is called “proximity touch” and an action that the object actually contacts the touch screen is called “contact touch”. A position that an object is proximity-touched on the touch screen is a position that the object vertically corresponds to the touch screen when the object is proximity-touched. The proximity sensor 141 may detect a proximity touch and a proximity touch pattern (for example, a proximity touch distance, a proximity touch direction, a proximity touch speed, a proximity touch time, a proximity touch position, and a proximity touch movement state). Moreover, the control unit 180 processes data (for information) corresponding to a proximity touch operation and a proximity touch pattern, detected through the proximity sensor 141, and furthermore, may output visual information corresponding to the processed data on the touch screen. Furthermore, according to whether a touch for the same point on the touch screen is a proximity touch or a contact touch, the control unit 180 may control the mobile terminal 100 to process different operations or data (or information).

The touch sensor 142 detects a touch (or a touch input) applied to the touch screen (or the display unit 151) by using at least one of various touch methods, for example, a resistive film method, a capacitive method, an infrared method, an ultrasonic method, and a magnetic field method.

For example, the touch sensor 142 may be configured to convert a pressure applied to a specific portion of the touch screen or changes in capacitance occurring at a specific portion into electrical input signals. The touch sensor 142 may be configured to detect a position and area that a touch target applying a touch on the touch screen touches the touch sensor 142, a pressured when touched, and a capacitance when touched. Here, the touch target, as an object applying a touch on the touch sensor, may be a finger, a touch pen, a stylus pen, or a pointer, for example.

In such a way, when there is a touch input on the touch sensor 142, signal(s) corresponding thereto is/are sent to a touch controller. The touch controller processes the signal(s) and then transmits corresponding data to the control unit 180. Therefore, the control unit 180 may recognize which area of the display unit 151 is touched. Herein, the touch controller may be an additional component separated from the control unit 180 or may be the control unit 180 itself.

Moreover, the control unit 180 may perform different controls or the same control according to types of a touch target touching the touch screen (or a touch key equipped separated from the touch screen). Whether to perform different controls or the same control according to types of a touch target may be determined according to a current operation state of the watch-type mobile terminal 100 or an application program in execution.

Moreover, the above-mentioned touch sensor 142 and proximity sensor 141 are provided separately or combined and may thus sense various types of touches, for example, short (or tap) touch), long touch, multi touch, drag touch, flick touch, pinch-in touch, pinch-out touch, swipe touch, and hovering touch on the touch screen.

The sensing unit 140 may include various sensing means such as a gravity sensor, a geomagnetic sensor, a gyro sensor, an acceleration sensor, an inclination sensor, an altitude sensor, a depth sensor, a gyroscope sensor, an angular velocity sensor, and a GPS sensor.

Moreover, the camera 121 described as a configuration of the input unit 120 may include at least one of a camera sensor (for example, CCD and CMOS), a photo sensor (or an image sensor), and a laser sensor.

The camera 121 and the laser sensor may be combined to detect a touch of a detection target for a three-dimensional image. The photo sensor may be stacked on a display device and is configured to scan a movement of a detection target close to the touch screen. In more detail, the photo sensor mounts a photo diode and a transistor (TR) in a row/column and scans content disposed on the photo sensor by using an electrical signal changing according to an amount of light applied to the photo diode. That is, the photo sensor may calculate the coordinates of a detection target according to the amount of change in light and through this, may obtain the position information of the detection target.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The sound output unit 152 may output audio data received from the wireless communication unit 110 or stored in the memory 170 in a call signal reception or call mode, a recording mode, a voice recognition mode, or a broadcast reception mode. The sound output unit 152 may output a sound signal relating to a function (for example, a call signal reception sound and a message reception sound) performed by the mobile terminal 100. The sound output unit 152 may include a receiver, a speaker, and a buzzer.

The haptic module 153 generates various haptic effects that a user can feel. A representative example of a haptic effect that the haptic module 153 generates is vibration. The intensity and pattern of vibration generated by the haptic module 153 may be controlled by a user's selection or a setting of a control unit. For example, the haptic module 153 may synthesize and output different vibrations or output different vibrations sequentially.

The haptic module 153 may generate various haptic effects, for example, effects by a pin arrangement moving vertical to a contact skin surface, injection power or suction power of air through an injection port or a suction port, rubbing a skin surface, electrode contact, stimulus of electrostatic force and effects by the reproduction of cold/warm sense by using a device absorbing or emitting heat.

The haptic module 153 may be implemented to deliver a haptic effect through a direct contact and also allow a user to feel a haptic effect through a muscle sense such as a finger or an arm. The haptic module 153 may be more than two according to a configuration aspect of the mobile terminal 100.

The optical output unit 154 outputs a signal for notifying event occurrence by using light of a light source of the mobile terminal 100. An example of an event occurring in the mobile terminal 100 includes message reception, call signal reception, missed calls, alarm, schedule notification, e-mail reception, and information reception through an application.

A signal outputted from the optical output unit 154 is implemented as a mobile terminal emits single color of multi-color to the front or the back. The signal output may be terminated when a mobile terminal detects user's event confirmation.

The interface unit 160 may serve as a path to all external devices connected to the mobile terminal 100. The interface unit 160 may receive data from an external device, receive power and deliver it to each component in the mobile terminal 100, or transmit data in the mobile terminal 100 to an external device. For example, the interface unit 160 may include a wired/wireless headset port, an external charger port, a wired/wireless data port, a memory card port, a port connecting a device equipped with an identification module, an audio I/O port, a video I/O port, and an earphone port.

Moreover, the identification module, as a chip storing various information for authenticating usage authority of the mobile terminal 100, may include a user identity module (UIM), a subscriber identity module (SIM), and a universal subscriber identity module (USIM). A device equipped with an identification module (hereinafter referred to as an identification device) may be manufactured in a smart card form. Accordingly, the identification device may be connected to the terminal 100 through the interface unit 160.

Additionally, when the mobile terminal 100 is connected to an external cradle, the interface unit 160 may become a path through which power of the cradle is supplied to the mobile terminal 100 or a path through which various command signals inputted from the cradle are delivered to the mobile terminal 100 by a user. The various command signals or the power inputted from the cradle may operate as a signal for recognizing that the mobile terminal 100 is accurately mounted on the cradle.

The memory 170 may store a program for an operation of the control unit 180 and may temporarily store input/output data (for example, a phone book, a message, a still image, and a video). The memory 170 may store data on various patterns of vibrations and sounds outputted during a touch input on the touch screen.

The memory 170 may include at least one type of storage medium among flash memory type, hard disk type, Solid State Disk (SSD) type, Silicon Disk Drive (SDD) type, multimedia card micro type, card type memory (for example, SD or XD memory type), random access memory (RAM) type, static random access memory (SRAM) type, read-only memory (ROM) type, electrically erasable programmable read-only memory (EEPROM) type, programmable read-only memory (PROM) type, magnetic memory type, magnetic disk type, and optical disk type. The mobile terminal 100 may operate in relation to a web storage performing a storage function of the memory 170 on internet.

Moreover, as mentioned above, the control unit 180 may control operations relating to an application program and overall operations of the mobile terminal 100 in general. For example, if a state of the mobile terminal 100 satisfies set conditions, the control unit 180 may execute or release a lock state limiting an output of a control command of a user for applications.

Additionally, the control unit 180 may perform a control or processing relating to a voice call, data communication, and a video call may perform pattern recognition processing for recognizing handwriting input or drawing input on the touch screen as a text and an image, respectively. Furthermore, the control unit 180 may use at least one or a combination of the above components to perform a control in order to implement various embodiments described below on the watch-type mobile terminal 100.

The power supply unit 190 may receive external power or internal power under a control of the control unit 180 and may then supply power necessary for an operation of each component. The power supply unit 190 includes a battery. The battery is a rechargeable built-in battery and may be detachably coupled to a terminal body in order for charging.

Additionally, the power supply unit 190 may include a connection port and the connection port may be configured as one example of the interface unit 160 to which an external charger supplying power for charging of the battery is electrically connected.

As another example, the power supply unit 190 may be configured to charge a battery through a wireless method without using the connection port. In this case, the power supply unit 190 may receive power from an external wireless power transmission device through at least one of an inductive coupling method based on a magnetic induction phenomenon, and a magnetic resonance coupling method based on an electromagnetic resonance phenomenon.

Then, a communication system using the mobile terminal 100 is described according to an embodiment of the present invention.

First, the communication system may use different wireless interfaces and/or physical layers. For example, a wireless interface available to the communication system may include Frequency Division Multiple Access (FDMA), Time Division Multiple Access (TDMA), Code Division Multiple Access (CDMA), and Universal Mobile Telecommunications Systems (UMTS) (especially, Long Term Evolution (LTE), Long Term Evolution-Advanced (LTE-A), and Global System for Mobile Communications (GSM)).

Hereinafter, for convenience of description, description is performed limited to CDMA. However, it is apparent that the present invention is applicable to all communication systems including Orthogonal Frequency Division Multiplexing (OFDM) wireless communication systems in addition to CDMA wireless communication systems.

The CDMA wireless communication system may include at least one terminal 100, at least one base station (BS) (it may be referred to as Node B or Evolved Node B), at least one base station controllers (BSCs), and a mobile switching center (MSC). MSC may be configured to be connected to Public Switched Telephone Network (PSTN) and BSCs. BSCs may be connected being paired with a BS through a backhaul line. The backhaul line may be provided according to at least one of E1/T1, ATM, IP, PPP, Frame Relay, HDSL, ADSL, and xDSL. Accordingly, a plurality of BSCs may be included in a CDMA wireless communication system.

Each of a plurality of BSs may include at least one sensor and each sensor may include an omni-directional antenna or an antenna indicating a specific radial direction from a BS. Additionally, each sensor may include at least two antennas in various forms. Each BS may be configured to support a plurality of frequency allocations and each of the plurality of frequency allocations may have a specific spectrum (for example, 1.25 MHz, 5 MHz, and so on).

The intersection of a sector and a frequency allocation may be referred to as a CDMA channel. A BS may be referred to as a Base Station Transceiver Subsystem (BTS). In such a case, one BSC and at least one BS together may be referred to as “BS”. A BS may also represent “cell site”. Additionally, each of a plurality of sectors for a specific BS may be referred to as a plurality of cell sites.

A Broadcasting Transmitter (BT) transmits broadcast signals to the terminals 100 operating in a system. The broadcast reception module 111 shown in FIG. 1 is provided in the terminal 100 for receiving broadcast signals transmitted from the BT.

Additionally, GPS may be linked to a CDMA wireless communication system in order to check the location of the mobile terminal 100. Then, a satellite helps obtaining the location of the mobile terminal 100. Useful location information may be obtained by at least one satellite. Herein, the location of the mobile terminal 100 may be traced by using all techniques for tracing the location in addition to GPS tracking technique. Additionally, at least one GPS satellite may be responsible for satellite DMB transmission selectively or additionally.

The location information module 115 in a mobile terminal is for detecting and calculating the position of the mobile terminal and its representative example may include a GPS module and a WiFi module. If necessary, the position information module 115 may perform a function of another module in the wireless communication unit 110 in order to obtain data on the location of the mobile terminal substitutionally or additionally.

The GPS module 115 may calculate information on a distance from at least three satellites and accurate time information and then apply triangulation to the calculated information, in order to accurately calculate the 3D current location information according to latitude, longitude, and altitude. A method for calculating location and time information by using three satellites and correcting errors of the calculated location and time information by using another one satellite is being widely used. Additionally, the GPS module 115 may speed information as continuously calculating the current location in real time. However, it is difficult to accurately measure the location of a mobile terminal by using a GPS module in a shadow area of a satellite signal such as a room. Accordingly, in order to compensate for the measurement of a GPS method, a WiFi Positioning System (WPS) may be utilized.

WPS is a technique for tracking the location of the mobile terminal 100 by using a WiFi module in the mobile terminal 100 and a wireless Access Point (AP) for transmitting or receiving wireless signals to or from the WiFi module and may mean a Wireless Local Area Network (WLAN) based location measurement technique using WiFi.

A WiFi location tracking system may include a WiFi location measurement server, a mobile terminal 100, a wireless AP connected to the mobile terminal 100, and a database for storing arbitrary wireless AP information.

The mobile terminal 100 in access to a wireless AP may transmit a location information request message to a WiFi location measurement server.

The WiFi location measurement server extracts information of a wireless AP connected to the mobile terminal 100 on the basis of a location information request message (or signal) of the mobile terminal 100. Information of a wireless AP connected to the mobile terminal 100 may be transmitted to the WiFi location measurement server through the mobile terminal 100 or may be transmitted from a wireless AP to a WiFi location measurement server.

Based on the location information request message of the mobile terminal 100, the extracted information of a wireless AP may be at least one of MAC Address, Service Set Identification (SSID), Received Signal Strength Indicator (RSSI), Reference Signal Received Power (RSRP), Reference Signal Received Quality (RSRQ), channel information, Privacy, Network Type, Signal Strength, and Noise Strength.

As mentioned above, the WiFi position measurement server may extract wireless AP information corresponding to a wireless AP that the mobile terminal 100 access from a pre-established database by using information of the wireless AP connected to the mobile terminal 100. At this point, information of arbitrary wireless APs stored in the database may information such as MAC Address, SSID, channel information, Privacy, Network Type, latitude and longitude coordinates of a wireless AP, a building name where a wireless AP is located, the number of floors, indoor detailed location (GPS coordinates available), the address of the owner of an AP, and phone numbers. At this point, in order to remove a mobile AP or a wireless AP provided using illegal MAC address during a measurement process, a WiFi location measurement server may extract only a predetermined number of wireless AP information in high RSSI order.

Then, the WiFi location measurement server may extract (or analyze) the location information of the mobile terminal 100 by using at least one wireless AP information extracted from the database. By comparing the included information and the received wireless AP information, location information of the mobile terminal 100 is extracted (or analyzed).

As a method of extracting (or analyzing) the location information of the motile terminal 100, a Cell-ID method, a finger-print method, a triangulation method, and a landmark method may be used.

The Cell-ID method is a method for determining the location of a wireless AP having the strongest signal intensity in neighbor wireless AP information that a mobile terminal collects as the location of the mobile terminal. Implementation is simple, no additional cost is required, and location information is obtained quickly but when the installation density of wireless APs is low, measurement precision is poor.

The finger-print method is a method for collecting signal intensity information by selecting a reference location from a service area and estimating the location through signal intensity information transmitted from a mobile terminal on the basis of the collected information. In order to use the finger-print method, there is a need to provide a database for storing propagation characteristics in advance.

The triangulation method is a method for calculating the location of a mobile terminal on the basis of a distance between coordinates of at least three wireless APs and a mobile terminal. In order to measure a distance between a mobile terminal and a wireless AP, a signal intensity converted into distance information, Time of Arrival (ToA), Time Difference of Arrival (TDoA), and Angle of Arrival (AoA) may be used.

The landmark method is a method for measuring the location of a mobile terminal by using a landmark transmitter knowing the location.

In addition to the listed methods, a variety of algorithms may be utilized as methods for extracting (or analyzing) the location information of a mobile terminal.

As the extracted location information of the mobile terminal 100 is transmitted to the mobile terminal 100 through the WiFi location measurement server, the mobile terminal 100 may obtain the location information.

As connected to at least one wireless AP, the mobile terminal 100 may obtain location information. At this point, the number of wireless APs, which are required for obtaining the location information of the mobile terminal 100, may vary according to a wireless communication environment where the mobile terminal 100 is located.

Moreover, various embodiments below may be implemented in a computer or device similar thereto readable medium by using software, hardware, or a combination thereof.

Furthermore, the memory unit 240 and the term “storage unit” may be interchangeably used.

Additionally, the mobile terminal 100 may be a wearable device and may be a watch type mobile terminal among wearable devices.

Moreover, the input unit 120 may further include a sensing unit 140 for sensing a user's input on a touch screen besides the camera 121, the microphone 122, and the user input 123.

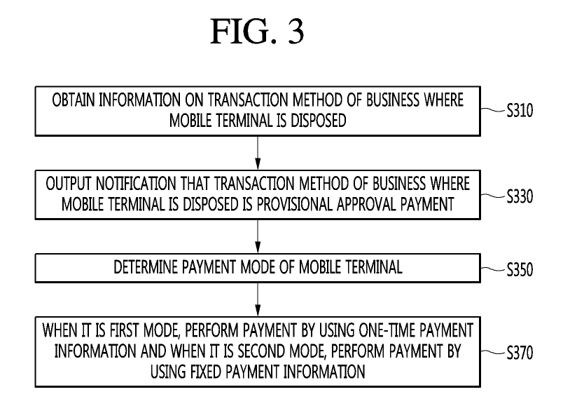

FIG. 3 is a flowchart illustrating an operating method of a mobile terminal according to an embodiment of the present invention.

An operating method of a mobile terminal according to an embodiment of the present invention includes: obtaining information on a transaction method at a business where a mobile terminal is disposed on the basis of at least one of coordinates information of the mobile terminal and signal information received by the mobile terminal in operation S310; outputting, when the transaction method at the business where the mobile terminal is disposed is a provisional approval transaction, a notification notifying that the transaction method at the business where the mobile terminal is disposed is the provisional approval transaction in operation S330; determining a mode for performing a payment by the mobile terminal in operation 5350; and when a mode of the mobile terminal is the first mode for general transaction, performing a payment by using one-time payment information and when the mode of the mobile terminal is the second mode for a provisional approval transaction, performing a payment by using fixed payment information in operation 5370.

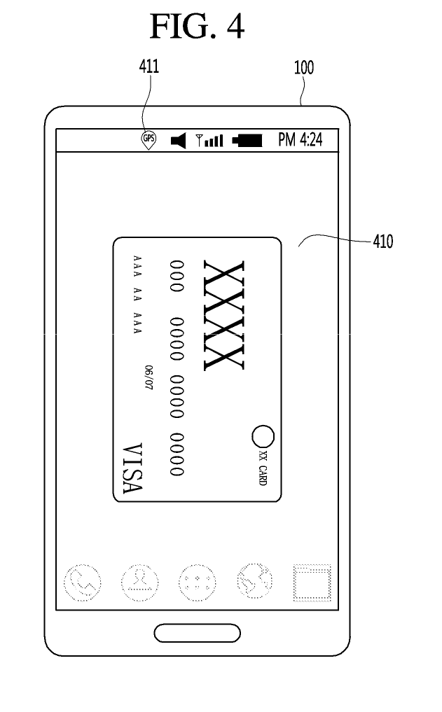

Among them, obtaining information on a transaction at a business where a mobile terminal is disposed on the basis of at least one of location information of the mobile terminal and signal information received by the mobile terminal operation S310 is described in more detail with reference to FIG. 4.

FIG. 4 is a view illustrating an execution screen of a payment application.

When an input for executing a payment application is received, the control unit 180, as shown in FIG. 4, executes a payment application and display an execution screen 410 of the payment application.

Moreover, in order to obtain information on the coordinates of the mobile terminal 100, the control unit 180 may turn on a GPS function of the mobile terminal 100 as executing the payment application, and display a UI 411 for representing that the GPS function is activated.

In this case, the control unit 180 may obtain the coordinates information of the mobile terminal 100 through the wireless communication unit 110.

Moreover, in order to receive a wireless signal transmitted from a business where the mobile terminal 100 is disposed, the control unit 180 may turn on a wireless signal reception function of the mobile terminal and display a UI for representing that the wireless signal reception function is activated.

In this case, the control unit 180 may receive a wireless signal transmitted from a business where the mobile terminal 100 is disposed through the wireless communication unit 110. Herein, a wireless signal transmitted from the business where the mobile terminal 100 is disposed, as a wireless signal including identification information of the business where the mobile terminal 100 is disposed, may be a beacon signal. However, the present invention is not limited thereto and a wireless signal transmitted from the business where the mobile terminal 100 is disposed may include at least one of a Bluetooth™ signal, a Radio Frequency Identification (RFID) signal, an Infrared Data Association (IrDA) signal, an Ultra Wideband (UWB) signal, a ZigBee signal, a Near Field Communication (NFC) signal, a Wireless-Fidelity (Wi-Fi) signal, a Wi-Fi Direct signal, and a Wireless Universal Serial Bus (USB) signal.

Moreover, the control unit 180 may obtain information on a payment method at a business where the mobile terminal 100 is disposed on the basis of at least one of coordinates information of the mobile terminal 100 and signal information received by the mobile terminal 100.

Herein, a “business” may mean a seller that provides goods or services to card users and a seller paid for goods or services from a card company that card users subscribe. For example, when a user of the mobile terminal 100 fills up a vehicle with gas at a self gas station, a “business” may be the self gas station.

The control unit 180 may receive information on a business where a provisional approval payment is performed from a server (not shown) and store the received information in the storage unit 170. Herein, the information on a business where a provisional approval payment is performed may include at least one of coordinates information of a plurality of businesses where a provisional approval payment is performed and identification information of a plurality of businesses where a provisional approval payment is performed.

In this case, the control unit 180 compares coordinates information of the mobile terminal 100 with coordinates information of a plurality of businesses where a provisional approval payment is performed, thereby obtaining information on a payment method at a business where the mobile terminal 100 is disposed. For example, when the coordinates information of the current mobile terminal 100 matches the coordinates information of a specific business among a plurality of businesses where a provisional approval payment is performed, the control unit 180 may determine that the payment is performed at the business where the current mobile terminal 100 is disposed through a provisional approval payment method. As another example, when the coordinates information of the current mobile terminal 100 does not match the coordinates information of a specific business among a plurality of businesses where a provisional approval payment is performed, the control unit 180 may determine that the payment is performed at the business where the current mobile terminal 100 is disposed through a general payment method.

Additionally, when the mobile terminal 100 receives a wireless signal including identification information of a business, the control unit 180 compares the received identification information of the business with identification information of a plurality of businesses where a provisional approval payment is performed, thereby obtaining information on a payment method at the business where the mobile terminal 100 is disposed.

Moreover, although it is described that the mobile terminal 100 receives information on a business where a provisional approval payment is performed in advance and stores it, the present invention is not limited thereto.

For example, when a payment application is executed, the control unit 180 may transmit, to a server (not shown), at least one of coordinates information obtained by the mobile terminal 100 and identification information of a business received by the mobile terminal 100. In this case, the server (not shown) obtains information on a payment method of a business where the mobile terminal 100 is disposed by using coordinates information of a plurality of businesses where a provisional approval payment is performed and transmits the obtained information to the mobile terminal 100, which are databased in advance. Additionally, the server (not shown) obtains information on a payment method of a business where the mobile terminal 100 is disposed by using coordinates information, which is databased in advance, of a plurality of businesses where a provisional approval payment is performed and transmits the obtained information to the mobile terminal 100. In this case, the mobile terminal 100 may obtain information on a payment method at a business where the mobile terminal 100 is disposed by receiving information on a payment method of a business where the mobile terminal 100 is disposed from a server.

Moreover, although it is described that information on a payment method of a business where the mobile terminal 100 is disposed is obtained in this embodiment, the present invention is not limited thereto. For example, the control unit 180 may be implantable through a method of obtaining information on a payment method of a POS terminal that is the closest to the mobile terminal 100.

In more detail, the control unit 180 may receive information on a POS terminal where a provisional approval payment is performed from a server (not shown) and store the received information in the storage unit 170. Herein, the information on a POS terminal where a provisional approval payment is performed may include at least one of coordinates information of a plurality of POS terminals where a provisional approval payment is performed and identification information of a plurality of POS terminals where a provisional approval payment is performed.

In this case, the control unit 180 compares coordinates information of the mobile terminal 100 with coordinates information of a plurality of POS terminals where a provisional approval payment is performed, thereby obtaining information on a payment method at a business where the mobile terminal 100 is disposed.

Additionally, when the mobile terminal 100 receives a wireless signal including identification information of a POS terminal, the control unit 180 compares the received identification information of the POS terminal with identification information of a plurality of POS terminals where a provisional approval payment is performed, thereby obtaining information on a payment method at the business where the mobile terminal 100 is disposed.

Additionally, when a payment application is executed, the control unit 180 may transmit, to a server (not shown), at least one of coordinates information obtained by the mobile terminal 100 and identification information of a POS terminal received by the mobile terminal 100. In this case, the server (not shown) obtains information on a payment method of a POS terminal around the mobile terminal 100 by using at least one of coordinates of a plurality of POS terminals where a provisional approval payment is performed and identification information of a plurality of POS terminals where a provisional approval payment is performed, which are databased in advance. In this case, the mobile terminal 100 may obtain information on a payment method of a POS terminal around the mobile terminal 100 by receiving information on a payment method of a POS terminal around the mobile terminal 100.

Referring to FIG. 3 again, according to an embodiment of the present invention, an operating method of a mobile terminal may include when a payment method at a business where a mobile terminal is disposed is a provisional approval payment, outputting a notification for representing that a payment method at a business where a mobile terminal is disposed is a provisional approval payment in operation S330.

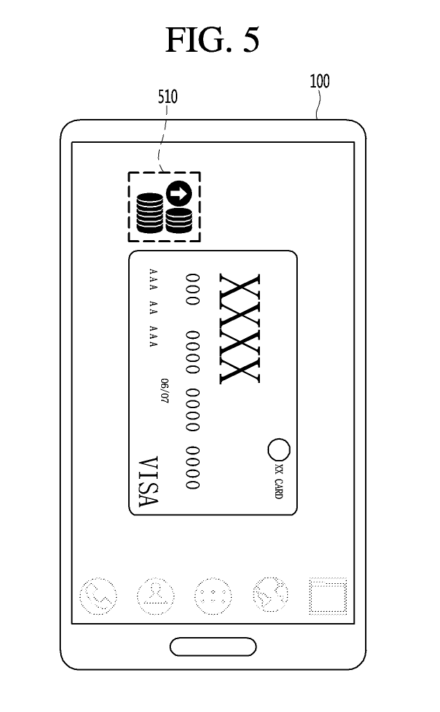

In relation to this, it will be described in detail with reference to FIG. 5.

FIG. 5 is a view illustrating a method of outputting a notification for representing that a payment method at a business where a mobile terminal is disposed is a provisional approval payment according to an embodiment of the present invention.

When a payment method at a business where the mobile terminal 100 is disposed is a provisional approval payment, the control unit 180 may display a UI 510 for representing that the payment method at the business where the mobile terminal 100 is disposed is the provisional approval payment.

However, the present invention is not limited thereto, and the control unit 180 may output a sound for representing a payment method at a business where the mobile terminal 100 is disposed is a provisional approval payment or output a vibration for representing that a payment method at a business where the mobile terminal 100 is disposed is a provisional approval payment.

Referring to FIG. 3 again, an operating method of a mobile terminal according to an embodiment of the present invention may include determining, by the mobile terminal a mode for performing a payment in operation 5350.

The mode for performing a payment by the mobile terminal may include the first mode and the second mode. Herein, the first mode is a mode for performing a payment by using one-time payment information and the second mode is a mode for performing a payment by using fixed payment information.

In more detail, the first mode is a mode for generating one-time payment information including a token and an authentication value linked with a payment time and transmitting the generated one-time payment information to a POS terminal.

Herein, the one-time payment information is payment information for general transaction. In more detail, when a general transaction is performed in the mobile terminal 100, the control unit 180 generates one-time payment information and transmits the generated one-time payment information to a POS terminal.

Additionally, the second mode is a mode for generating fixed payment information including a fixed token and transmitting the generated fixed payment information to a POS terminal.

Herein, the fixed payment information is payment information for provisional approval transaction. In more detail, when a provisional approval transaction is performed in the mobile terminal 100, the control unit 180 generates fixed payment information and transmits the generated fixed payment information to a POS terminal.

Herein, the token means a string that is matched with user's card information to be generated and managed and may be provided from a card management server (not shown) and stored in the storage unit 170.

In more detail, when receiving a registration request including specific card information and personal information from the mobile terminal 100, a card management server (not shown) may generate a token corresponding to a specific card and the mobile terminal 100 to transmit it to the mobile terminal 100. In this case, the control unit 180 may match the received token to specific card information and store it. During this process, a card management server (not shown) may encrypt a token to transmit it to the mobile terminal 100 and the mobile terminal 100 may decode the encrypted token and store it.

The control unit 180 may determine a payment mode for performing a transaction by the mobile terminal 100.

In more detail, when receiving an input for selecting a mode for performing a payment by the mobile terminal 100 from a user, the control unit 180 may determine a mode for performing a payment by the mobile terminal 100 as a mode selected by a user. For example, in the case of receiving an input for selecting the first mode, the control unit 180 may determine a mode for performing a payment as the first mode and in the case of receiving an input for selecting the second mode, the control module 180 may determine a mode for performing a payment as the second mode.

On the other hand, when a mode for performing a payment by the mobile terminal 100 is the first mode, as an input for switching the mode for performing the payment by the mobile terminal 100 to the second mode is received, the control unit 180 may switch the mode of the mobile terminal 100 into the second mode.

In more detail, in general cases, that is, when an input for switching the mode for performing the payment by the mobile terminal 100 to the second mode is not received, the mobile terminal 100 may perform a payment in the first mode. That is, the payment mode of the mobile terminal 100 may be set to the first mode by default. In this case, the control unit 180 may generate one-time payment information including a token and an authentication value linked with a payment time and transmit the generated one-time payment information to a POS terminal.

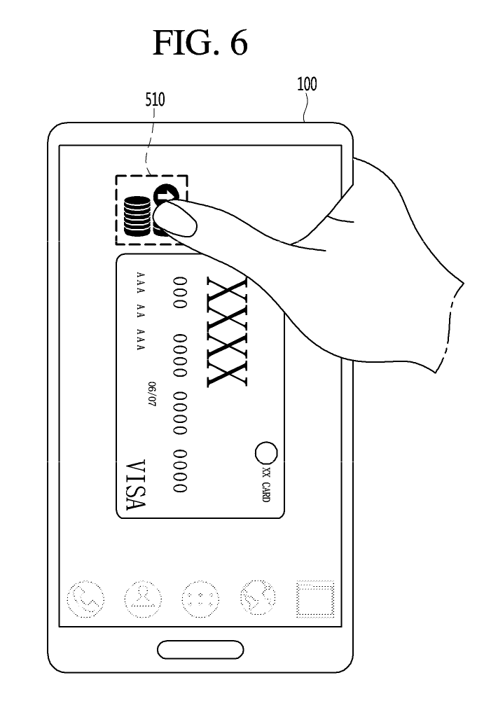

Moreover, when receiving an input for switching a mode for performing a payment by the mobile terminal 100 to the second mode, the control unit 180 may switch a mode for performing a payment by the mobile terminal 100 to the second mode. Then, when switching a mode for performing a payment by the mobile terminal 100 to the second mode, the control unit 180 may generate fixed payment information including a fixed token and transmit the generated fixed payment information to a POS terminal. In relation to this, it will be described in more detail with reference to FIGS. 6 to 12.

FIGS. 6 to 12 are views illustrating various user inputs for switching the payment mode of a mobile terminal to the second mode when the payment mode of the mobile terminal is the first mode.

Referring to FIG. 6, an input for switching the payment mode of a mobile terminal to the second mode when the payment mode of the mobile terminal is the first mode may be an input for touching a UI 510 for representing that a payment method at a business where the mobile terminal 100 is disposed is a provisional approval payment.

In more detail, as described with reference to FIG. 5, when the UI 510 for representing that a payment method at a business where the mobile terminal 100 is disposed is a provisional approval payment is displayed, as an input for touching the UI 510 for representing that a payment method at a business where the mobile terminal 100 is disposed is a provisional approval payment is received, the control unit 180 may switch the payment mode of the mobile terminal 100 from the first mode to the second mode.

Moreover, although it is described with reference to FIG. 3 that an operating method of a mobile terminal according to the present invention includes obtaining information on a transaction method at a business where a mobile terminal is disposed on the basis of at least one of coordinates information of the mobile terminal and signal information received by the mobile terminal in operation S310 and outputting, when the transaction method at the business where the mobile terminal is disposed is a provisional approval transaction, a notification notifying that the transaction method at the business where the mobile terminal is disposed is the provisional approval transaction in operation S330, the present invention is not limited thereto. That is, without obtaining information on a transaction method at a business where a mobile terminal is disposed on the basis of at least one of coordinates information of the mobile terminal and signal information received by the mobile terminal in operation S310 and outputting, when the transaction method at the business where the mobile terminal is disposed is a provisional approval transaction, a notification notifying that the transaction method at the business where the mobile terminal is disposed is the provisional approval transaction in operation S330, the payment mode of a mobile terminal may be selected by simply receiving a user input.

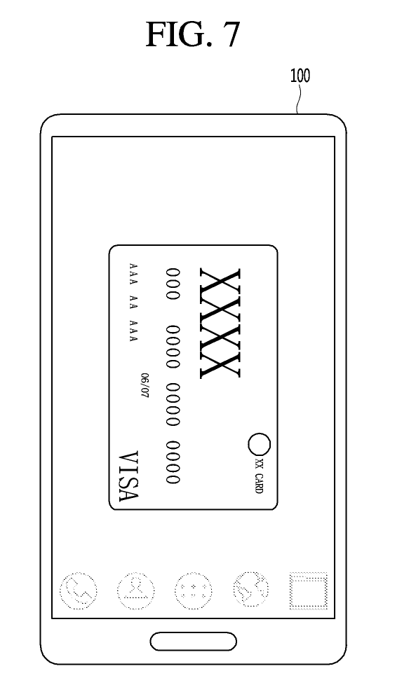

In more detail, as shown in FIG. 7, when a payment application is executed, as an input for selecting the payment mode of the mobile terminal 100 is received from a user, the control unit 180 may determine the payment mode of the mobile terminal 100 as a mode selected by a user.

Additionally, when the payment mode of the mobile terminal 100 is automatically set to the first mode as a payment application is executed, if an input for switching the payment mode of the mobile terminal 100 into the second mode is received, the control unit 180 may switch the payment mode of the mobile terminal 100 into the second mode.

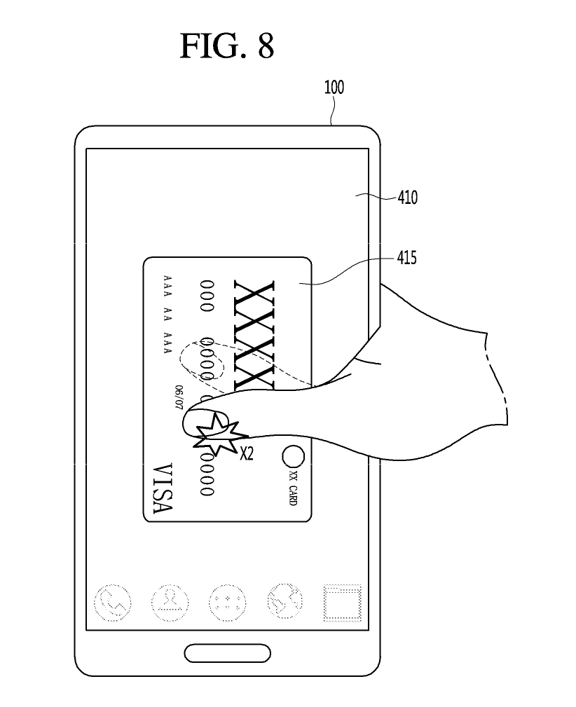

In this case, the input for switching the payment mode of the mobile terminal 100 into the second mode may be a double tap input that presses twice a card image 415 included in the execution screen 410 of the payment application as shown in FIG. 8.

In more detail, when a double tap input that presses twice the card image 415 included in the execution screen 410 of the payment application is received as shown in FIG. 8, the control unit 180 may switch the payment mode of a mobile terminal from the first mode to the second mode.

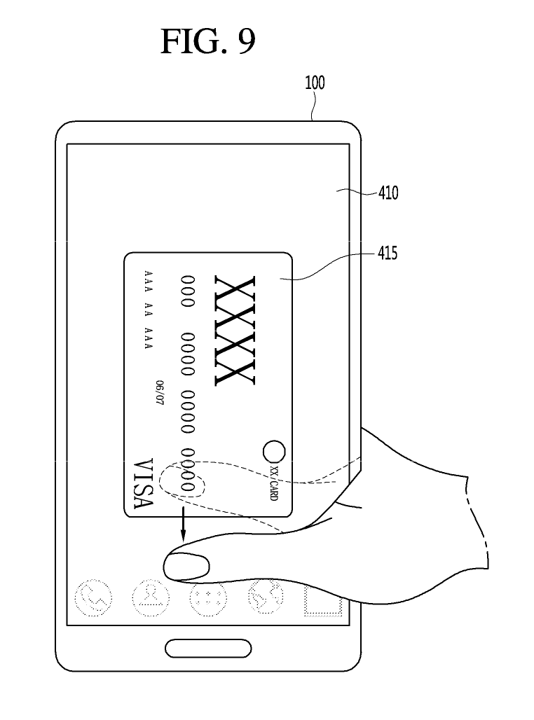

Additionally, an input for switching the payment mode of a mobile terminal to the second mode while the payment mode of the mobile terminal is in the first mode may be an input that swipes a card image included in the execution screen of a payment application. In more detail, when an input that touches and swipes down the card image 415 included in the execution screen 410 of the payment application is received as shown in FIG. 9, the control unit 180 may switch the payment mode of a mobile terminal from the first mode to the second mode.

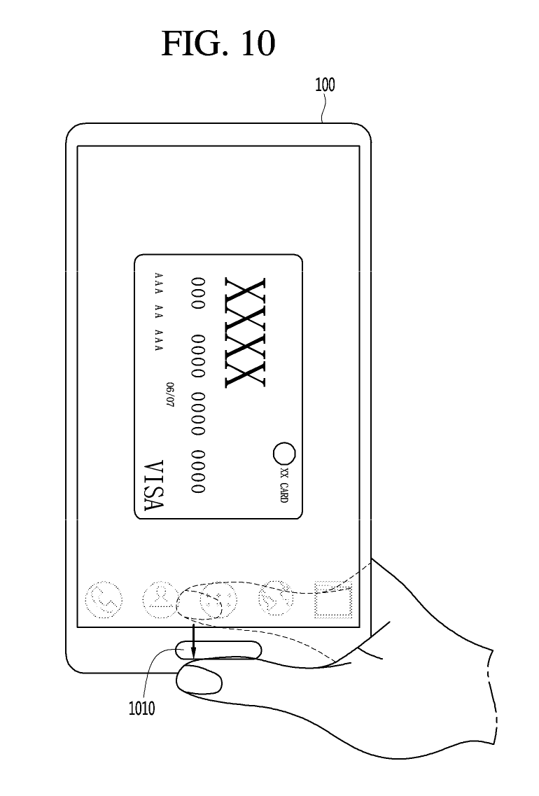

Additionally, an input for switching the payment mode of a mobile terminal to the second mode while the payment mode of the mobile terminal is in the first mode may be an input that swipes a fingerprint sensor. In more detail, when an input that swipes down a fingerprint sensor 1010 is received as a payment application is executed as shown in FIG. 10, the control unit 180 may switch the payment mode of a mobile terminal from the first mode to the second mode.

It is described with reference to FIGS. 7 to 10 that when a notification that a transaction method of a business where the current mobile terminal is disposed is a provisional approval transaction method is not outputted, the payment mode of the mobile terminal is switched from the first mode to the second mode, with only the reception of an input for switching the payment mode of the mobile terminal.

A user often recognizes what transaction method a business that the user visits uses in advance. For example, a user who goes to a self gas station to fill up a vehicle periodically may recognize in advance that a transaction is performed at the self gas station through a provisional approval transaction method.

In such a case, a user may set not outputting a notification that a transaction method of a business where the current mobile terminal is disposed is a provisional approval transaction method and in such a case, without obtaining information on a transaction method at a business where a mobile terminal is disposed on the basis of at least one of coordinates information of the mobile terminal and signal information received by the mobile terminal in operation S310 and outputting, when the transaction method at the business where the mobile terminal is disposed is a provisional approval transaction, a notification notifying that the transaction method at the business where the mobile terminal is disposed is the provisional approval transaction in operation S330, the payment mode of a mobile terminal may be switched from the first mode to the second mode with only the reception of an input for switching the payment mode of the mobile terminal.

Moreover, when an input for switching the payment mode of the mobile terminal from the first mode to the second mode is received, a transaction may be completed at a business where the mobile terminal 100 is disposed through a provisional approval transaction method but a transaction may be completed sometimes through a general transaction method instead of the provisional approval transaction method.

In such a case, the mobile terminal 100 may display whether a transaction is performed at a business where the mobile terminal 100 is disposed through a provisional approval transaction method to allow a user to recognize it.

In more detail, the control unit 180 may obtain information on a transaction method at a business where the mobile terminal 100 is disposed on the basis of at least one of coordinates information of the mobile terminal 100 and signal information received by the mobile terminal 100.

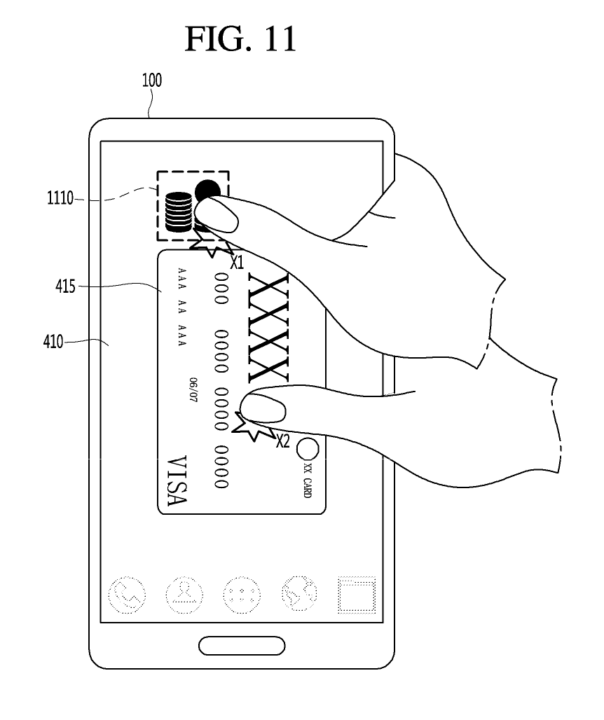

Then, when a transaction method at a business where the mobile terminal 100 is disposed is a provisional approval transaction method and a double tap input that presses twice the card image 415 included in the execution screen 410 of the payment application is received as shown in FIG. 11, the control unit 180 may display a UI 1110 for representing that the transaction method at the business where the mobile terminal 100 is disposed is the provisional approval transaction.

Moreover, when receiving an input for selecting the UI 1110 for representing that the transaction method at the business where the mobile terminal 100 is disposed is the provisional approval transaction, the control unit 180 may switch the payment mode of a mobile from the first mode to the second mode.

Moreover, when a transaction method at a business where the mobile terminal 100 is disposed is a general transaction method instead of a provisional approval transaction method and a double tap input that presses twice the card image 415 included in the execution screen 410 of the payment application is received as shown in FIG. 11, the control unit 180 may not display the UI 1110 for representing that the transaction method at the business where the mobile terminal 100 is disposed is the provisional approval transaction. As another example, when a double tap input that presses twice the card image 415 included in the execution screen 410 of the payment application is received, the control unit 180 may display a UI for representing that a provisional approval transaction is not completed at a business where the current mobile terminal is disposed.

Moreover, according to this embodiment, although it is described that as information on a payment method at a business where the mobile terminal 100 is disposed is obtained and then, a user input is received, a UI 1110 for representing that the payment method at the business where the mobile terminal 100 is disposed is the provisional approval payment is displayed, the present invention is not limited thereto.

For example, when an input for switching the payment mode of the mobile terminal 100 from the first mode to the second mode is received, information on transaction method at a business where the mobile terminal 100 is disposed is obtained and when the transaction method at the business where the mobile terminal is disposed is a provisional approval transaction, the UI 1110 for representing that the transaction method at the business where the mobile terminal is disposed is the provisional approval transaction may be displayed.

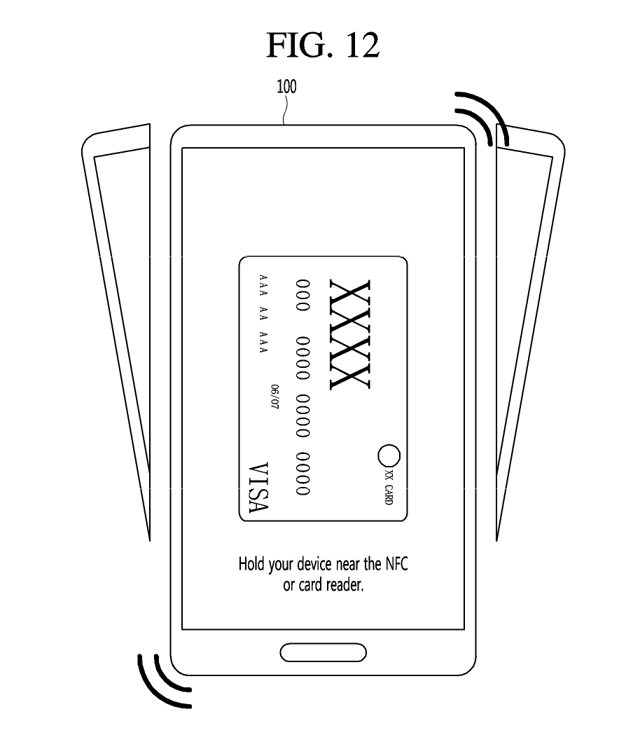

Moreover, an input for switching the payment mode of a mobile terminal to the second mode while the payment mode of the mobile terminal is in the first mode may be an input that shakes the mobile terminal 100. In more detail, as shown in FIG. 12, when an input that shakes the mobile terminal 100 twice horizontally is detected through the sensing unit 140, the control unit 180 may switch the payment mode of the mobile terminal 100 from the first mode to the second mode.

On the other hand, although it is described with reference to FIGS. 6 to 12 that the payment mode of the mobile terminal 100 is determined according to an input received from a user, the present invention is not limited thereto.

For example, based on information on a transaction method at a business where a mobile terminal is disposed, the control unit 180 may determine the payment mode of the mobile terminal 100. In more detail, as described with reference to FIG. 4, information on a payment method at a business where the mobile terminal 100 is obtained based on at least one of coordinates of the mobile terminal 100 and signal information received by the mobile terminal 100, and when a payment method at a business where the mobile terminal 100 is disposed is a provisional payment method, the control unit 180 may determine the payment mode of the mobile terminal 100 as the second mode for a provisional approval transaction without an additional another user input.

Additionally, although it is described with reference to FIG. 4 that the mobile terminal 100 receives a wireless signal transmitted from a business where the mobile terminal 100 is disposed and information on a payment method at the business where the mobile terminal 100 is disposed is obtained by using identification information of a business included in the received wireless signal, the present invention is not limited thereto. For example, a specific POS terminal may transmit a wireless signal for performing a payment in linkage with the mobile terminal 100 and the mobile terminal 100 may obtain information on a transaction method at a specific POS terminal by receiving a wireless signal transmitted from a specific POS terminal.

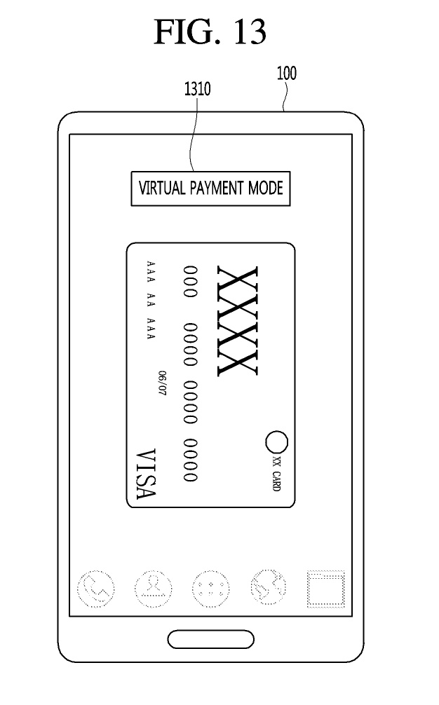

FIG. 13 is a view illustrating a display screen of a mobile terminal that enters the second mode.

When the payment mode of the mobile terminal 100 is determined as the second mode for a provisional approval payment, the control unit 180 may perform a payment in a provisional approval payment mode. Additionally, the control unit 180 may display a UI 1310 for representing that the current payment mode is the second mode for a provisional approval payment.

Moreover, referring to FIG. 5, when a transaction method at a business where the mobile terminal 100 is disposed is a provisional approval payment, it is described that a UI 510 for representing that the transaction method at the business where the mobile terminal 100 is disposed is the provisional approval payment is displayed.

However, the present invention is not limited thereto, and when a transaction method at a business where the mobile terminal 100 is disposed is a provisional approval payment, the control unit 180 may display a UI relating to the business where the mobile terminal 100 is disposed.

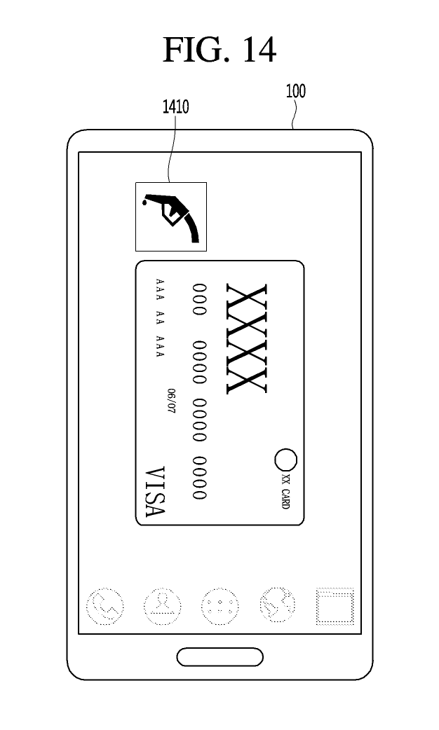

This will be described in more detail with reference to FIGS. 14 to 17C.

FIG. 14 is a view illustrating a mobile terminal where a UI corresponding to the business type of a business where the mobile terminal 100 is disposed is displayed according to an embodiment of the present invention.

When the mobile terminal 100 performs a payment in the second mode for a provisional approval transaction, the control unit 180 may store information on a business where the mobile terminal 100 is disposed in the storage unit 170. Herein, information on a business where the mobile terminal 100 is disposed may include information on the business type of a business where the mobile terminal 100 is disposed. For example, when a user of the mobile terminal 100 visits a self gas station, information stored in the storage unit 170 may include the business type (that is, a gas station) of a business where the mobile terminal 100 is disposed and location information of the mobile terminal 100.

Moreover, when a user of the mobile terminal 100 visits the same self gas station again, that is, the location of the mobile terminal 100 is identical to the location stored in the storage unit 170, the control unit 180 may display a UI 1410 corresponding to the business type of a business where the mobile terminal 100 is disposed.

Furthermore, the UI 1410 corresponding to the business type of a business where the mobile terminal 100 is disposed may be displayed when a payment application is executed and may be displayed when the payment mode of the mobile terminal 100 is determined as the second mode for a provisional approval payment.

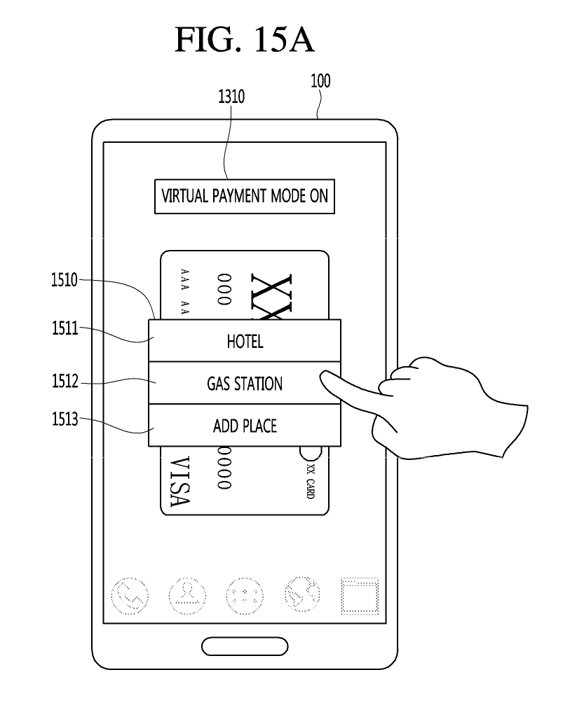

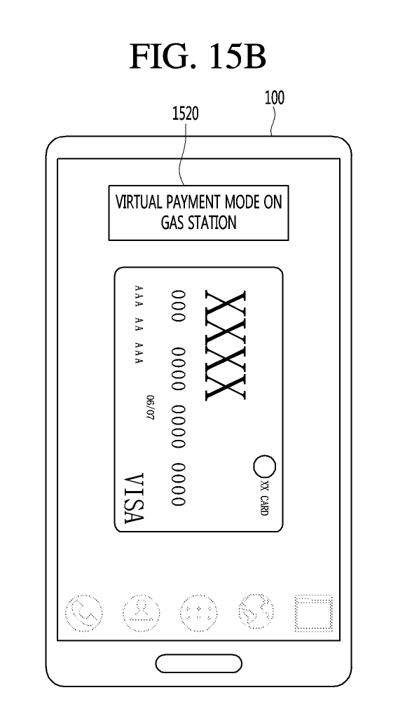

FIGS. 15A and 15B are views illustrating a display screen when information on a business where the mobile terminal 100 is disposed is not stored according to an embodiment of the present invention.

When the payment mode of the mobile terminal 100 is determined as the second mode for a provisional approval transaction and a business corresponding to the location of the current mobile terminal 100 is not stored in the storage unit 170, as shown in FIG. 15A, the control unit 180 may display a UI 1510 for specifying a business where the current mobile terminal 100 is disposed.

Herein, the UI 1510 for specifying a business where the current mobile terminal 100 is disposed may include items 1511 and 1512 for a business type in which a payment is performed through a provisional approval method and also may include an item 1513 for newly registering a business where a payment is performed through a provisional transaction method.

Moreover, when an input for selecting an item for a specific business type among the items 1511 and 1512 for a business type in which a transaction is processed through a provisional transaction method is received, the control unit 180 may store location information of the current mobile terminal 100 and information on a specific business type in the storage unit 170. Additionally, the control unit 180 may control the display unit 151 to display information on a specific business type.

For example, as shown in FIG. 15A, when a gas station is selected from “hotel” and “gas station” where a payment is performed through a provisional approval payment method, the control unit 180 may store location information of the current mobile terminal 100 and information that the current mobile terminal 100 is at a gas station, and as shown in FIG. 15B, display information 1520 “gas station”.

Moreover, when a user of the mobile terminal 100 visits the same gas station again, the control unit 180 may display a UI corresponding to the business type of a business where the mobile terminal 100 is disposed on the basis of location information of the mobile terminal and information on a business type corresponding to a specific item stored in the storage unit 170.

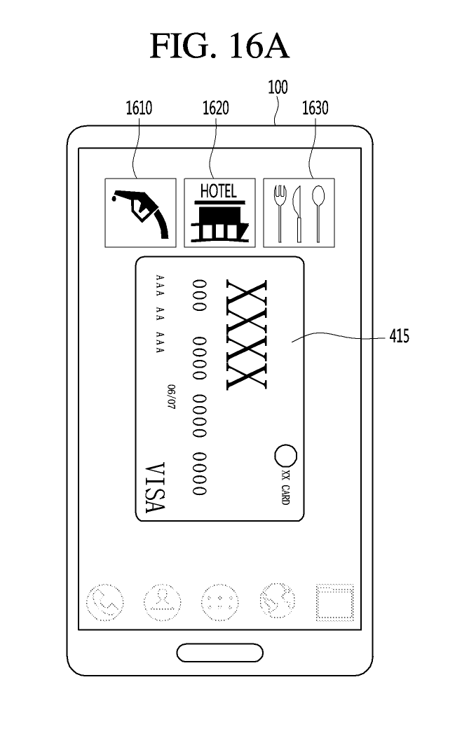

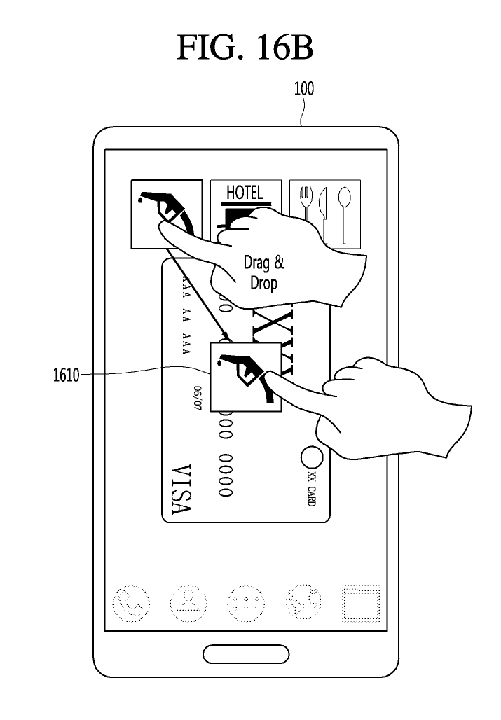

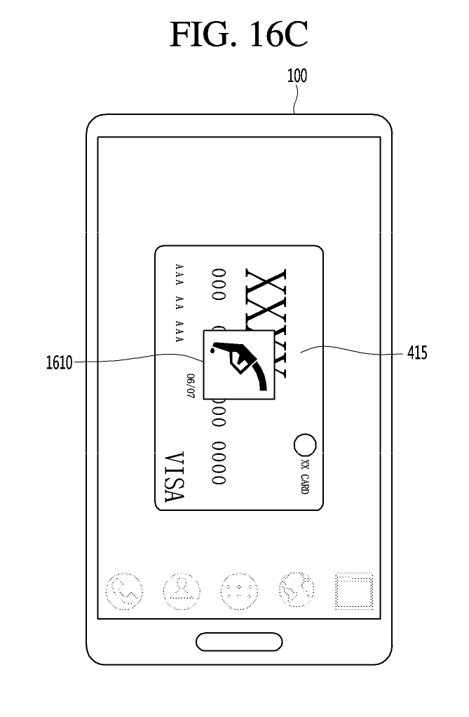

FIGS. 16A and 16C are views illustrating a display screen when information on a business where the mobile terminal 100 is disposed is not stored according to another embodiment of the present invention.

When the payment mode of the mobile terminal 100 is determined as the second mode for a provisional approval transaction and a business corresponding to the location of the current mobile terminal 100 is not stored in the storage unit 170, as shown in FIG. 16A, the control unit 180 may display icons 1610, 1620, and 1630 corresponding to a plurality of business types in which a provisional approval payment is performed.

Moreover, as shown in FIG. 16B, when selecting the icon 1610 corresponding to a specific business type from icons 1610, 1620, and 1630 corresponding to a plurality of business types in which a provisional approval payment is performed and receiving an input for dragging and dropping the icon 1610 corresponding to the specific business type on a card image 415, the control unit 180 may store location information of the current mobile terminal 100 and information on a specific business type in the storage unit 170. In this case, as shown in FIG. 16C, the control unit 180 may overlap the icon 1610 corresponding to a specific business on the card image 415.

Moreover, when a user of the mobile terminal 100 visits the same gas station again, the control unit 180 may display an icon corresponding to the business type of a business where the mobile terminal 100 is disposed on the basis of location information of the mobile terminal and information on a business type corresponding to a specific item stored in the storage unit 170. In this case, as shown in FIG. 16C, the control unit 180 may overlap the icon 1610 corresponding to a specific business on the card image 415.

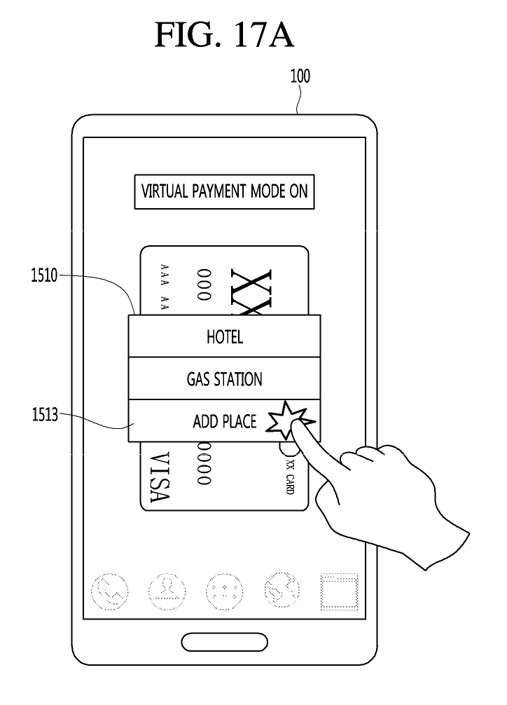

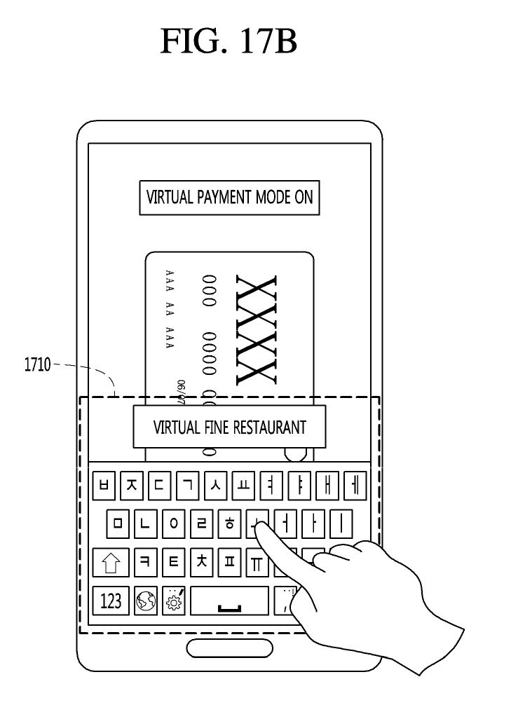

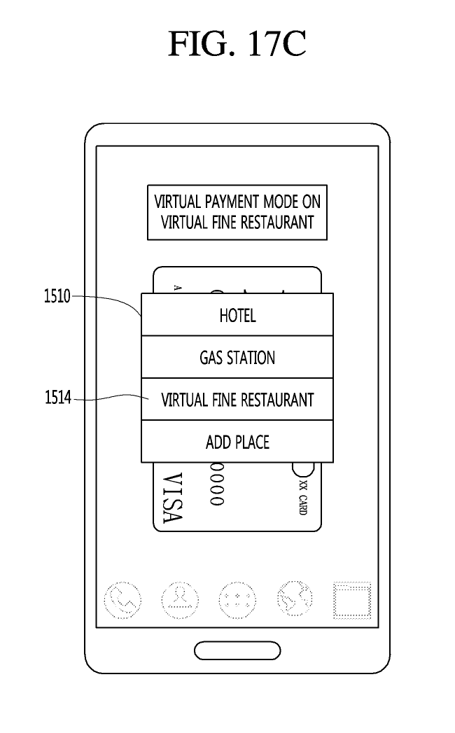

FIGS. 17A and 17C are views illustrating a method of newly registering a business where a payment is performed through a provisional approval transaction method when information on a business where the mobile terminal 100 is disposed is not stored according to another embodiment of the present invention.

As shown in FIG. 15A, in a state that the UI 1510 for specifying a business where the mobile terminal 100 is disposed is displayed, as shown in FIG. 17A, when an input for selecting the item 1513 for newly registering a business where a payment is performed through a provisional approval payment method is received, the control unit 180, as shown in FIG. 17B, may display an input window 1710 for newly registering a business where a payment is performed through a provisional approval payment method.

Moreover, as information on a business where a payment is performed through a provisional approval payment method is inputted by a user, the controller 180, as shown in FIG. 17C, may display a UI 1510, where a newly registered item 1514 is added, for specifying a business where the mobile terminal 100 is disposed.

Moreover, referring to FIGS. 14 to 17, although it is described that information on a business where a payment is performed through a provisional approval payment method is stored in the mobile terminal 100 and when a user visits the same place again later, information corresponding to a business where a payment is performed through a provisional approval payment method on the basis of information in the mobile terminal 100 is displayed, the present invention is not limited thereto.

For example, information on a business where a payment is performed through a provisional approval payment method is performed may be stored in an information server (not shown). Herein, the server (not shown) may be a server that establishes and stores a database of card member stores where a payment is performed through a provisional approval payment method and location information of card membership stores.

In more detail, the control unit 180 may transmit location information of the current mobile terminal 100 to a server (not shown). Herein, the location information of the mobile terminal 100 may include at least one of coordinates information of the mobile terminal 100 and signal information received from the mobile terminal 100.

Moreover, the server (not shown) that receives the location information of the mobile terminal 100 searches the database to transmit information on a business corresponding to the location information of the mobile terminal 100 to the mobile terminal 100.

In this case, when the payment mode of the mobile terminal 100 is determined as the second mode, the control unit 180 may control the display unit 151 to display information on a business corresponding to the location information of the mobile terminal 100.

Moreover, when the business where the mobile terminal 100 is disposed is a business where a transaction is performed through a provisional approval transaction method or is not registered in a server side database, the control unit 180, as described with reference to FIG. 15A or 16B, may transmit location information of the mobile terminal 100 and information on a business where the mobile terminal 100 is disposed. In this case, the server (not shown) may register a new business in the database by using the information received from the mobile terminal 100.

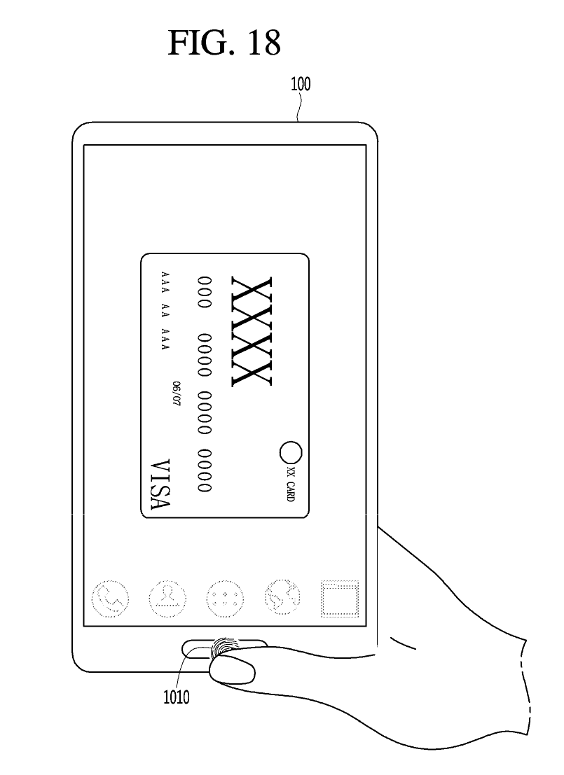

Referring to FIG. 3, an operating method of a mobile terminal according to an embodiment of the present invention may include, when a mode of the mobile terminal is the first mode for general transaction, performing a payment by using one-time payment information and when the mode of the mobile terminal is the second mode for a provisional approval transaction, performing a payment by using fixed payment information in operation 5370. This will be described in detail with reference to FIG. 18.

FIG. 18 is a view illustrating a payment performing method according to an embodiment of the present invention.

A fingerprint sensor 1010 may be mounted at a mobile terminal 100 and when a user's finger touches the fingerprint sensor 1010, the control unit 180 may recognized the touched fingerprint. Additionally, if the recognized fingerprint corresponds to a pre-registered fingerprint, the control unit 180 may perform a payment.

Moreover, when the payment mode of a mobile terminal is the first mode for general payment, the control unit 180 may perform a payment by using one-time payment information.

In more detail, when authentication is completed through a fingerprint, the control unit 180 may generate one-time payment information. Herein, the one-time payment information may include a one-time token and an authentication value linked with a payment time.

Herein, the one-time token is a virtual card number that replaces an actual card number of a card used for a payment and may be provide from a card company server. Additionally, the authentication value, as a virtual authentication value that replaces an actual card number authentication value (for example, a CVV), may be provided from a card company server.

Moreover, the control unit 180 may store a one-time token and an authentication value in the storage unit 170. In this case, the one-time token and the authentication value may be stored in a separated security area in the storage unit 170.

Moreover, the control unit 180 may generate one-time payment information including a one-time token and an authentication value linked with a fingerprint authentication time by using the one-time token and the authentication value stored in the storage unit 170.

Then, when the mobile terminal 100 is tagged to a POS terminal by a user, the control unit 180 may transmit the generated one-time payment information to the POS terminal.

Moreover, when the payment mode of a mobile terminal is the second mode for provisional approval payment, the control unit 180 may perform a payment by using fixed payment information.

In more detail, when authentication is completed through a fingerprint, the control unit 180 may generate fixed payment information including a fixed token. Herein, the fixed token is a virtual card number that replaces an actual card number of a card used for a payment and may be provide from a card company server.

However, the fixed token is required to be delivered to a card company server (not shown) within a predetermined time from a generated time point and if a predetermined time elapses, unlike a one-time token, the fixed token may have a fixed value regardless of the generated time point. However, the present invention is not limited thereto, and the fixed token may be renewed (or changed) by a specific period unit (for example, on a daily basis) and after a payment is performed by using fixed payment information including a fixed token, if the mobile terminal 100 is out of a location where a payment is performed, the fixed token is renewed (or changed), so that a new fixed token may be stored. Moreover, the fixed payment information may be information obtained by combining the fixed token and another authentication value.

Moreover, the control unit 180 may store a fixed token in the storage unit 170. In this case, the fixed token may be may be stored in a separated security area in the storage unit 170.

Moreover, the control unit 180 may generate fixed payment information including a fixed token and an authentication value by using the fixed token stored in the storage unit 170.

Then, when the mobile terminal 100 is tagged to a POS terminal by a user, the control unit 180 may transmit the generated fixed payment information to the POS terminal through the wireless communication unit 110.

Moreover, when the mobile terminal 100 is tagged to a POS terminal by a user, NFC communication may be used for communication between the mobile terminal 100 and the POS terminal and in this case, the POS terminal may be a terminal for supporting an NFC type. However, the present invention is not limited thereto, and one-time payment information or fixed payment information may be transmitted by using an MST method between the mobile terminal 100 and the POS terminal.

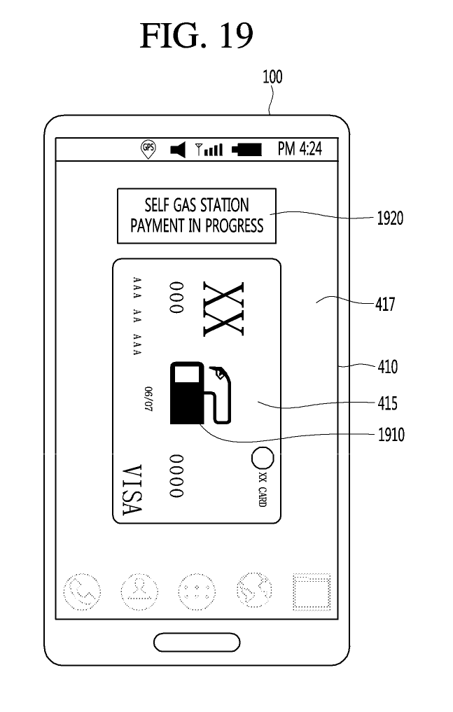

FIG. 19 is a view illustrating a screen displayed when a payment is performed in the second mode according to an embodiment of the present invention.

When a payment is in progress in the second mode as authentication through fingerprint is completed, the control unit 180 may display a UI for representing that the payment is in progress in the second mode.

In more detail, as shown in FIG. 19, the control unit 180 may display an icon 1910 corresponding to a business where the mobile terminal 100 is disposed.

Additionally, the control unit 180 may display a pop-up window 1920 for representing that a payment is in progress at a business where the mobile terminal 100 is disposed.

Furthermore, when authentication is completed through a fingerprint, the control unit 180 may change and display the color of the execution screen 410 of a payment application. In this case, the control unit 180 may change and display the color of a background image 417 in the execution screen 410 of the application, that is, an area other than an area of the card image 415.

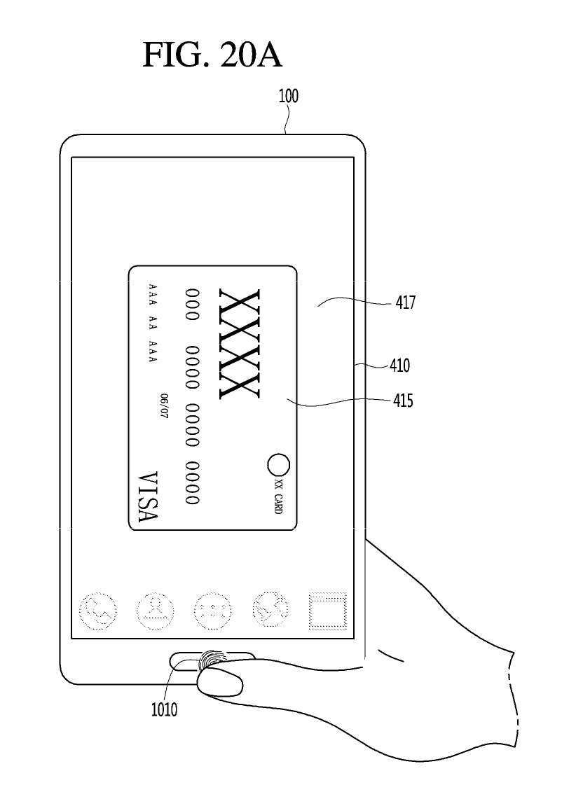

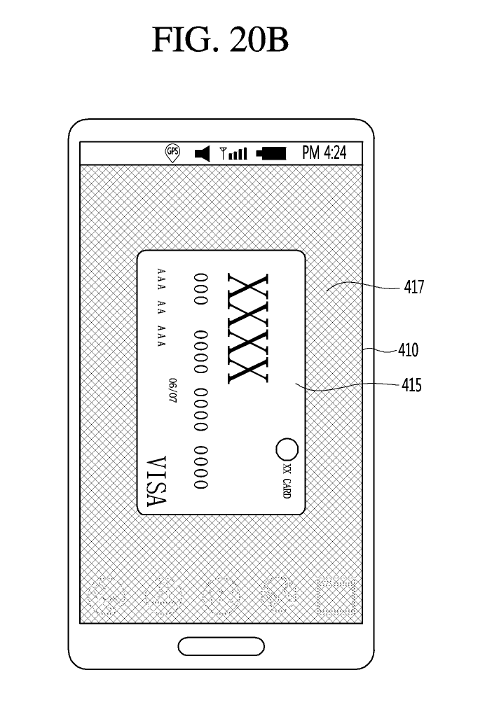

FIGS. 20A and 20B are views illustrating a method of representing a payment expiration time according to an embodiment of the present invention.

From a time that a user of the mobile terminal 100 is authenticated as a user's finger touches the fingerprint sensor 1010 to a time that payment information is transmitted to a POS terminal as the mobile terminal 100 is tagged to a POS terminal are required to be completed within a specific time. Moreover, when payment information is not transmitted to a POS terminal within a specific time, a user may touch the fingerprint sensor 1010 by a finger in order for re-authentication. That is, a time point that a specific time elapses after a user of the mobile terminal 100 is authenticated is called a payment expiration time.

When a user of the mobile terminal 100 is authenticated, the control unit may display that a payment expiration time becomes closer by changing the color of the execution screen 410 of a payment application. In more detail, when a user of the mobile terminal 100 is authenticated, the control unit 180 may display the execution screen 410 of an application with a first color and additionally, as a payment expiration time becomes closer, the control unit 180 may gradually change the execution screen 410 of an application from the first color to a second color and display it. Additionally, when the payment expiration time arrives, the control unit 180 may display the execution screen 410 of an application with the second color.

Moreover, the control unit 180 may gradually change only the color of a background image 417 in the execution screen 410 of the application, that is, an area other than an area of the card image 415 and display it.

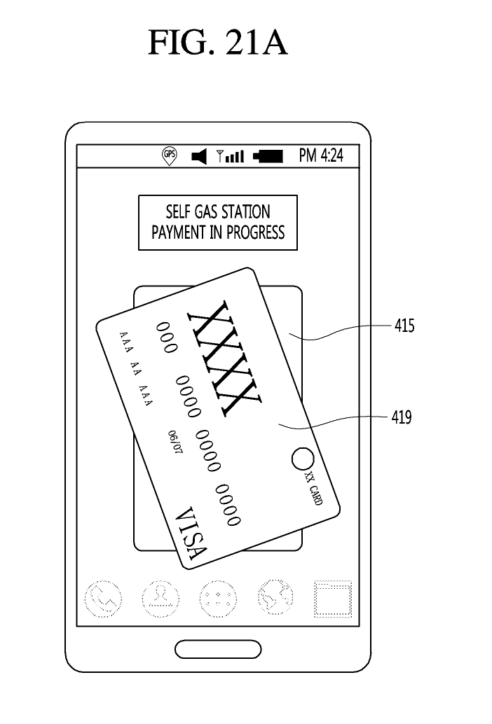

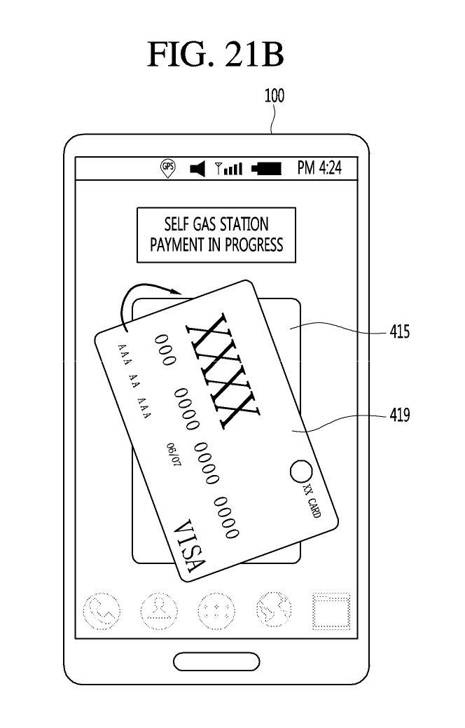

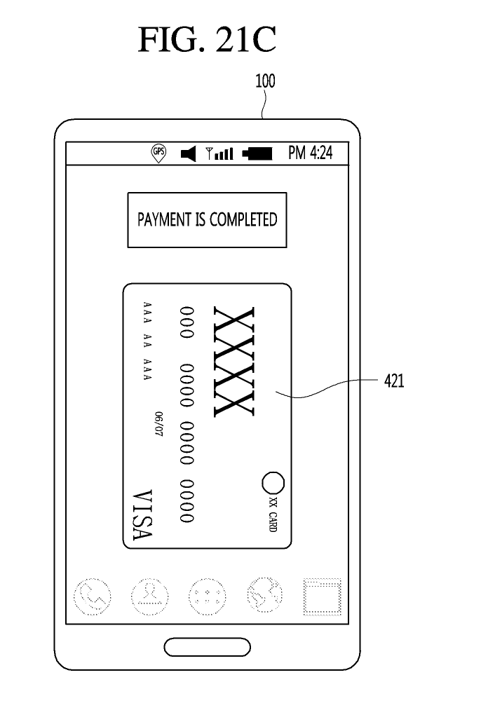

FIGS. 21A to 21C are views illustrating an operating method of a mobile terminal when a payment is in progress in the second mode according to an embodiment of the present invention.

When an authentication is completed through a fingerprint, a payment is performed in the second mode. Then, while the payment is in progress in the second mode, the control unit 180 may display a UI for representing that the payment is in progress in the second mode.

In more detail, the control unit 180, as shown in FIG. 21A, may overlap a second card image 419 on a card image where an execution screen of an application is displayed and display it. Moreover, the control unit 180 may display the second card image 419 as a tilted card image.

Moreover, as shown in FIG. 21B, when a payment is completed, the control unit 180 may rotate the tilted second card image 419 to overlap the card image 415 and display it. As a result, the control unit 180, as shown in FIG. 21C, may display one card image 421 where the card image 415 and the second card image 419 overlap completely.

Moreover, when a payment is completed, that is, the mobile terminal 100 is tagged to a POS terminal and fixed payment information is transmitted to the POS terminal, the POS terminal may transmit fixed payment information and information on a guarantee amount to a card company server (not shown). In this case, a card company server (not shown) compares a fixed token included in fixed payment information with a token stored in the card company server and if they are identical, authenticates a transaction for guarantee amount (for example, a provisional approval transaction). Moreover, when an actual transaction amount is determined as a user completes the refueling, a POS terminal may request the cancellation of a transaction for a guarantee account (i.e., a provisional approval transaction) and the approval of an actual transaction amount (i.e., an actual transaction approval) from a card company server (not shown), and the card company server (not shown) may cancel the transaction for a guarantee amount (i.e., a provisional approval transaction) and approves the actual transaction amount (i.e., approves the actual transaction) to transmit a final notification to the mobile terminal 100.

Moreover, the fixed payment information may include location information of the mobile terminal 100. In more detail, the control unit 180 may obtain location information of the mobile terminal 100 on the basis of at least one of coordinates information of the mobile terminal 100 and signal information received by the mobile terminal 100.

Furthermore, when the authentication of a user of the mobile terminal 100 is completed through a fingerprint, the control unit 180 may generate fixed payment information including a fixed token and the location information of the mobile terminal 100. Additionally, when the mobile terminal 100 is tagged to a POS terminal, the control unit 180 may transmit the fixed payment information including the fixed token and the location information of the mobile terminal 100 to the POS terminal.

In this case, a card company server (not shown) compares a fixed token and location information of the mobile terminal 100 included in fixed payment information with a token and location information of a business where a payment is performed through a provisional payment method stored in the card company server, thereby approving a transaction requested from the mobile terminal 100.

In detail, the card company server (not shown) may establish and retain a database of location information of a business where a payment is performed through a provisional approval payment method. In more detail, the card company server (not shown) may establish and retain a database of at least one of coordinates information of a business where a payment is performed through a provisional approval payment method and identification information included in a wireless signal transmitted from a business where a payment is performed through a provisional approval payment method.

In this case, a card company server (not shown) compares a fixed token included in fixed payment information with a token stored in the card company server (not shown) to determine whether they are identical. Additionally, the card company server (not shown) may compare location information of the mobile terminal 100 and location information of a business where a payment is performed through a provisional approval payment method to determine whether they are identical.

Then, when a fixed token included in fixed payment information is identical to a token stored in the card company server (not shown) and the location of the mobile terminal 100 is identical to one of the locations of a plurality of businesses where a payment is performed through a provisional approval payment method postponed by the card company server (not shown), the card company server (not shown) may approve a transaction requested from the mobile terminal 100.

Moreover, when a payment is performed, the fixed token may be renewed (or changed).

In more detail, it is described above, that the mobile terminal 100 may obtain location information of a mobile terminal on the basis of at least one of coordinates information of the mobile terminal 100 and signal information received by the mobile terminal 100.

In this case, it may be determined that the location of the mobile terminal 100 is out of a threshold value on the basis of at least one of coordinates information of the mobile terminal 100, signal information received by the mobile terminal 100, and information on a movement of the mobile terminal 100. For example, when the mobile terminal 100 is moved more than a specific distance on the basis of the coordinates of the mobile terminal 100, the control unit 180 may determine that the mobile terminal 100 is out of more than a threshold value from a location where a payment is performed. As another example, when a wireless signal received by the mobile terminal 100 is received as a smaller size of signal compared to a signal received at a location where a payment is performed or a wireless signal received at a location where a payment is performed is not received anymore, the control unit 180 may determine that the mobile terminal 100 is out of more than a threshold value from a location where a payment is performed.

As another example, as detecting a movement of the mobile terminal 100 through the sensing unit 140, the control unit 180 may determine that the location of the mobile terminal 100 is out of more than a threshold value.

In this case, the control unit 180 may renew (or change) a fixed token. That is, the control unit 180 may discard the previously used fixed token and store a new fixed token in a separated security area in the storage unit 170. In this case, the new fixed token may be provided from a server (not shown).

Then, a new fixed token (hereinafter referred to as a second fixed token) stored in the storage unit 170 may be used for the next provisional approval payment. That is, when a second payment is performed in the second mode for provisional approval payment, the control unit 180 may generate second fixed payment information including a second fixed token and transmit the generated second fixed payment information to a POS terminal. Additionally, when the second payment is canceled or completed, the control unit 180 may discard the used second fixed token and store a third token, that is, a new fixed token, in a separated security area in the storage unit 170.

According to the present invention, in the second mode for provisional approval transaction, by using fixed payment information instead of one-time payment information changed according to the passage of time, a mobile payment is possible at a business where a provisional approval transaction is performed.

Additionally, according to the present invention, by performing a payment by using one-time payment information in the first mode for general payment instead of using fixed payment information at all times, the security of a mobile payment may be further improved in consideration that a provisional approval payment accounts for a minority and a general payment accounts for a majority.

Additionally, a payment is performed by using fixed payment information obtained by combining a fixed token and location information of a mobile terminal in addition to the fixed token, so that the present invention may improve the security. In more detail, a card company server (not shown) approves a transaction by using location information of a mobile terminal in addition to a fixed token, so that a payment using fixed payment information is not approved at a business where a provisional payment is not made. That is, a payment may be performed by using a fixed token only at a business where a provisional approval payment is performed.

Additionally, the present invention may prevent security from weakening, which occurs as the same token is utilized continuously, by updating a fixed token based on a location change of a mobile terminal while utilizing fixed payment information. That is, the present invention does not renew (or change) a token by a time unit and thus allows a mobile payment at a business where a provisional approval payment is performed and when a payment is performed, also improves security by updating a previously-used fixed token on the basis of a location change of a mobile terminal.

Additionally, the present invention may reduce a time taken for generating payment information during a provisional approval payment by updating a fixed token in advance and store it when a payment is performed in the second mode for provisional approval payment.

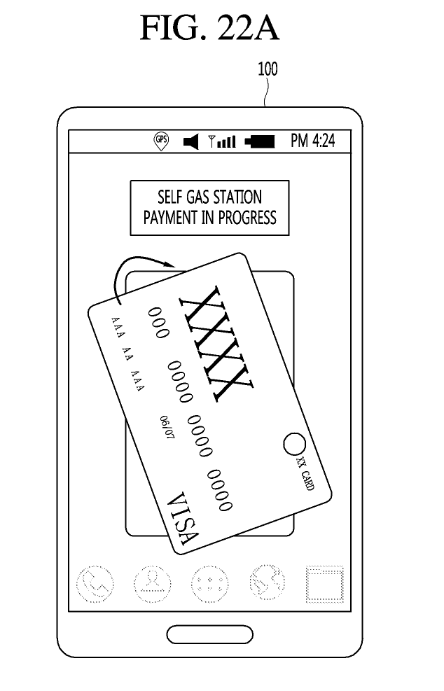

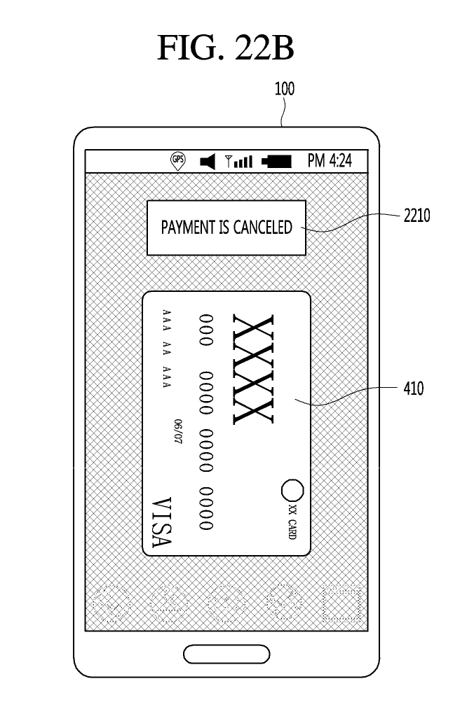

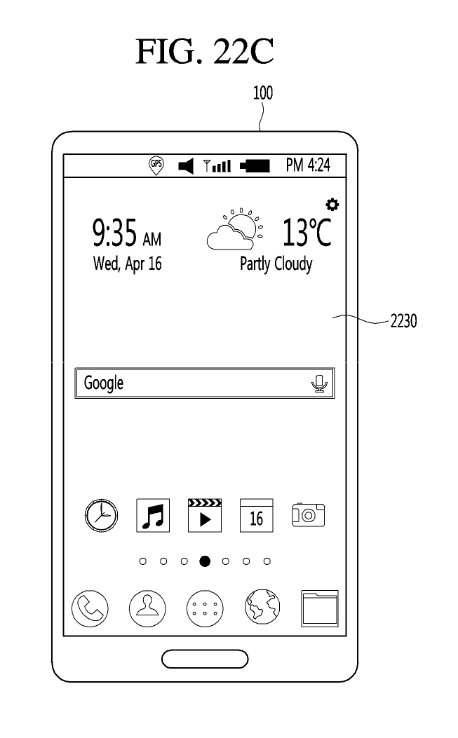

FIGS. 22A to 22C are views illustrating an operating method of a mobile terminal when a payment is cancelled in the second mode according to an embodiment of the present invention.

FIG. 22A is a view illustrating a display screen of a mobile terminal where a payment is in progress in the second mode.

While a payment is performed in the second mode, it may occur that the payment is canceled instead that the payment is performed.

For example, fixed payment information may include location information of the mobile terminal 100 and a server (not shown) may determine whether to approve a transaction by using location information of a mobile terminal included in the fixed payment information.

In this case, when the mobile terminal 100 is moved more than a threshold value from a place where the fixed payment information is generated, the payment may be canceled.

In more detail, the control unit 180 may determine that the location of the mobile terminal 100 is out of more than a threshold value on the basis of at least one of coordinates information of the mobile terminal 100, signal information received by the mobile terminal 100, and information on a movement of the mobile terminal 100.

Moreover, when the location of the mobile terminal 100 is out of more than a threshold value, since fixed payment information also is changed as the location of the mobile terminal 100 is changed, previously-generated fixed payment information cannot be used anymore.

Accordingly, when the location of the mobile terminal 100 is out of more than a threshold value, the control unit 180 may cancel a payment performed at the mobile terminal 100.

When a user changes its location after fixed payment information is generated, by stopping the payment, it is prevented that a user moves to another business and performs a payment after fixed payment information is generated through an authentication by using a fingerprint.

Moreover, when a payment expiration time elapses in a state that fixed payment information is not transmitted to a POS terminal, the control unit 180 may cancel a payment being performed at the mobile terminal 100.

Furthermore, when the payment being performed at the mobile terminal 100 is canceled, as shown in FIG. 22B, the control unit 180 may change and display the color of the execution screen 410 of a payment application. Additionally, the control unit 180 may display a pop-up window 2210 for representing that the payment is cancelled.

Furthermore, when the payment is cancelled, the control unit 180 may renew (or changed) a fixed token. In more detail, the control unit 180 may discard the previously used fixed token and store a new fixed token in a separated security area in the storage unit 170.

Moreover, when the payment is canceled, since the previously used fixed token is discarded and a new fixed token is stored, the generation of new fixed payment information is required in order to allow a user to perform a payment again. That is, when a user is authenticated again through a fingerprint, the control unit 180 generates new fixed payment information including a new fixed token and performs a payment by using the generated new fixed payment information.

In such a way, the present invention may renew (or change) a fixed token when a payment is canceled while utilizing fixed payment information, so that security weakening occurring as the same token is utilized continuously may be prevented.

Furthermore, when the payment being performed at the mobile terminal 100 is canceled, as shown in FIG. 22C, the control unit 180 may terminate a payment application and display the basic screen 2230 of the mobile terminal 100.

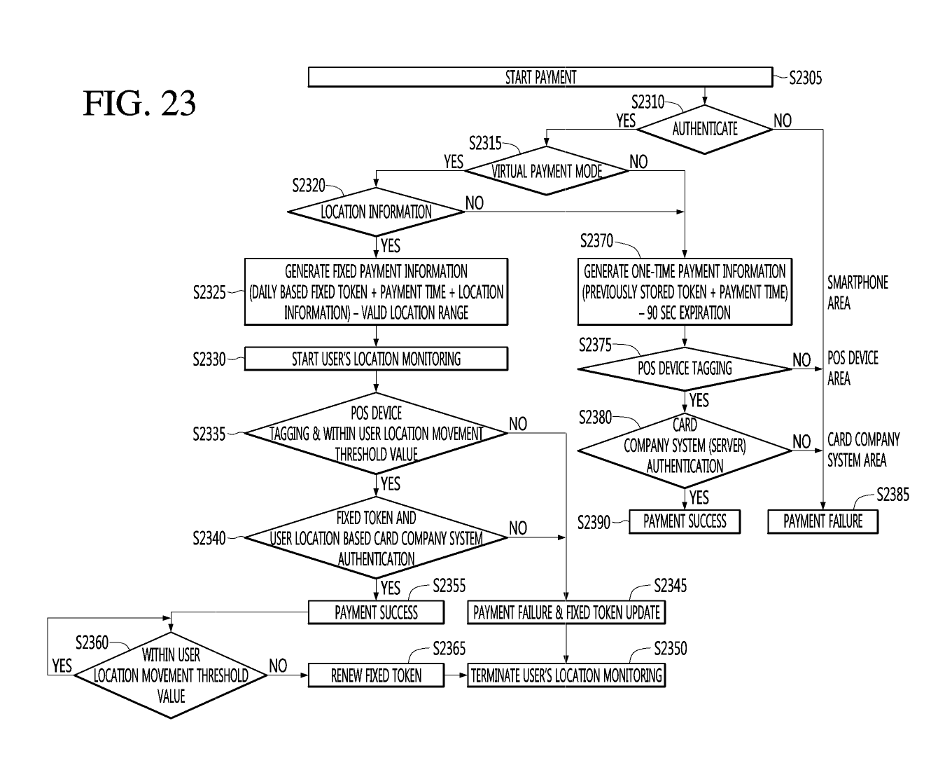

FIG. 23 is a flowchart illustrating an operating method of a mobile terminal according to an embodiment of the present invention.

When a payment application is executed, a payment may start in operation S2305. The payment application may be executed by a user input but may be automatically executed based on location information of the mobile terminal 100.

Moreover, an authentication for payment may be performed in operation S2310. In general, a user of the mobile terminal 100 may be authenticated through fingerprint recognition but the present invention is not limited thereto, and may be authenticated by all authentication means for authenticating the user of the mobile terminal 100.

Moreover, when the user of the mobile terminal 100 is not authenticated, the payment may be terminated in operation S2385.

Moreover, when the user of the mobile terminal 100 is authenticated, according to the payment mode of the mobile terminal 100, the method proceeds to operation 2320 to perform a provisional approval payment and proceeds to operation S2370 to perform a general payment in operation S2315.

Moreover, when the payment mode of the mobile terminal 100 is the second mode for provisional approval payment, the mobile terminal 100 may obtain the location information of the mobile terminal 100 in operation S2320.

Then, the mobile terminal 100 may generate fixed payment information including a fixed token in operation S2325. Moreover, the fixed payment information may include location information of the mobile terminal 100 in addition to a fixed token, and may be in a form of combining a fixed token number and a number corresponding to the location of the mobile terminal 100. Additionally, the fixed payment information may include payment time information.

When fixed payment information is generated, the mobile terminal 100 may monitor a user's location in operation S2330. In this case, the mobile terminal 100 may monitor the user's location of the mobile terminal 100 by using at least one of coordinates information of the mobile terminal 100, signal information received by the mobile terminal 100, and information on a movement of the mobile terminal 100 sensed through the sensing unit 140.

Moreover, when the mobile terminal 100 is tagged to a POS terminal, fixed payment information may be transmitted from the mobile terminal 100 to the POS terminal. In this case, the POS terminal that receives the fixed payment information may transmit the fixed payment information to a card company server in operation S2335. Moreover, when the location of the mobile terminal 100 is changed more than a threshold value, a payment is cancelled and a fixed token is renewed (or changed) and stored in operation S2345.

Moreover, the card company server may approve a transaction by using the received fixed payment information. In more detail, the card company server compares a fixed token included in the received fixed payment information with a token stored in the card company server, and compares location information of the mobile terminal 100 included I the fixed payment information with location information stored in the card company server to approve a transaction requested from the mobile terminal 100 in operation S2340.

Herein, the approved transaction may be a provisional approval payment for deposit. Moreover, when an actual transaction amount is determined after a provisional approval payment is approved, a POS terminal may request the cancellation of a provisional approval payment and the approval for actual transaction amount from a card company server. In this case, the card company server cancels the provisional approval payment and approves the transaction for actual transaction amount.

Moreover, when location information of the mobile terminal 100 included in fixed payment information is different from location information stored in a card company server, the card company server may reject the transaction in operation S2340, and in this case, the card company server may transmit a transaction disapproval message to the mobile terminal 100 and the mobile terminal 100 that receives the transaction disapproval message cancels the payment and renews (or changes) the fixed token in operation S2345. Additionally, the mobile terminal 100 may stop monitoring the location of the mobile terminal 100 in operation S2350.

Moreover, when a provisional approval payment, a provisional approval payment cancellation, and an actual transaction approval are completed, the card company server may transmit a transaction completion message to the mobile terminal 100 and accordingly a payment is performed in operation S2355.

Moreover, the mobile terminal 100 may determine whether the location of the mobile terminal 100 is changed more than a threshold value in operation S2360 and when the location of the mobile terminal 100 is changed more than the threshold value, renew (or change) a fixed token in operation S2365. Additionally, the mobile terminal 100 may stop monitoring the location of the mobile terminal 100 in operation S2350.

Moreover, when the payment mode of the mobile terminal 100 is the first mode for general payment in operation S2320, the mobile terminal 100 may generate one-time payment information in operation S2370. Herein, the one-time payment information may include a one-time token and an authentication value linked with a payment time.

Moreover, when the mobile terminal 100 is tagged to a POS terminal, one-time payment information may be transmitted from the mobile terminal 100 to the POS terminal. In this case, the POS terminal that receives the fixed payment information may transmit the fixed payment information to a card company server in operation S2375.

The card company server may compare the received one-time payment information with one-time payment information stored in the card company server to approve a transaction in operation S2380

Then, when the transaction is approved, the card company server may transmit a transaction completion message to the mobile terminal 100 and accordingly, a payment is performed in operation S2390.

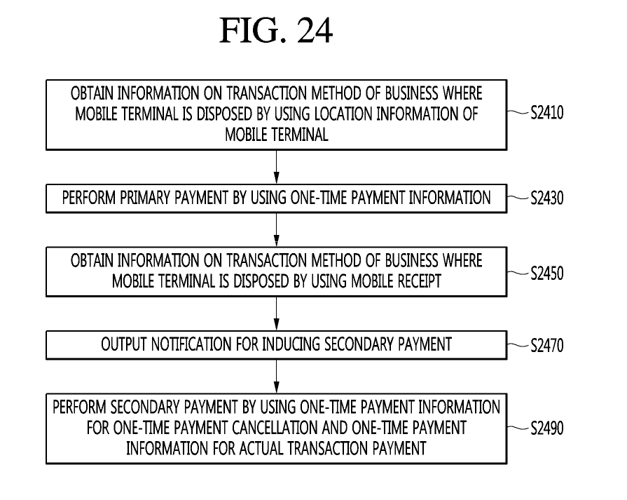

FIG. 24 is a flowchart illustrating an operating method of a mobile terminal according to another embodiment of the present invention.

Referring to FIGS. 24 to 37, when the payment mode of the mobile terminal 100 is determined as the first mode for general transaction, a method of performing a provisional approval transaction in the first mode is described.

A user of the mobile terminal 100 may complete a provisional approval transaction (e.g., a provisional payment, a provisional payment cancellation, and an actual transaction approval) through a one-time tagging operation in the second mode, and also complete a provisional approval transaction through a two-time tagging operation in the first mode.

That is, according to a user's selection, a provisional approval transaction may be performed in the first mode or the second mode.

Referring to FIG. 24, an operating method of a mobile terminal according to another embodiment of the present invention includes: obtaining information on a payment method of a business where a mobile terminal is disposed by using location information of the mobile terminal in operation S2410; performing a primary payment by using one-time payment information for the primary payment in operation S2430; obtaining information on a transaction method of a business where a mobile terminal is disposed by using a mobile receipt in operation S2450; outputting a notification for inducing a secondary payment in operation S2470; and performing a secondary payment by using one-time payment information for canceling the primary payment and one-time payment information for an actual transaction payment.

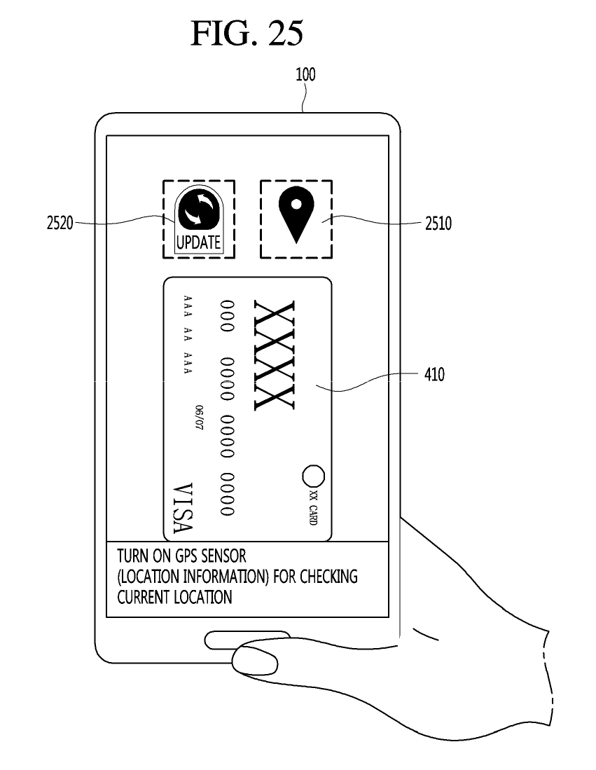

Among them, obtaining information on a payment method of a business where a mobile terminal is disposed by using location information of the mobile terminal in operation S2410 is described with reference to FIG. 25.

FIG. 25 is a view illustrating a method of obtaining information on a transaction method of a business where the mobile terminal 100 is disposed and a method of updating information on a business where a provisional approval transaction is performed, according to an embodiment of the present invention.

When an input for executing a payment application is received, the control unit 180 may turn on a GPS function of the mobile terminal 100 and display a UI 2510 for representing that the GPS function is activated. Additionally, in order to receive a wireless signal transmitted from a business where the mobile terminal 100 is disposed, the control unit 180 may turn on a wireless signal reception function of the mobile terminal and display a UI for representing that the wireless signal reception function is activated.

In this case, the control unit 180 may obtain information on a transaction method at a business where the mobile terminal 100 is disposed on the basis of at least one of coordinates information of the mobile terminal 100 and signal information received by the mobile terminal 100.

Moreover, when a business where a provisional approval transaction is performed is updated in a server (not shown), the control unit 180 may display a UI 2520 for representing that the business where the provisional approval transaction is performed is updated. Moreover, when an input for selecting the UI 2520 for representing that the business where the provisional approval transaction is performed is updated is received, the control unit 180 may receive information on the updated business where a provisional approval transaction is performed and store it in the storage unit 170.

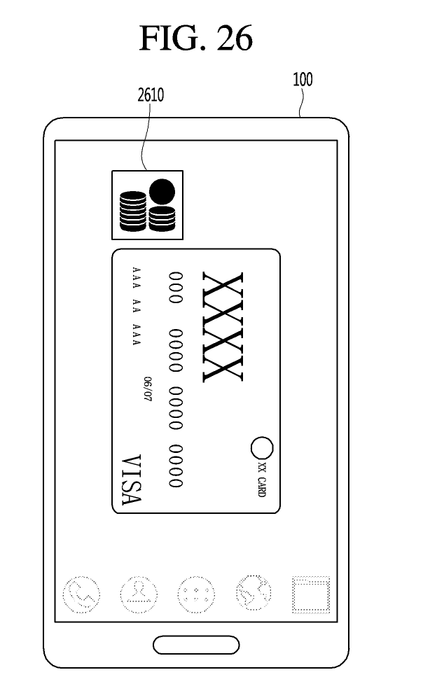

FIG. 26 is a view illustrating an operating method of a mobile terminal when a transaction method of a business where a mobile terminal is disposed is a provisional approval transaction according to an embodiment of the present invention.

Referring to FIG. 26, a UI 2610 for representing that a transaction method at a business where a mobile terminal is disposed is a provisional approval transaction may be displayed.

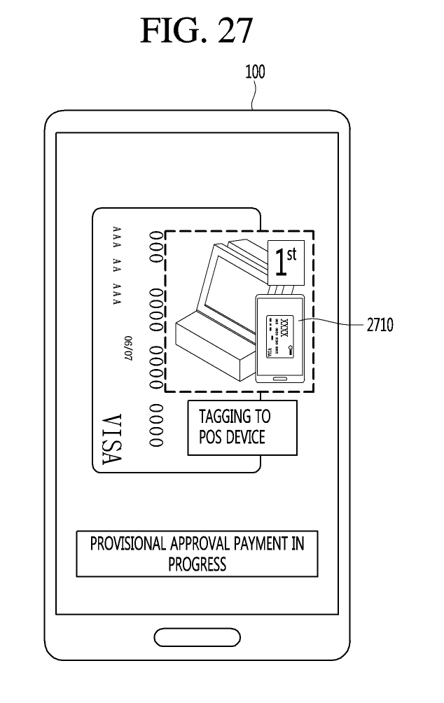

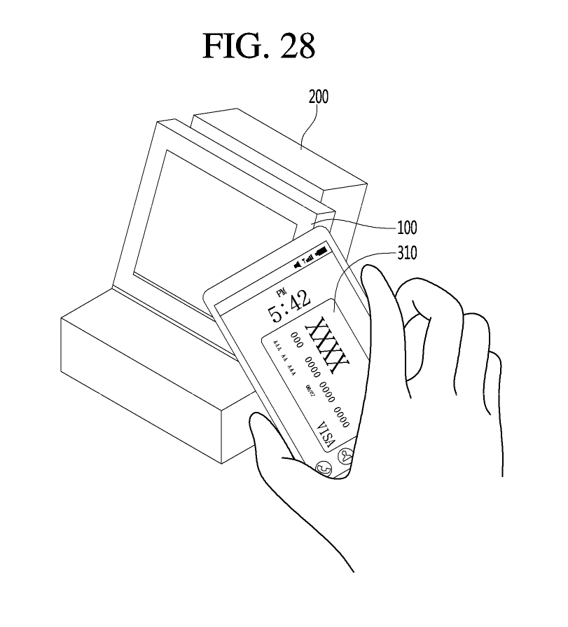

Referring to FIG. 24 again, an operating method of a mobile terminal according to another embodiment of the present invention may include performing a primary payment by using one-time payment information in operation S2430. This will be described in more detail with reference to FIGS. 27 and 28.

FIGS. 27 and 28 are views illustrating a method of performing a primary payment in the first mode according to an embodiment of the present invention.

When the payment mode of the mobile terminal 100 is the first mode, the control unit 180 may perform a primary payment. Herein, the primary payment may be a provisional approval payment.

In more detail, when user authentication is completed through a fingerprint, the control unit 180 may generate one-time payment information and one-time payment information including an authentication value linked with a payment time.

Additionally, as show in FIG. 28, when the mobile terminal 100 is tagged to a POS terminal, the control unit 180 may transmit the generated one-time payment information to the POS terminal.

Moreover, a POS terminal that receives one-time payment information may transmit the one-time payment information in addition to a guarantee amount to a card company server, and the card company server may approve a provisional approval payment on the guarantee amount.

Moreover, as shown in FIG. 27, when the payment mode of the mobile terminal 100 is the first mode and user authentication is completed through a fingerprint, the control unit 180 may display a UI 2710 for representing that the current payment is a primary payment, that is, a provisional approval payment.

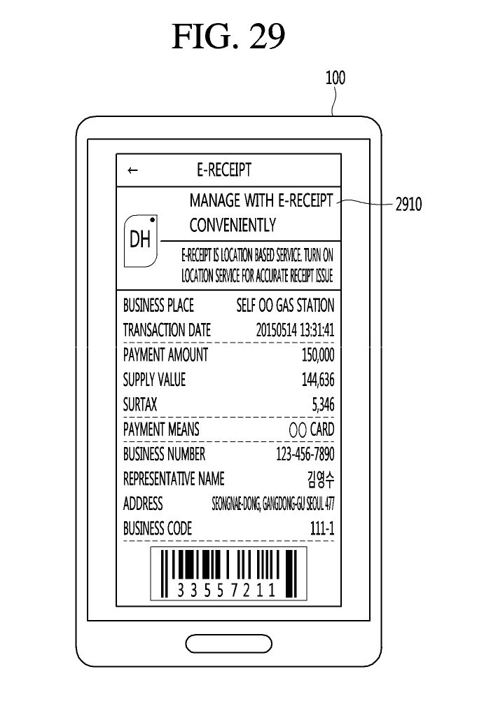

Referring to FIG. 24 again, an operating method of a mobile terminal according to another embodiment of the present invention may include obtaining information on a payment method of a business where a mobile terminal is disposed by using a mobile receipt in operation S2450. This will be described in detail with reference to FIG. 29.

Moreover, although it is described with reference to FIG. 24 that an operating method of a mobile terminal according to another embodiment of the present invention includes obtaining information on a payment method of a business where a mobile terminal is disposed by using location information of the mobile terminal in operation S2410, obtaining information on a payment method of a business where a mobile terminal is disposed by using location information of the mobile terminal in operation S2410 may be omitted.

Instead of that, when a primary payment is performed in the first mode and a mobile receipt for the primary payment is received, the control unit 180 may obtain information on a transaction method of a business where the primary payment is performed on the basis of information included in the mobile receipt.

FIG. 29 is a view illustrating a method of obtaining information on a transaction method of a business where a mobile terminal is disposed by using a mobile receipt according to an embodiment of the present invention.

When a card company server (not shown) approves a primary payment, that is, a provisional approval payment, it may transmit a mobile receipt for the approved provisional approval payment to the mobile terminal 100.

FIG. 29 illustrates a mobile receipt 2910 received by the mobile terminal 100.

The mobile receipt 2910 may include information on at least one of a business name, a representative, an address, and a business type code.

Moreover, the control unit 180 may obtain information on a transaction method at a business where the mobile terminal 100 performs a primary payment on the basis of the information on at least one of a business name, a representative, an address, and a business type code included in the mobile receipt 2910.

For example, when the business name “ [symbol] ◯◯ gas station” or “self ◯◯ gas station” is included in the mobile receipt 2910, the control unit 180 may obtain information that a payment is performed at a business where the mobile terminal 100 performs a primary payment through a provisional approval transaction method and accordingly, the primary payment is a provisional approval payment.

For example, when the business type code “477” is included in the mobile receipt 2910 and is a business type code of gas station industry, the control unit 180 may obtain information that a payment is performed at a business where the mobile terminal 100 performs a primary payment through a provisional approval transaction method and accordingly, the primary payment is a provisional approval payment on the basis of the business name and the business type code.

As another example, the control unit 180 may receive information on a business where a provisional approval transaction is performed from a server (not shown) and store the received information in the storage unit 170. Herein, the information on a business where a provisional approval transaction is performed may include at least one of addresses of a plurality of businesses where a provisional approval transaction is performed and representatives of a plurality of businesses where a provisional approval transaction is performed.

In this case, when a representative included in the mobile receipt 2910 corresponds to the representative of a business where a provisional approval transaction stored in the storage unit 170 is performed, the control unit 180 may obtain information that a payment is performed at a business where the mobile terminal 100 performs a primary payment through a provisional approval transaction method and accordingly, the primary payment is a provisional approval payment.

Additionally, when an address included in the mobile receipt 2910 corresponds to the address of a business where a provisional approval transaction stored in the storage unit 170 is performed, the control unit 180 may obtain information that a payment is performed at a business where the mobile terminal 100 performs a primary payment through a provisional approval transaction method and accordingly, the primary payment is a provisional approval payment.

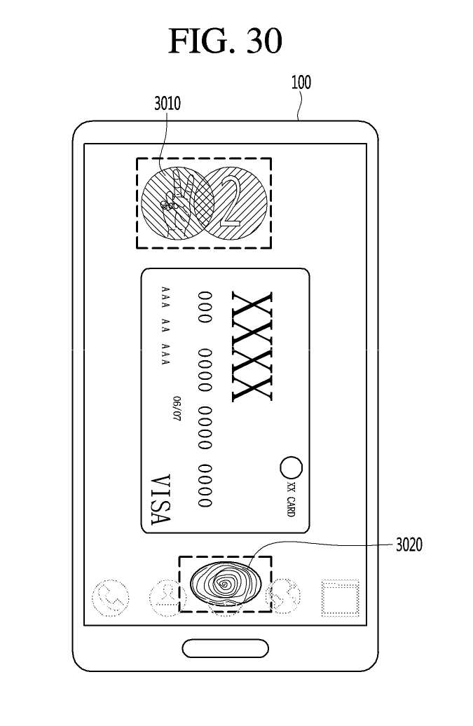

Referring to FIG. 24 again, an operating method of a mobile terminal according to another embodiment of the present invention may include outputting a notification for inducing a secondary payment in operation S2470. This will be described in detail with reference to FIG. 30.

FIG. 30 is a view illustrating a method of outputting a notification for inducing a secondary payment according to an embodiment of the present invention.

When a provisional approval transaction is performed using a fixed token in the second mode, unlike one-time tagging is required, in order to complete a provisional approval transaction in the first mode, a primary tagging for provisional approval payment, provisional approval payment cancellation, and a secondary tagging for actual payment are required.

Accordingly, the control unit 180 may display UIs 3010 and 3020 for representing that a user's secondary payment is required. For example, the control unit 180 may display the UI 3010 for representing the number 2. As another example, the control unit 180 may display the UI 3020 for inducing a user's finger touch in order to induce a user's fingerprint authentication necessary for the secondary payment. Moreover, the control unit 180 may display the UI 3020 for inducing a user's finger touch to blink periodically.

Referring to FIG. 24 again, an operating method of a mobile terminal according to another embodiment of the present invention may include performing a secondary payment by using one-time payment information for canceling a primary payment and one-time payment information for secondary payment in operation S2490.

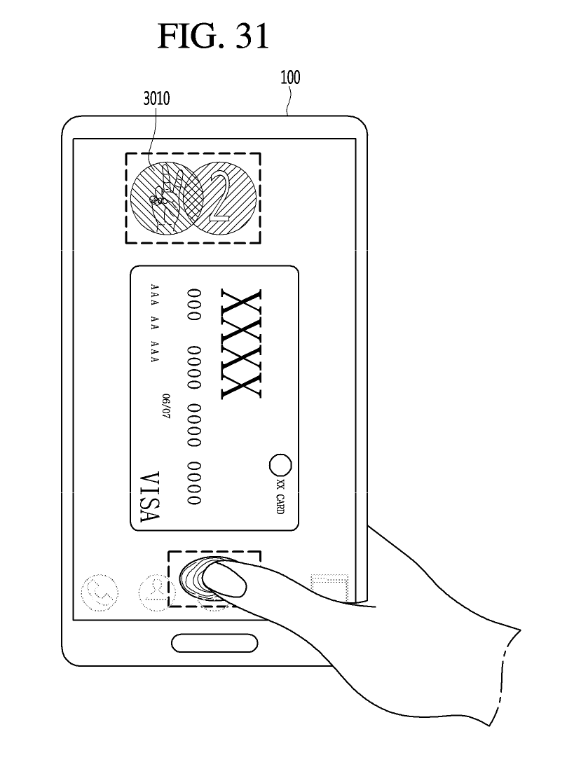

This will be described in more detail with reference to FIGS. 31 to 34.

FIG. 31 is a view illustrating a method of performing a secondary payment depending on a user's fingerprint authentication according to an embodiment of the present invention.

When the payment mode of the mobile terminal 100 is the first mode and a primary payment is performed, the control unit 180 may perform a secondary payment. Herein, a process for performing a secondary payment includes a process for canceling a provisional approval payment and a process for performing an actual transaction payment.

In more detail, as shown in FIG. 31, when user authentication is completed through a fingerprint, the control unit 180 may generate one-time payment information including a first one-time token and an authentication value linked with a payment time. Herein, the first one-time payment information may be one-time payment information for canceling a primary payment, that is, a provisional approval payment.

Additionally, the control unit 180 may generate second one-time payment information including a second one-time token and an authentication value linked with a payment time in addition to generating first one-time payment information. Herein, the second one-time payment information may be one-time payment information for actual transaction payment.

Moreover, when the mobile terminal 100 is secondarily tagged to a POS terminal, the control unit 180 may transmit the generated first and second one-time payment information to the POS terminal.

Moreover, a POS terminal that receives first one-time payment information may transmit a cancellation request for a transaction (i.e., a provisional approval transaction) for a guarantee amount in addition to first one-time payment information to a card company server.

Additionally, a POS terminal that receives second one-time payment information may transmit an authentication request of an actual transaction amount in addition to second one-time payment information to a card company server.

In this case, when a card company server (not shown) compares a one-time token and an authentication value included in first one-time payment information with a token and an authentication value stored in the card company server (not shown) and they correspond to each other, a transaction for guarantee amount (i.e., a provisional approval transaction) may be cancelled.

Additionally, when a card company server (not shown) compares a one-time token and an authentication value included in second one-time payment information with a token and an authentication value stored in the card company server (not shown) and they correspond to each other, an actual transaction payment for actual transaction amount may be approved.

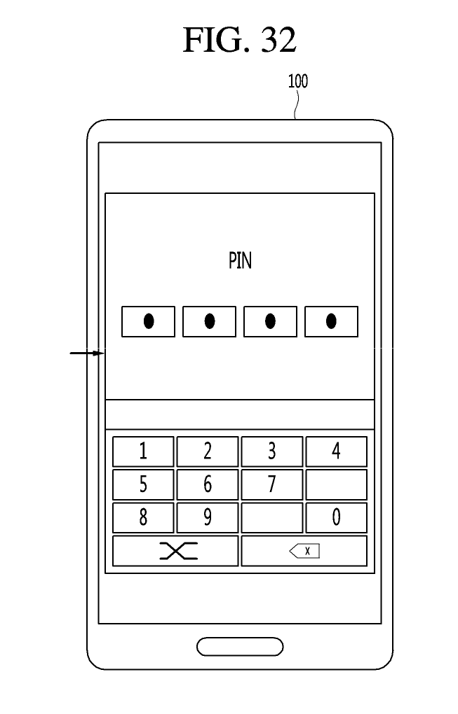

FIG. 32 is a view illustrating an authentication method for payment according to another embodiment of the present invention.

The above embodiment describes that authentication through a fingerprint is required in order to perform a payment. However, the present invention is not limited thereto, and as shown in FIG. 32, a user of the mobile terminal 100 may be authenticated through a method of inputting a PIN code.

Additionally, a user authentication method through the input of a PIN code may be applied to at least one of a user authentication for payment in the second mode, a user authentication for primary payment in the first mode, and a user authentication for secondary payment in the first mode.

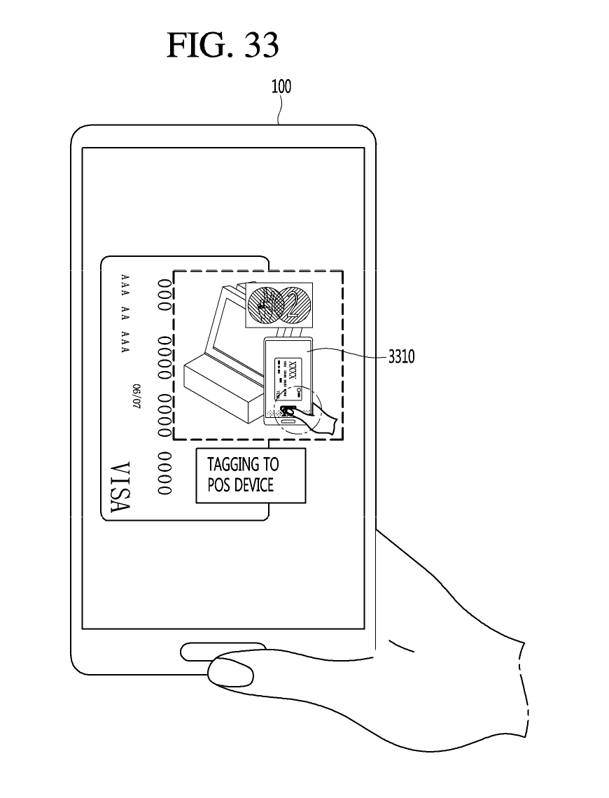

FIG. 33 is a view illustrating a method of inducing the tagging of the mobile terminal 100 after an authentication for secondary payment is completed according to an embodiment of the present invention.

The control unit 180 may a display UI 3310 for representing that it is necessary that the mobile terminal 100 is tagged to a POS terminal in order for a secondary payment. Moreover, the tagging of the mobile terminal 100 is required for a secondary payment and the UI 3310 for representing that tagging to a POS terminal is required may include information that this time payment is a second payment.

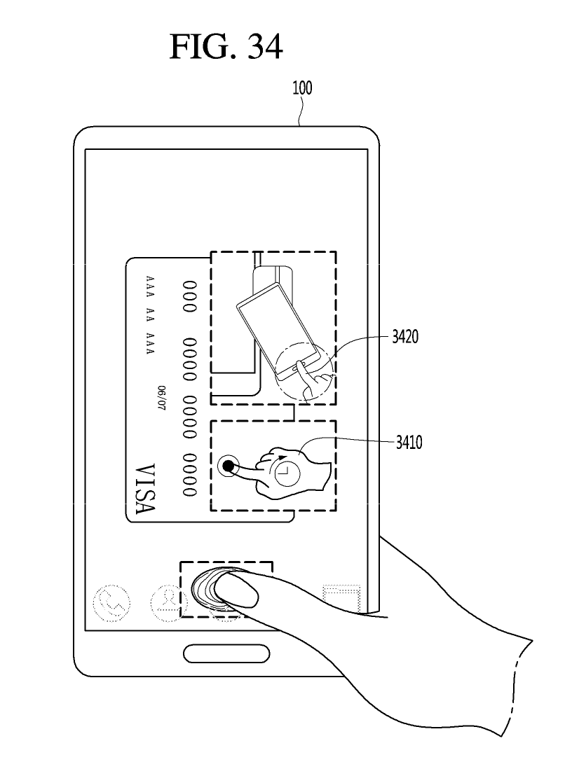

FIG. 34 is a view illustrating a tagging method for a secondary payment according to an embodiment of the present invention.

The secondary payment is a process for canceling a primary payment and performing an actual transaction payment and is required to be distinguished from another payment.

Accordingly, when the mobile terminal 100 is tagged to a POS terminal in a state that a touch on a fingerprint sensor is maintained, the control unit 180 may transmit first one-time payment information and second one-time payment information to the POS terminal.

In this case, the control unit 180 may display UIs 3410 and 3420 for representing that a finger's touch is required to be maintained.

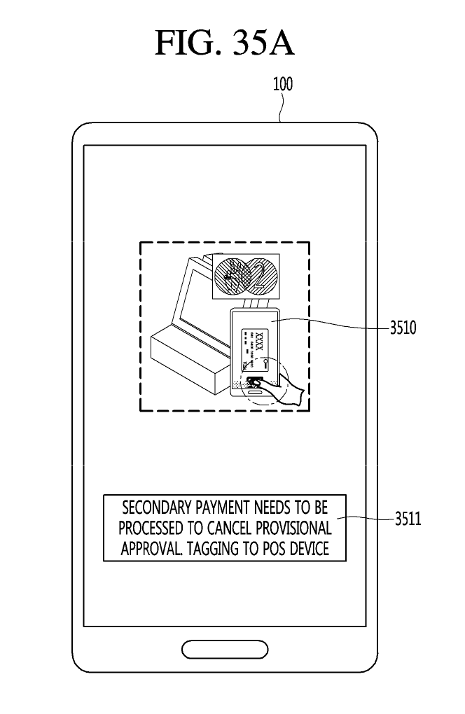

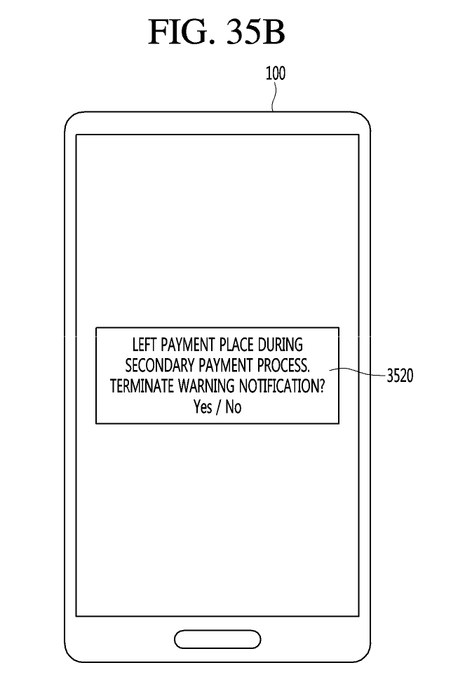

FIGS. 35A to 35B are views illustrating an operating method of a mobile terminal when a user leaves a place before a secondary payment is performed according to an embodiment of the present invention.

The control unit 180 may obtain information on a location change of the mobile terminal 100 on the basis of at least one of coordinates information of the mobile terminal 100, signal information received by the mobile terminal 100, and information on a movement of the mobile terminal 100 sensed through the sensing unit 140.

Additionally, when the location of the mobile terminal 100 is out of more than a threshold value, the control unit 180 may output a warning notification.

Specifically, the control unit 180, as shown in FIG. 35A, may display a UI 3510 for representing that a secondary payment is required. Moreover, the UI 3510 for representing that a secondary payment is required may include information 3511 for representing that a primary payment is cancelled when the secondary payment is performed.

Additionally, although not shown in the drawings, when the location of the mobile terminal 100 is changed more than a threshold value in a state that a secondary payment is not performed, the control unit 180 may control the sound output unit 152 to output a warning sound or control the haptic module 153 to output a vibration signal for warning.

Moreover, when a predetermine time elapses after a warning is outputted, the control unit 180, as shown in FIG. 35B, may display a UI 3520 for terminating a warning notification. Moreover, when a warning notification is terminated by a user input, the control unit 180 may display an icon for representing that there is a primary payment to be cancelled.

The present invention may allow a user to perform a provisional approval transaction in the first mode using one-time payment information.

That is, by allowing a user, who is aware that a provisional approval transaction is possible through a one-time tagging in the second mode, to perform a payment for a provisional approval transaction in the first mode, a provisional approval transaction may be performed according to a user's selection.

Additionally, according to the present invention, by allowing a provisional approval transaction in the first mode, a user, who is not aware that the business of the current transaction makes a deal through a provisional approval transaction method and starts to perform a payment in the first mode, may complete the payment in the first mode without restarting the payment in the second mode.

Additionally, by displaying a UI for inducing a primary payment and a secondary payment, a user, who is not aware that the business of the current transaction makes a deal through a provisional approval transaction method and starts to perform a payment in the first mode, may complete a provisional approval transaction according to the induction of the mobile terminal 100.

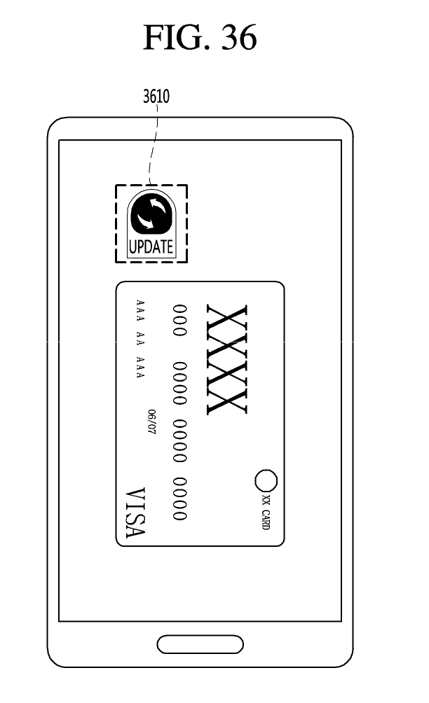

FIG. 36 is a view illustrating an operating method when location information of the mobile terminal 100 is not obtained according to an embodiment of the present invention.

It is described in the above embodiment that by receiving location information on a business where a provisional approval transaction is performed from a server (not shown) and comparing the location information on a business where a provisional approval transaction is performed with location information of the current mobile terminal 100, it is determined whether a business where the mobile terminal 100 is disposed is a business where a provisional approval transaction method is applied.

Moreover, when a business where a provisional approval transaction is performed is registered in a server (not shown) but is not updated in the mobile terminal 100, the control unit 180 may display a UI 3610 for representing that an update for a business where a provisional approval transaction is performed is required. Then, when an input on the UI 3610 for representing that an update for a business where a provisional approval transaction is performed is required is received, the control unit 180 may receive information on a business where an approval transaction is performed from the server (not shown) and update the information.

Moreover, it is described in the above embodiment that the mobile terminal 100 generates fixed payment information including a fixed token and location information of the mobile terminal 100 and transmit it in the second mode.

However, in a case that location of the mobile terminal 100 cannot be obtained (for example, when the mobile terminal 100 is located in the underground and thus cannot receive GPS location information), the control unit 180 may switch a payment mode from the second mode using fixed payment information to the first mode using one-time payment information.

In this case, as described with reference to FIGS. 24 to 35, an operation method of the mobile terminal 100 in the first mode may be applied.

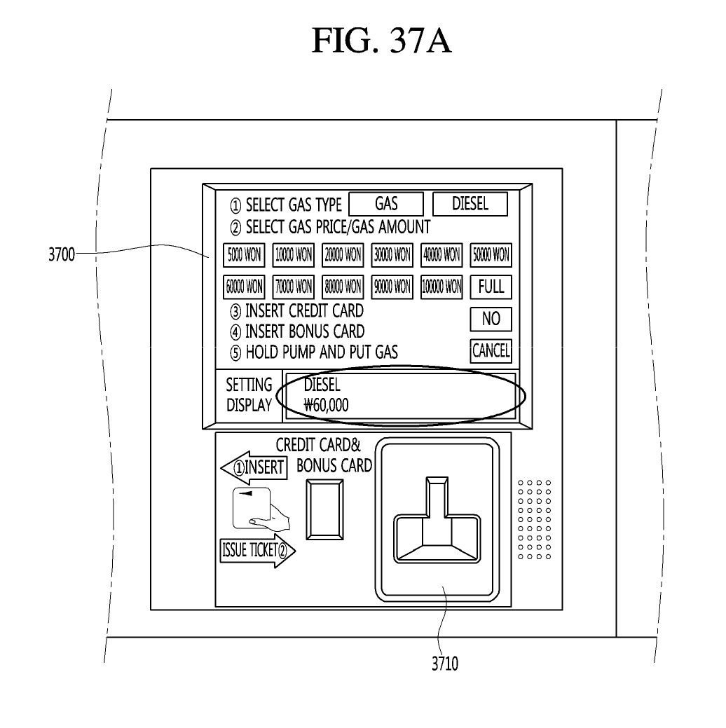

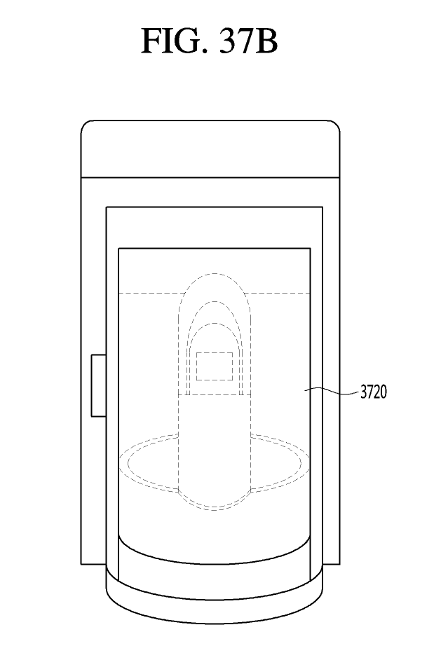

FIGS. 37A and 37B are views illustrating a shield device according to an embodiment of the present invention.

In order to prevent fire accidents caused by electromagnetic waves, most gas stations dealing with flammable substances are generally equipped with an installed explosion-proof device having an electromagnetic shielding function. However, in a case of an MST method for generating a magnetic field and delivering payment information to a POS terminal, as electromagnetic waves are blocked, the transmission of payment information is impossible.

Accordingly, as shown in FIG. 37A, a groove 3710 for receiving payment information from the mobile terminal 100 may be mounted at a lubricator. In this case, a communication unit for receiving payment information of a POS terminal may be installed in the groove 3710 for receiving payment information.

Then, when a user of the mobile terminal 100 puts down the mobile terminal 100 in the groove 3710 for receiving payment information in order to transmit payment information, the payment information may be transmitted from the mobile terminal 100 to a communication unit of a POS terminal.

In this case, although electromagnetic shield processing is performed inside the groove 3710 for receiving payment information, payment information may be received because electromagnetic shield processing is not performed on the communication unit of the POS terminal inside the groove 3710 for receiving payment information.

On the other hand, as shown in FIG. 37B, an additional shield payment device 3720 may be installed at the lubricator 3700.

Moreover, electromagnetic shield processing may be performed on the shield payment device 3720 and accordingly, the shield payment device 3720 may prevent the external leakage of electromagnetic waves generated from the inside of the shield payment device 3720.

Moreover, the communication unit of the POS terminal may be installed in the shield payment device 3720 and when a user puts the mobile terminal 100 in the shield payment device 3720, payment information may be received from the mobile terminal.

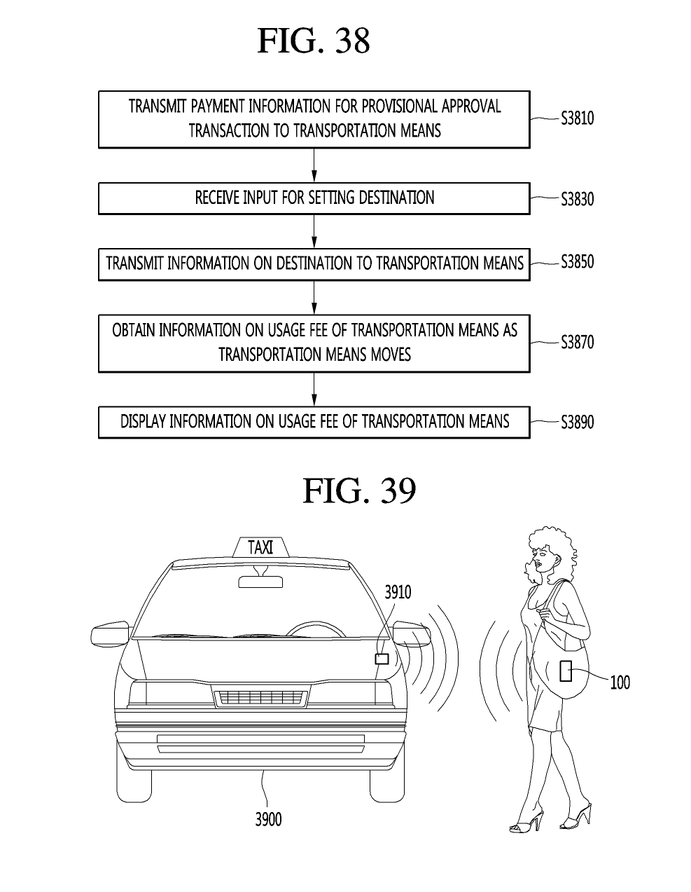

FIG. 38 is a flowchart illustrating an operating method of a mobile terminal according to another embodiment of the present invention.

Referring to FIG. 38, an operating method of the mobile terminal 100 according to an embodiment of the present invention may include: transmitting payment information for provisional approval transaction to a transportation means in operation S3810; receiving an input for setting a destination of a user of a mobile terminal in operation S3830; transmitting information on the destination to the transportation means on the basis of the received input in operation S3850; obtaining information on a usage fee of the transportation means as the transportation means is moved to the destination after a provisional approval payment is approved in operation S3870; and displaying information on the usage fee of the transportation means in operation S3890.

Moreover, receiving an input for setting a destination of a user of a mobile terminal in operation S3830 and transmitting information on the destination to the transportation means on the basis of the received input in operation S3850 may be omitted.

Transmitting payment information for provisional approval transaction to a transportation means in operation S3810 will be described in detail with reference to FIG. 39.

FIG. 39 is a view illustrating a method for transmitting payment information for a provisional approval transaction to a transportation means according to an embodiment of the present invention.

The provisional approval transaction is described below again. When a final payment amount is not determined, a purchaser requests the approval for a provisional approval payment with respect to a guarantee amount from a card company, and when the purchaser has a payment ability for the guarantee amount, the card company approves the provisional approval transaction. Then, when the final payment amount is determined, the seller requests the cancellation of a provisional approval payment and the approval of a transaction for a final payment amount and the card company cancels the provisional approval payment of a deposit and approves an actual transaction for the final payment amount, so that a credit card payment is performed. Hereinafter, a transaction method in which a provisional approval payment, a provisional approval payment cancellation, and an actual transaction approval are completed is referred to as “a provisional approval transaction method” and described.

Additionally, the transportation means described in this specification may include bus, taxi, train, subway, airplane, etc. but the present invention is not limited thereto, and the transportation means may mean all means for transporting persons or moving luggage. Additionally, the transportation means may include unmanned taxi or unmanned orbital taxi (for example, Personal Rapid Transit (PRT)).

In this specification, an unmanned taxi is described as one example but the present invention is not limited thereto, and the context of the present invention may be applied to all transportation means.

A transportation means 3900 may transmit a wireless signal. A wireless signal transmitted from the transportation means 3900 has a similar meaning to “subscription” in a contract, and when the transportation means 3900 is operable currently (for example, the transportation means 3900 carries another passenger or is not in maintenance), it may transmit a wireless signal. Herein, the wireless signal may be a beacon signal. However, the present invention is not limited thereto and a wireless signal may include at least one of a Bluetooth™ signal, a Radio Frequency Identification (RFID) signal, an Infrared Data Association (IrDA) signal, an Ultra Wideband (UWB) signal, a ZigBee signal, a Near Field Communication (NFC) signal, a Wireless-Fidelity (Wi-Fi) signal, a Wi-Fi Direct signal, and a Wireless Universal Serial Bus (USB) signal.

Moreover, the transportation means 3900 may keep the doors locked in order to prevent passenger boarding when a contract is not established

When a wireless signal transmitted from the transportation means 3900 is received, the control unit 180 may transmit payment information for a provisional approval transaction to the transportation means 3900.

In more detail, the control unit 180 may receive an input for setting the automatic boarding in a transportation means when approaching through the input unit 120 or the sensing unit 140. Then, when a wireless signal transmitted from the transportation means 3900 is received in a state that an input for setting the automatic boarding in a transportation means when approaching is received, the control unit 180 may transmit payment information for a provisional approval transaction to the transportation means 3900.

In this case, in order to prevent malfunction, when a user approaches the transportation means 3900 by less than a specific distance or a user is located at a specific location around the transportation means 3900, payment information for a provisional approval transaction may be transmitted.

For example, the control unit 180 may obtain information on a distance between the mobile terminal 100 and the transportation means 3900 by using the intensity of the received wireless signal, and when the mobile terminal 100 is located within a specific distance with respect to the transportation means 3900, the control unit 180 may transmit payment information for a provisional approval transaction to the transportation means 3900.

Moreover, the transportation means 3900 may include the communication unit 3910 for transmitting a wireless signal and receiving payment information for a provisional approval payment from the mobile terminal 100. Then, the transportation means 3900 may transmit a wireless signal in a specific direction (for example, a passenger-side door direction or a passenger rear seat side door direction). Moreover, when a user of the mobile terminal 100 is located in a passenger-side door direction or a passenger rear seat side door direction, the mobile terminal 100 may receive a wireless signal transmitted from the transportation means 3900 and transmit payment information for a provisional approval payment to the communication unit 210 included in the transportation means 3900.

Moreover, although it is described in this embodiment that when a wireless signal is received from the transportation means 3900, the mobile terminal 100 transmits payment information for a provisional approval payment to the transportation means 3900, the present invention is not limited thereto.

For example, when a wireless signal is received from the transportation means 3900 as the mobile terminal 100 approaches the transportation means 3900, the control unit 180 may display a UI for representing that a wireless signal is received from the transportation means 3900 and it is possible to board on the transportation means 3900. In this case, when an input for transmitting payment information for a provisional approval payment is received from a user, the control unit 180 may transmit provisional approval payment information to the transportation means 3900.

Moreover, according to an embodiment described later in FIG. 15, a destination, a transition, and a moving path may be set before a user boards a transportation means. Then, when a destination, a transition, and a moving path are set before a user boards a transportation means, the control unit 180, as mentioned above, may transmit information on at least one of a destination, a transition, and a moving path of a transportation means while transmitting payment information for a provisional approval transaction to the transportation means 3900.

Moreover, the control unit 180 may perform a payment in the first mode and perform a payment in the second mode.

Herein, the first mode, as a mode for general transaction, may be a mode for performing a payment by using one-time payment information.

Herein, in relation to a general card payment system, when a purchaser requests a card payment, a seller requests the approval of a transaction for a payment amount from a card company, and when the card company approves the transaction, the card company pays money for the payment amount to the seller, and the card company charges the purchaser for the money for the payment amount, and this transaction method is different from the above-mentioned provisional approval transaction method.

Moreover, the second mode, as a mode for a provisional approval transaction, may be a mode for performing a payment by using fixed payment information.

Furthermore, the control unit 180 may determine the payment mode of the mobile terminal 100. In more detail, the control unit 180 may determine the payment mode of the mobile terminal 180 as one of the first mode and the second mode on the basis of at least one of signal information received by the mobile terminal 100.

The control unit 180 may obtain information on a transaction method at a business where the mobile terminal 100 is disposed. Herein, the business where the control unit 180 is disposed may include a transportation means 3900. That is, when the mobile terminal 100 is disposed around the transportation means 3900, the control unit 180 may obtain information on a transaction method of the transportation means 3900 that transmits a wireless signal by receiving a wireless signal.

That is, although it is described with reference to FIG. 4 that information on a payment method of a business where the mobile terminal 100 is disposed is obtained based on at least one of coordinates information of the mobile terminal 100 and signal information received by the mobile terminal 100, in the case of the transportation means 3900 that is not located at a fixed place, information that the transaction method of the transportation means 3900 is a provisional approval transaction may be obtained based on signal information that the mobile terminal 100 receives from the transportation means 3900.

However, the present invention is not limited thereto. For example, as described later, when a transportation means 5200 is a bus, as a user is located at a bus stop, the mobile terminal 100 may receive a wireless signal transmitted from the bus stop. In this case, the control unit 180 may obtain information that a transaction method of the transportation means 5200 is a provisional approval transaction on the basis of the ID of a bus stop included in the wireless signal and coordinates information of the bus stop.

Additionally, when a transportation means is an unmanned taxi stopping at a taxi stop or an unmanned orbit taxi (for example, PRT) stopping at a predetermined station, information that a transaction method of a transportation means is a provisional approval transaction may be obtained on the basis of a wireless signal transmitted from a taxi stop or a station.

Furthermore, when a transaction of the transportation means 3900 is performed by a provisional approval transaction method, as a wireless signal transmitted from the transportation means 3900 is received, the control unit 180 may determine the payment mode of the mobile terminal 100 as the second mode. In more detail, the transportation means 3900 where a transaction is performed by a provisional approval transaction method may transmit a wireless signal when the current operation is possible, and when a wireless signal transmitted from the transportation means 3900 is received, the control unit 180 may determine the payment mode of the mobile terminal 100 as the second mode. As another example, the control unit 180 may receive identification information of a transportation means where a transaction is performed through a provisional approval transaction method, from a server (not shown) and store it in the storage unit 170, and when identification information included in a wireless signal transmitted from the transportation means 3900 corresponds to identification information stored in the storage unit 170, the control unit 180 may determine the payment mode of the mobile terminal 100 as the second mode.

Moreover, the payment mode of the mobile terminal 100 may be set to the first mode by default and when a transaction method at a business where the mobile terminal 100 is disposed is a provisional approval transaction method, the control unit 100 may change the payment mode of the mobile terminal 100 from the first mode to the second mode.

Furthermore, according to this embodiment, when information on a transaction method at a business where the mobile terminal 100 is disposed is obtained, it is descried that the payment mode of the mobile terminal 100 automatically changes from the first mode to the second mode However, the present invention is not limited thereto, and when information on a transaction method at a business where the mobile terminal 100 is disposed is obtained, as described with reference to FIG. 5, the control unit 180 may output a notification for representing that a transaction method at a business where the mobile terminal 100 is disposed is a provisional approval transaction. Additionally, as described in operation 5350, when receiving an input for switching a mode for performing a payment by the mobile terminal 100 to the second mode, the control unit 180 may switch the mode for performing a payment by the mobile terminal 100 from the first mode to the second mode. In this case, various input methods described with reference to FIGS. 6 to 12 may be applied.

Moreover, a process for performing a payment in the first mode is described later and a specific process for performing a payment in the second mode is described herein.

Payment information for a provisional approval transaction that the mobile terminal 100 transmits to the transportation means 3900 may be fixed payment information including a fixed token.

In more detail, when a wireless signal is received from the transportation means 3900, the control unit 180 may generate fixed payment information including a fixed token. Herein, the fixed token is a virtual card number that replaces an actual card number of a card used for a payment and may be provide from a card company server.

However, although a fixed token has a fixed value regardless of the generated time point, the present invention is not limited thereto, and the fixed token may be renewed (or changed) by a specific period unit (for example, on a daily basis) and after a payment is performed by using fixed payment information including a fixed token, if the mobile terminal 100 is out of a location where a payment is performed, the fixed token is renewed (or changed), so that a new fixed token may be stored. Moreover, the fixed payment information may be information obtained by combining the fixed token and another authentication value.

Moreover, the control unit 180 may store a fixed token in the storage unit 170. In this case, the fixed token may be may be stored in a separated security area in the storage unit 170.

Moreover, the control unit 180 may generate fixed payment information including a fixed token and an authentication value by using the fixed token stored in the storage unit 170.

When the fixed payment information is generated, the control unit 180 may transmit the fixed payment information to the transportation means 3900.

Moreover, the mobile terminal 100 may transmit at least one of an NFC type signal, an MST type signal, and a beacon signal, including the fixed payment information, to the transportation means 3900. However, the type of a signal is not limited thereto, and all communication methods implementable in the mobile terminal 100 may be used.

Moreover, when fixed payment information is received, the transportation means 3900 may transmit fixed payment information and information on a guarantee amount to a card company server (not shown).

In this case, the card company server (not shown) may approve a provisional approval payment by using the fixed payment information. In more detail, a card company server (not shown) compares a fixed token included in fixed payment information with a token stored in the card company server and if they are identical, authenticates a transaction for guarantee amount (for example, a provisional approval transaction). Moreover, when an actual transaction amount is determined as the transportation means 3900 arrives at the destination, the transportation means 3900 may request the cancellation of a transaction for a guarantee account (i.e., a provisional approval transaction) and the approval of an actual transaction amount (i.e., an actual transaction approval) from a card company server (not shown), and the card company server (not shown) may cancel the transaction for a guarantee amount (i.e., a provisional approval transaction) and approves the actual transaction amount (i.e., approves the actual transaction) to transmit a final notification to the mobile terminal 100.

Moreover, the fixed payment information may include signal information that the mobile terminal 100 receives from the transportation means 3900. In more detail, the control unit 180 may generate fixed payment information including a fixed token and signal information received by the mobile terminal 100 to transmit it to the transportation means 3900.

In this case, a card company server (not shown) compares a fixed token and signal information received by the mobile terminal 100 included in fixed payment information with a token and signal information of a business (for example, a transportation means) where a transaction is performed through a provisional payment method stored in the card company server, thereby approving a transaction requested from the mobile terminal 100.

In detail, the card company server (not shown) may establish and retain a database of signal information of a transportation means where a payment is performed through a provisional approval transaction method. In detail, the card company server (not shown) may establish and retain a database of signal information of a transportation means where a payment is performed through a provisional approval transaction method.

In this case, a card company server (not shown) compares a fixed token included in fixed payment information with a token stored in the card company server (not shown) to determine whether they are identical. Additionally, the card company server (not shown) may compare signal information received by the mobile terminal 100 and signal information of the transportation means 3900 where a payment is performed through a provisional approval payment method to determine whether they are identical.

Then, when a fixed token included in fixed payment information is identical to a token stored in the card company server (not shown) and signal information received by the mobile terminal 100 is identical to signal information, which is stored in the card company server (not shown), of the transportation means 3900 where a payment is performed through a provisional approval payment method, the card company server (not shown) may approve a provisional approval payment requested from the mobile terminal 100. Furthermore, when the payment is completed, the control unit 180 may renew (or change) the fixed token.

Moreover, when the provisional approval payment is approved, the transportation means 3900 may unlock its door to allow a user of the mobile terminal 100 to board. Moreover, when the provisional approval payment is not approved, the transportation means 3900 may not unlock its door and maintain its unlocked door.

Additionally, when the provisional approval payment is approved, the transportation means 3900 may move to the destination. Moreover, when the provisional approval payment is not approved, the transportation means 3900 may not move to the destination.

Furthermore, a plurality of sensing units (not shown) for sensing the mobile terminal 100 may be mounted in the transportation means 3900 and when a sensing unit (not shown) senses the mobile terminal 100 (that is, when a user of the mobile terminal 100 boards), the transportation means 3900 may move to the destination.

As another example, the control unit 180 of the mobile terminal 100 may transmit identification information of the mobile terminal 100 in addition to payment information for provisional approval transaction to the transportation means 3900. Additionally, the control unit 180 may transmit a wireless signal including identification information of the mobile terminal 100 and when a user boards to the inside of the transportation means 3900, a communication unit (not shown) in the transportation means 3900 may receive a wireless signal including identification information of the mobile terminal 100. Moreover, when the identification information of the mobile terminal 100 received in addition to payment information is identical to identification information included in the wireless signal transmitted from the mobile terminal 100 and received by the communication unit (not shown) in the transportation means 3900, the transportation means 3900 may determine that a user who pays a charge boards. In this case, the transportation means 3900 may move to the destination.

Furthermore, when the mobile terminal 100 is not sensed through the sensing unit (not shown) (for example, when a user of the mobile terminal 100 pays a charge but does not board or when a person who has no intention too board the transportation means 3900 but pays a charge accidentally), the transportation means 3900 may request the cancellation of the provisional approval payment from the card company server (not shown) and the card company server (not shown) may cancel the provisional approval payment.

Moreover, although it is described in this specification that the transportation means 3900 is used through a provisional approval transaction, the present invention is not limited thereto. That is, as the control 180 transmits payment information for general transaction to a transportation means, the transportation means 3900 may be used.

Additionally, payment information transmitted from the mobile terminal 180 to the transportation means 3900 may be payment information of a transportation card in which an amount for using the transportation means 3900 is charged in advance instead of information for credit card payment.

Moreover, although it is described in this embodiment that once a provisional approval payment is completed, a user of the mobile terminal 100 boards the transportation means 3900, the present invention is not limited thereto.

For example, the mobile terminal 100 that receives a wireless signal from the transportation means 3900 transmits authentication information of the mobile terminal 100 to the transportation means 3900 and the transportation means 3900 authenticates the user of the mobile terminal 100 by using the authentication information of the mobile terminal 100 to unlock the door.

In this case, when a user of the mobile terminal 100 boards the transportation means 3900, information may be transmitted. In more detail, a communication unit (not shown) for transmitting a wireless signal to request a payment from the mobile terminal 100 may be mounted in the transportation means 3900. Moreover, as a user of the mobile terminal 100 boards the transportation means 3900, when the mobile terminal 100 receives a wireless signal for requesting a payment from the mobile terminal 100, the control unit 180 may transmit payment information for provisional approval transaction to the communication unit (not shown) mounted in the transportation means 3900. In this case, the transportation means 3900 may transmit the payment information to the card company server (not shown) to request a provisional approval payment from the card company server (not shown).

Furthermore, a wireless signal transmitted from a communication unit (not shown) mounted in the transportation means 3900 may be a beacon signal. However, the present invention is not limited thereto and a wireless signal transmitted from a communication unit (not shown) mounted in the transportation means 3900 may include at least one of a Bluetooth™ signal, a Radio Frequency Identification (RFID) signal, an Infrared Data Association (IrDA) signal, an Ultra Wideband (UWB) signal, a ZigBee signal, a Near Field Communication (NFC) signal, a Wireless-Fidelity (Wi-Fi) signal, a Wi-Fi Direct signal, and a Wireless Universal Serial Bus (USB) signal.

Moreover, the present invention is not limited thereto, and after a user of the mobile terminal 100 boards the transportation means 3900 and the mobile terminal 100 is tagged to a POS terminal mounted in the transportation means 3900, payment information is transmitted to the transportation means 3900.

Moreover, although it is described in this embodiment that the transportation means 3900 transmits a wireless signal and the mobile terminal 100 that receives the wireless signal transmits payment information, the present invention is not limited thereto.

For example, a user may execute a payment application to automatically transmit payment information to the transportation means 3900. In this case, when the mobile terminal 100 accesses the communication unit 3910 mounted in the transportation means 3900, the control unit 180 may transmit payment information to the communication unit 3910 mounted in the transportation means 3900.

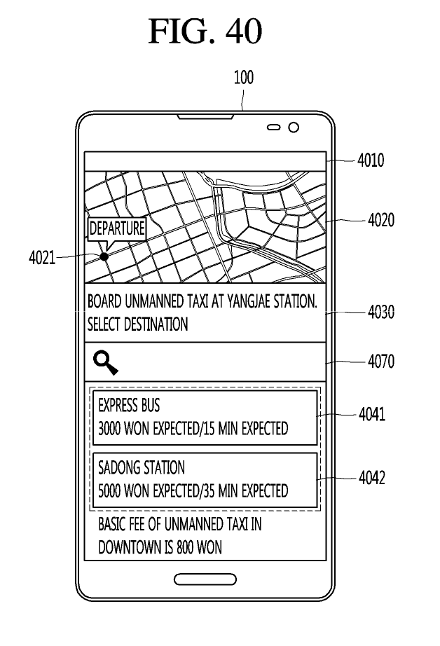

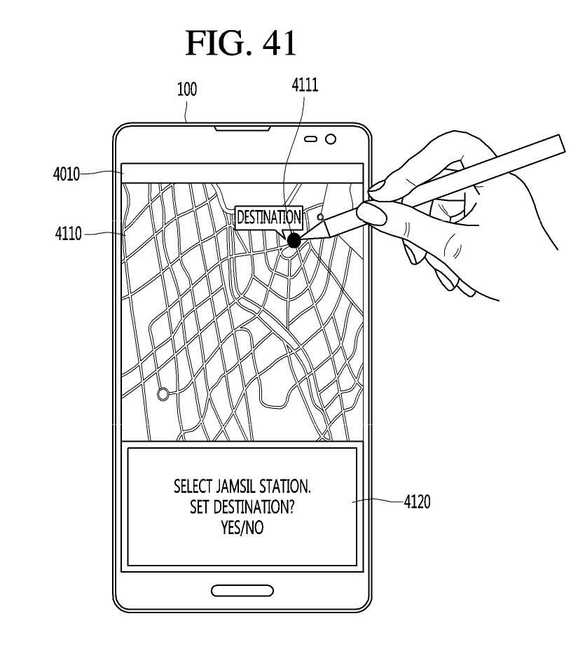

Referring to FIG. 38 again, an operating method of the mobile terminal 100 according to an embodiment of the present invention may include receiving an input for setting a destination of a user of a mobile terminal in operation S3830 and transmitting information on the destination to the transportation on the basis of the received input in operation S3850. This will be described in more detail with reference to FIGS. 40 and 41.

FIGS. 40 and 41 are views illustrating a method of setting a destination of the transportation means 3900 according to an embodiment of the present invention.

Referring to FIG. 40, when a user boards the transportation means 3900, an itinerary management application may be executed.

In more detail, a communication unit (not shown) for transmitting a variety of information to the mobile terminal 100 and receiving information from the mobile terminal 100 may be mounted in the transportation means 3900. Moreover, when a signal transmitted from the communication unit (not shown) is received, the control unit 180 may execute the itinerary management application and display the execution screen 4010 of the itinerary management application.

Moreover, the control unit 180 may obtain location information of the mobile terminal 100 to display information 4030 on the departure of the transportation manes 3900.

Additionally, the control unit 180 may display a map 4020 and display a UI 4021 for representing that the current location on the map 4020.

Moreover, information on a region where a user frequently moves may be stored in the storage unit 170 and the control unit 180 may display information 4041 and 4042 on the region where a user frequently moves. Herein, the information 4041 and 4042 on the region where a user frequently moves may include information on at least one of the name of a region where a user frequently moves, a moving time to a region where a user frequently moves, and an expected cost when moving to a region where a user frequently moves.

Furthermore, the control unit 180 may receive an input for setting the destination of a user of the mobile terminal 100.

For example, as shown in FIG. 41, when an input for touching a specific point 4111 on the map 4110 is received, the control unit 180 may determine that a region corresponding to the specific point 4111 is the destination. For example, a region corresponding to the specific point 4111 is “jamsil station”, the control unit 180 may determine that “jamsil station” is the destination and store location information of “jamsil station” in the storage unit 170.

Moreover, without storing information on a region corresponding to the specific point 4111, it is possible to store coordinates information of the specific point 4111. In this case, the mobile terminal 100 may transmit the coordinates information of the specific point 4111 to the transportation means 3900 and the transportation means 3900 may move to the destination on the basis of the coordinates information of the specific point 4111.

Moreover, as an input for enlarging the map 4111 is received, the control unit 180 may display the enlarged map 4111.

Furthermore, the control unit 180 may transmit information on the set destination to a communication unit (not shown) of the transportation means 3900.

Moreover, although it is described in the above embodiment that a destination is set by touching the specific point 4111 of the map 4110, the present invention is not limited thereto. For example, as shown in FIG. 40, an input window 4070 for searching for a destination may be displayed and a user may search for the destination by using the input window 4070.

Moreover, an input for setting a destination may be a voice input received through the microphone 122.

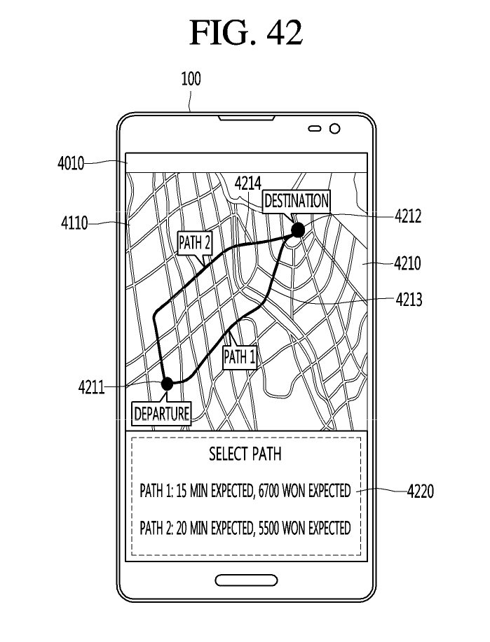

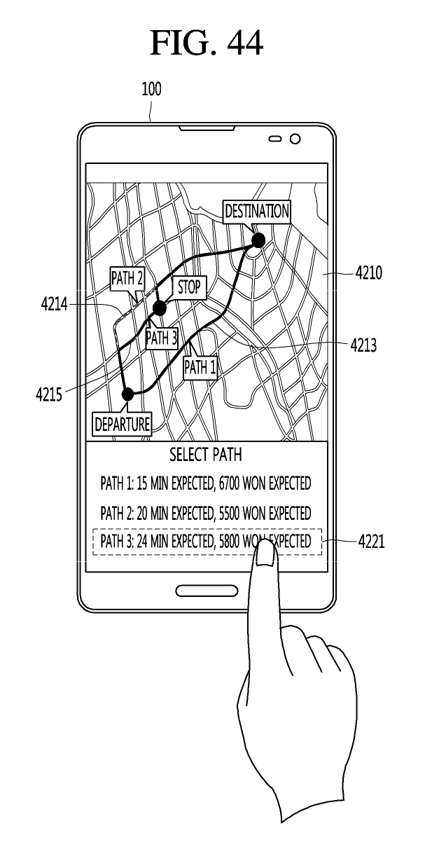

Moreover, when a destination is transmitted to the transportation means 3900, the transportation means 3900 may move to the destination by using its navigation system. However, the present invention is not limited thereto, a user of the mobile terminal 100 may directly specify a moving path of the transportation means 3900. This will be described in more detail with reference to FIGS. 42 and 44.

FIG. 42 is a view illustrating a method of specifying a moving path of the transportation means 3900 according to an embodiment of the present invention.

As described with reference to FIG. 41, once a destination is determined, the control unit 180 may obtain information on at least one path 4213 and 4214 through which the transportation means 3900 moves to the destination 4212.

As one example, the control unit 180 may obtain information on at least one path for moving to a destination by using a navigation app installed in the mobile terminal 100. However, the present invention is not limited thereto and when the control unit 180 transmits information on a user's destination to the transportation means 3900, the transportation means 3900 may obtain information on at least one path for moving to the destination by using its navigation system and the control unit 180 may obtain information on at least one path for moving to the destination by receiving the at least one path for moving to the destination from the transportation means 3900.

Furthermore, the control unit 180 may display information on at least one path through which the transportation means 3900 moves to the destination. Herein, information on at least one path for moving to the destination may include at least one of UIs 4213 and 4214 for representing at least one path for moving to the destination and information 4220 on a time and cost taken when using a path.

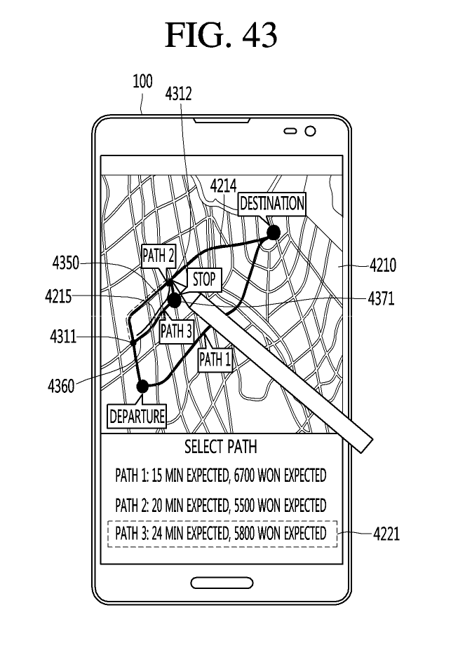

Moreover, a path obtained by the mobile terminal 100 and displayed may be modified by a user. This will be described in detail with reference to FIG. 43.

FIG. 43 is a view illustrating a method of editing a path through which the transportation means 3900 moves according to an embodiment of the present invention.

Referring to FIG. 43, the control unit 180 may receive an input for changing a path through which a transportation means moves to a destination through the input unit 120 or the sensing unit 140.

When a second path 4214 is selected by a user input and a first point 4311 and a second point 4312 on the second path 4214 are selected by a user input, a section 4350 between the first point 4311 and the second point 4312 on the second path 4214 may be changed.

Moreover, as a moving input is received after a user's body or a touch pen touches, the control unit 180 may display a UI 4360 corresponding to a moving path of the user's body or the touch pen. Additionally, the control unit 180 may change a path of a section between the first point 4311 and the second point 4312 on the second path 4214 into a path 4360 corresponding to a moving path of the user's body or the touch pen.

Furthermore, the control unit 180 may display information 4221 on a time and cost taken when using the changed path.

Moreover, although it is described in this embodiment that a path is changed according to a touch input, the present invention is not limited thereto, and all known methods for changing a path on a map according to a user input may be applied.

Furthermore, the control unit 180 may receive an input for setting a stop of the transportation means 3900.

For example, as shown in FIG. 43, when an input for touching a specific point 4371 on a moving path 4215 of the transportation means 3900 is received, the control unit 180 may determine that a region corresponding to the specific point 4371 is a stop. Furthermore, the control unit 180 may transmit information on the set stop to a communication unit (not shown) of the transportation means 3900. In this case, the transportation means 3900 may first move to the stop and stop and again move to the destination.

Moreover, this embodiment describes a change of a moving path but the present invention is not limited thereto. For example, a user may input a moving path to a destination in addition to setting the destination through a setting method using a user's body or a touch pen described with reference to FIG. 43. In this case, the control unit 180 may transmit information on the destination and the moving path to the transportation means 3900.

FIG. 44 is a view illustrating a method of transmitting a destination or a moving path according to an embodiment of the present invention.

The control unit 180 may receive an input for selecting a specific path 4215 from at least one path 4213, 4214, and 4215 through which the transportation means 3900 moves to the destination. Furthermore, the control unit 180 may transmit information on the destination and information on the specific path 4215 to a communication unit (not shown) of the transportation means 3900.

Moreover, the transportation means 3900 that receives information on a destination and information on a specific path may move to the destination through a specific path.

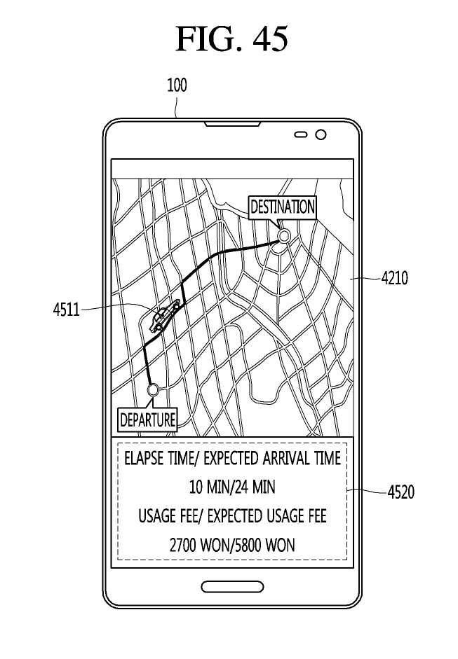

FIG. 45 is a view illustrating a screen displayed on the mobile terminal 100 while the transportation means 3900 moves to a destination according to an embodiment of the present invention.

The control unit 180 may obtain information on the current location of the transportation means 3900. In more detail, the control unit 180 may obtain information on the current location of the transportation means 3900 on the basis of GPS coordinates information received through the wireless communication unit 110.

However, the present invention is not limited thereto. In more detail, the transportation means 3900 may obtain information on the current location of the transportation means 3900 by using its navigation system, and transmit the obtained information to the mobile terminal 100 through a communication unit (not shown). In this case, as receiving information on the current location of the transportation means 3900 through the wireless communication unit 110, the control unit 180 may obtain the current location of the transportation means 3900.

Furthermore, the control unit 180 may display the current location of the transportation means 3900 by displaying a UI 911 corresponding to the current location of the transportation means 3900.

Furthermore, the control unit 180 may display moving information 4520 of the transportation means 3900. Herein, the moving information 4520 of the transportation means 3900 may include at least one of an elapse time after start and an expected arrival time.

Additionally, the control unit 180 may display information on a usage fee of a transportation means.

In more detail, the transportation means 3900 may include a fee charging unit (not shown), and the fee charging unit (not shown) may calculate the current usage fee according to a moving distance of the transportation means 3900 and calculate an expected usage fee from the departure to the destination on the basis of the remaining moving distance of the transportation means 3900 and real-time traffic information. Moreover, the communication unit (not shown) of the transportation means 3900 may transmit information on at least one of the current usage fee and the expected usage fee to the mobile terminal 100. Moreover, the control unit 180 that receives the information on at least one of the current usage fee and the expected usage fee may display information on at least one of the current usage fee and the expected usage fee. In this case, the moving information 4520 of the transportation means 3900 may include information on at least one of the current usage fee and the expected usage fee.

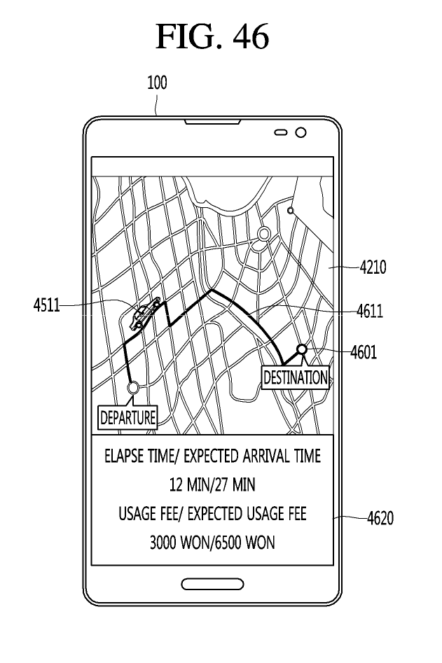

FIG. 46 is a view illustrating a method of changing at least one of the destination and moving path of the transportation means 3900 according to an embodiment of the present invention.

The control unit 180 may receive an input for changing at least one of the destination of the transportation means 3900 and a moving path of the transportation means 3900. That is, while the transportation means 3900 moves, a user may change at least one of the destination and the moving path by using the mobile terminal 100.

In more detail, while the transportation means 3900 moves, when an input for changing the destination through the same method as setting the destination described with reference to FIG. 41 is received, the control unit 180 may display a UI 4601 for representing a location on a map of the changed destination. Additionally, the control unit 180 may transmit information on the changed destination to a communication unit (not shown) of the transportation means 3900.

Additionally, the control unit 180 may obtain information on at least one path for moving to the changed destination through the method described with reference to FIG. 42, and modify a path through which the transportation means 3900 moves through the method described with reference to FIG. 43.

Additionally, when a path through which the transportation means 3900 moves to the changed destination is determined, a path 4611 through the transportation means 3900 moves to the changed destination may be displayed, and through a method described with reference to FIG. 44, information on the changed destination and a moving path to the changed destination may be transmitted to the transportation means 3900.

In this case, the transportation means 3900 may move to the changed destination through a moving path to the changed destination.

Additionally, the control unit 180 may display moving information 4620 of the transportation means 3900 through a method described with reference to FIG. 10. Herein, the moving information 4620 of the transportation means 3900 may display information on at least one of an elapse time after start, an expected arrival time to a changed destination, a current usage fee, and an expected usage fee to a changed destination.

Moreover, this embodiment describes that a destination and a moving path are changed but the present invention is not limited thereto. For example, the control unit 180 may receive an input for changing only a moving path of the transportation means 3900 and transmit information on the changed moving path to the transportation means 3900.

Additionally, a moving path may be maintained identically and only a destination may be changed.

Moreover, although it is described in this embodiment that only a destination and a moving path of the transportation means 3900 are controlled through the mobile terminal 100, the present invention is not limited thereto. For example, at least one of stop and restart, the maximum speed, and a driving option (for example, comfortable ride at a slow speed or somewhat uncomfortable ride at a high speed) of the transportation means 3900 may be controlled through the mobile terminal 100.

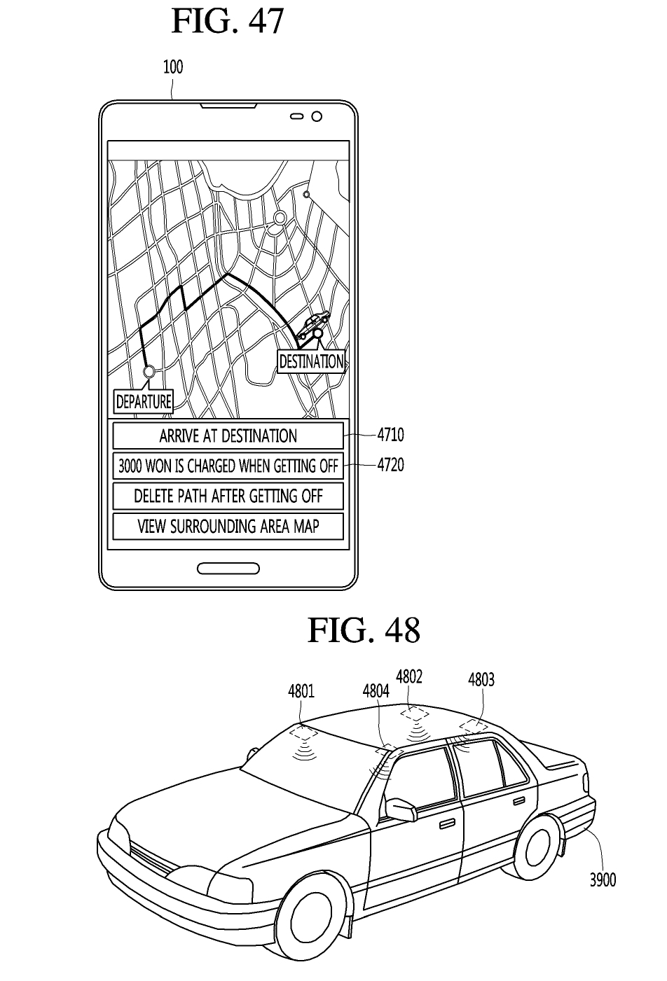

FIG. 47 is a view illustrating a display screen of a mobile terminal when the transportation means 3900 arrives at a destination according to an embodiment of the present invention.

The control unit 180 may obtain information that the transportation means 3900 arrives at a destination. In more detail, the control unit 180 may obtain information that the transportation means 3900 arrives at a destination on the basis of GPS coordinates information received through the wireless communication unit 110 and information on a destination stored in the storage unit 170.

However, the present invention is not limited thereto, and the transportation means 3900 transmits the information that the transportation means 3900 arrives at the destination to the mobile terminal 100, so that the mobile terminal 100 may obtain the information that the transportation means 3900 arrives at the destination.

Furthermore, when the transportation means 3900 arrives at the destination, the control unit 180 may output a notification that the transportation means 3900 arrives at the destination. For example, the control unit 180 may output a notification hat the transportation means 3900 arrives at the destination through a form of a sound signal or a vibration signal. As another example, when the transportation means 3900 arrives at the destination, the control unit 180 may display a UI 4710 for representing that the transportation means 3900 arrives at the destination.

Moreover, the control unit 180 may obtain information on a usage fee of the transportation means 3900. In more detail, a fee charging unit (not shown) of the transportation means 3900 may calculate a usage fee to a destination according to a moving distance of the transportation means 3900 and a communication unit (not shown) of the transportation means 3900 may transmit information on the usage fee to a destination to the mobile terminal 100. Furthermore, the control unit 180 that receives the information on the usage fee to a destination may display information 4720 on the usage fee to a destination.

FIG. 48 is a view illustrating a method of detecting getting off of the mobile terminal 100 and calculating a fee according to an embodiment of the present invention.

Referring to FIG. 48, at least one sensing unit 4801, 4802, 4803, and 4804 for sensing the mobile terminal 100 or a user of the mobile terminal 100 may be mounted in the transportation means 3900 and the transportation means 3900 may obtain information that a user of the mobile terminal 100 gets off on the basis of a detection result from the sensing units 4801, 4802, 4803, and 4804.

As another example, the mobile terminal 100 may transmit a wireless signal including identification information of the mobile terminal 100, and when a wireless signal including the identification information of the mobile terminal 100 is not received any more through a communication unit (not shown) in the transportation means 3900, the transportation means 3900 may obtain information that a user of the mobile terminal 100 gets off.

Moreover, the transportation means 3900 may request the cancellation of a provisional approval payment and the actual transaction approval from a card company server (not shown).

When a provisional approval payment is performed as a user of the mobile terminal 100 boards the transportation means 3900, a payment for guarantee amount is approved.

In this case, the transportation means 3900 may request the cancellation of a payment for guarantee amount (for example, the cancellation of a provisional approval payment) and the approval of a transaction for usage fee to a destination (for example, an actual transaction approval) from a card company server (not shown).

In this case, the card company server (not shown) cancels the payment for guarantee amount and approves the actual transaction for a usage fee to a destination.

Referring to FIG. 38 again, an operating method of the mobile terminal 100 according to an embodiment of the present invention may include obtaining information on a usage fee of the transportation means as the transportation means is moved to the destination after a provisional approval payment is approved in operation S3870 and displaying information on the usage fee of the transportation means in operation S3890.

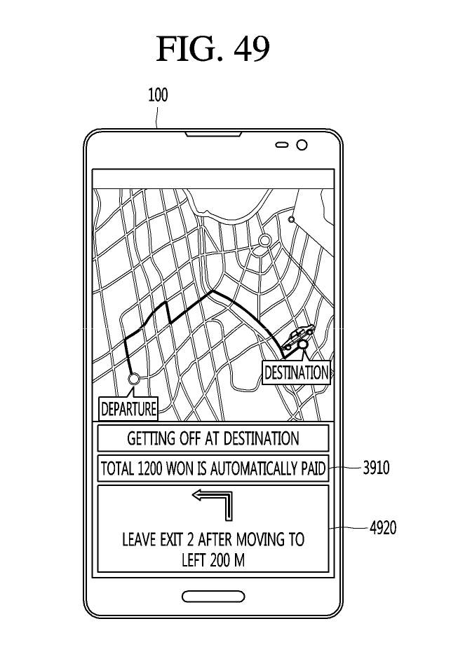

This will be described in detail with reference to FIG. 49.

FIG. 49 is a view illustrating a mobile terminal where a usage fee of a transportation means is displayed according to an embodiment of the present invention.

It is described with reference to FIGS. 45 and 46 that as the transportation means 3900 moves, a usage fee of the transportation means 3900, that is, a usage fee until now and an expected usage fee, is displayed. However, this is just a middle fee and an expected amount, and a final usage fee for the transportation means 3900 may be displayed when a provisional approval transaction is completed.

In more detail, when a provisional approval transaction is completed, that is, after a provisional approval payment is approved, when the provisional approval payment is cancelled and an actual transaction for usage fee to a destination is approved, the card company server (not shown) may transmit information on a usage fee to a destination where an actual transaction is approved, to the mobile terminal 100.

Moreover, as receiving information on a usage fee to the destination where an actual transaction is approved from a card company server (not shown), the control unit 180 may obtain information on a usage fee of the transportation means 3900.

Moreover, the control unit 180 may display information 4910 on a usage fee through which an actual transaction is approved.

Moreover, when the mobile terminal 100 arrives at a destination, the control unit 180 may store information on a destination and a moving path in the storage unit 170. In this case, information stored in the storage unit 170 may be used to recommend a path to a user later.

However, the present invention is not limited thereto and in order to protect privacy protection, the control unit 180 may detect information on a destination and a moving path.

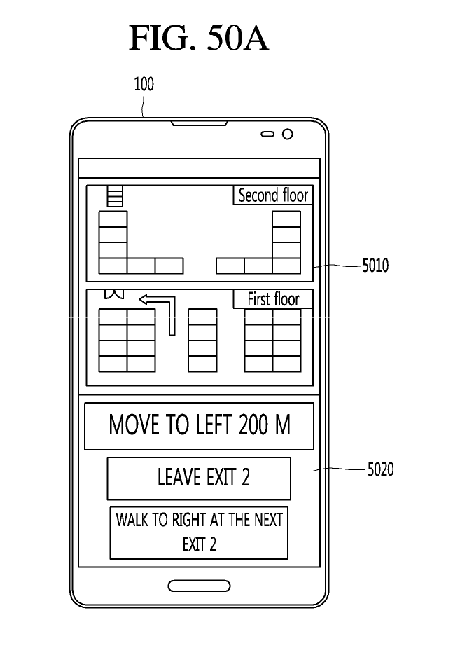

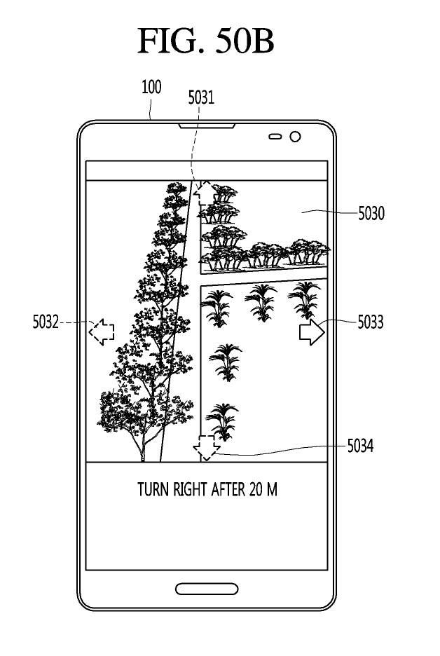

Moreover, the control unit 180 may display a UI 4920 for guiding a user to a destination. This will be described in more detail with reference to FIGS. 50A and 50B.

FIGS. 50A and 50B are views illustrating a method of guiding a walking path to a destination according to an embodiment of the present invention.

It is described in the previous embodiment that when information on a destination is transmitted to the transportation means 3900, the transportation means 3900 moves to the destination. However, the present invention is not limited thereto, and a user may input a final destination in addition to the destination of the transportation means 3900. Additionally, when a user is unable to move to the inputted final destination through the transportation means 3900, the control unit 180 may obtain information on a destination to which the transportation means 3900 is able to move, which is the closest to the final destination, and transmit it to the transportation means 3900.

Moreover, when a user who arrives at the destination gets off the transportation means 3900 and a wireless signal transmitted from the transportation means 3900 is not detected any more, the control unit 180 may display a walking path to the final destination.

In this case, the control unit 180 may display a map 5010 including a road path and the map 5010 including the road path may include an indoor map as shown in FIG. 50A, in addition to an outdoor map. Moreover, information on the location of the mobile terminal 100 in a room may be obtained based on at least one wireless signal received by the mobile terminal 100.

Furthermore, the control unit 180 may display at least one of a moving direction, a moving distance, a transfer path, and an exit path of a transportation means.

Moreover, the control unit 180 may obtain information on an angle of the mobile terminal 100 through the sensing unit 140. Additionally, when the mobile terminal 100 is disposed at a specific angle with respect to the ground, the control unit 180, as shown in FIG. 50B, may display an image 5030 actually obtained from the mobile terminal 100 and UIs 5031, 5032, 5033, and 5034 for representing directions.

For example, in a state that a user lays down the mobile terminal 1000 (for example, when the rear surface of a mobile terminal faces the ground), as shown in FIG. 50A, a map 5010 may be displayed.

However, in a state that a user lays down the mobile terminal 1000 (for example, when the rear surface of a mobile terminal faces the ground), when the user stands up the mobile terminal 100 (for example, the rear surface of a mobile terminal faces the user's front), the control unit 180 may receive an image through a camera mounted at the rear surface of the mobile terminal 100. Furthermore, the control unit 180 may display the received image 5030. Additionally, the control unit 180 may display the UI 5033 for representing a direction in which a user is to move from the current location, from the plurality of UIs 5031, 5032, 5033, and 5034 for representing a plurality of respective directions.

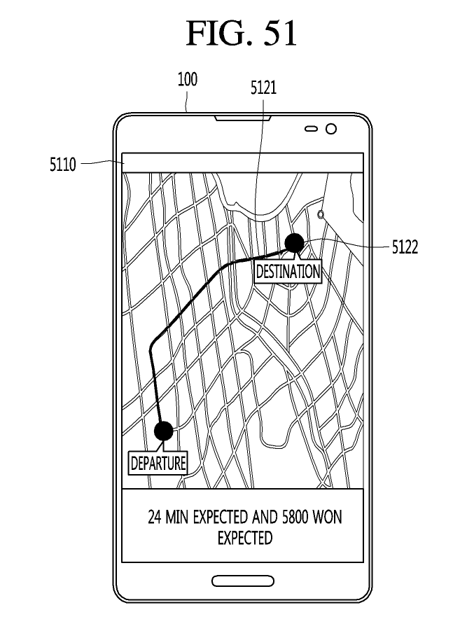

FIG. 51 is a view illustrating a destination setting method according to another embodiment of the present invention.

It is described with reference to FIG. 40 that when a user boards the transportation means 3900, as an itinerary management application is executed, a user may input a destination.

However, the present invention is not limited thereto, and a user may set a destination before boarding the transportation means 3900.

In more detail, when an input for executing an itinerary management application is received, the control unit 180, as shown in FIG. 51, may display an execution screen 5110 of the itinerary management application.

Additionally, the control unit 180 may receive an input for setting at least one of a destination 5122 and a moving path 5121 of the transportation means 3900. Moreover, all the above-mentioned methods of setting a destination and a moving path of the transportation means 3900 may be applied to a method of setting a destination and a moving path of the transportation means 3900.

Moreover, the control unit 180 may display a UI for setting whether to board automatically. Additionally, in a state that an input for the UI for setting whether to board automatically is received, when a wireless signal transmitted from the transportation means 3900 is received, the control unit 180 may transmit payment information for a provisional approval transaction to the transportation 3900.

Moreover, in a state that it is not set that a user boards automatically, payment information may be transmitted according to an input of a user of the mobile terminal 100. Alternatively, as a user of the mobile terminal 100 is directly tagged to a payment terminal in the transportation means 3900, a payment may be performed.

Moreover, although it is described with reference to FIG. 45 that before a user boards the transportation means 3900, only payment information is transmitted, and after the user boards the transportation means 3900, information on a destination is transmitted, the present invention is not limited thereto.

For example, the control unit 180 may transmit, to the transportation means 3900, information on at least one of a destination and a moving path of the transportation means 3900 in addition to payment information for provisional approval transaction.

In this case, even if an additional procedure for transmitting a destination is omitted after a user boards the transportation means 3900, the transportation means 3900 may move to the destination.

In such a way, the present invention may allow a direct payment through a mobile terminal so that it is possible to prevent the inconvenience of purchasing a ticket for boarding a transportation means or charging a transportation card.

Additionally, the present invention may provide an environment in which a user uses a transportation means without an operation for paying a fee.

Additionally, the present invention may prevent a user who has no ability to pay a cost from using a transportation means by introducing a provisional approval transaction when the user uses the transportation means.

Additionally, the present invention provides an environment that easily sets and changes a destination and a moving path of a transportation means through a mobile terminal.

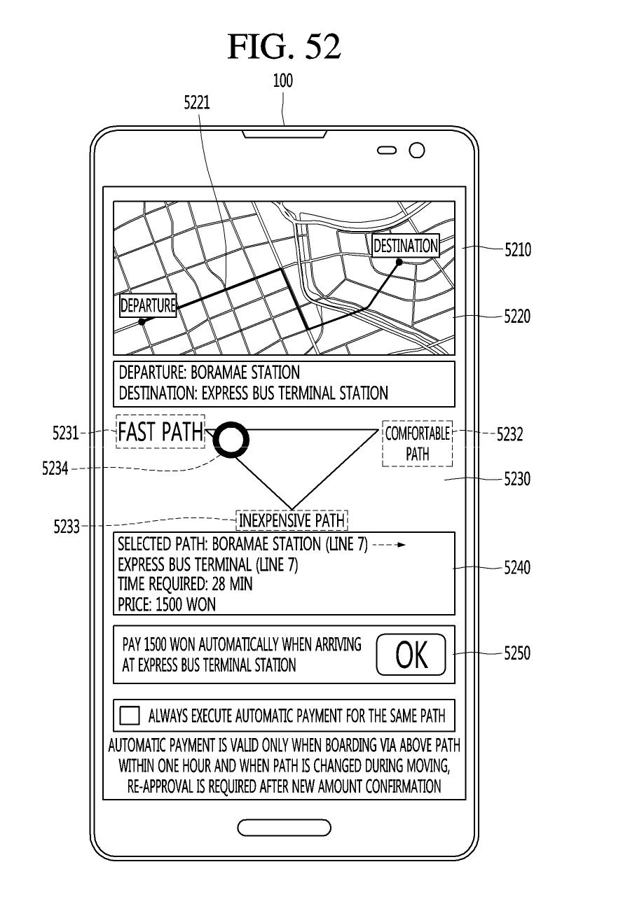

FIG. 52 is a view illustrating an operating method of a mobile terminal according to another embodiment of the present invention.

It is assumed and described in FIGS. 39 to 51 that the transportation means 3900 is an unmanned taxi. It is assumed and described in FIGS. 52 to 61 that the transportation means 5200 is an unmanned taxi.

FIG. 52 is a view illustrating an operation of the mobile terminal 100 for recommending a moving path of a user.

The control unit 180 may obtain information on a departure by obtaining location information of a user. In more detail, the control unit 180 may obtain location information of a user by obtaining coordinates information of the mobile terminal 100 through the wireless communication unit 110.

Additionally, when a user is at a bus stop, the mobile terminal 100 may receive a wireless signal transmitted from the bus stop. In this case, the control unit 180 may obtain location information of a user on the basis of the ID of a bus stop included in a wireless signal.

Moreover, when boarding the transportation means 5200, a user may set a destination by executing an itinerary management application. In this case, the control unit 180 may display a screen 5210 for recommending a moving path from the departure to the destination.

Moreover, the control unit 180 may recommend a moving path corresponding to the characteristics of the moving path. In more detail, the characteristics of the moving path may include at least one of a fast path, a comfortable path, and an inexpensive path. Then, the control unit 180 may display UIs 5231, 5232, and 5233 corresponding to a plurality of characteristics of a moving path.

Moreover, when an input for selecting the UI 5231 corresponding to a specific characteristic from the UIs 5231, 5232, and 5233 corresponding to a plurality of characteristics is received, the control unit 180 may display information 5240 on a moving path corresponding to a specific characteristic. Additionally, the control unit 180 may display a moving path 5221 corresponding to a specific characteristic on the map 5220.

Moreover, information 5240 on a moving path may include at least one of an expected time required and a cost. Besides that, the information 5240 on a moving path may display detailed information of a moving path and a bus number that a user uses.

Moreover, before a specific character is selected from a plurality of characteristics, the control unit 180 may display a recommendation path.

Herein, a recommendation path may be determined based on at least one of a path that a user selects previously with respect to the same destination, when the next schedule of a user is, and the degree of fatigue according to whether a user is active previously.

For example, when a user moves through a path 1 that is the fastest path with respect to the same destination, the control unit 180 may display a UI 5234 for representing a fast path.

As another example, when a user has a time to reach the destination on the basis of schedule information stored in the storage unit 170, the control unit 180 may display a UI for recommending an inexpensive path. Additionally, when a user has no time to reach the destination on the basis of schedule information stored in the storage unit 170, the control unit 180 may display a UI for recommending a fast path.

As another example, when it is determined that a user is tired due to many schedules on the basis of schedule information stored in the storage unit 170, the control unit 180 may display a UI for recommending a comfortable path.

Moreover, the comfortable path may be determined based on at least one of the number of transfers, a waking distance, a real-time car congestion, and the complexity of a route.

Moreover, the control unit 180 may display a UI 5250 for setting an automatic payment. Then, when an input on the UI 5250 for setting an automatic payment is received, in a case that a user boards the transportation means 5200, payment information for provisional approval transaction may be transmitted to the transportation means 5200 automatically.

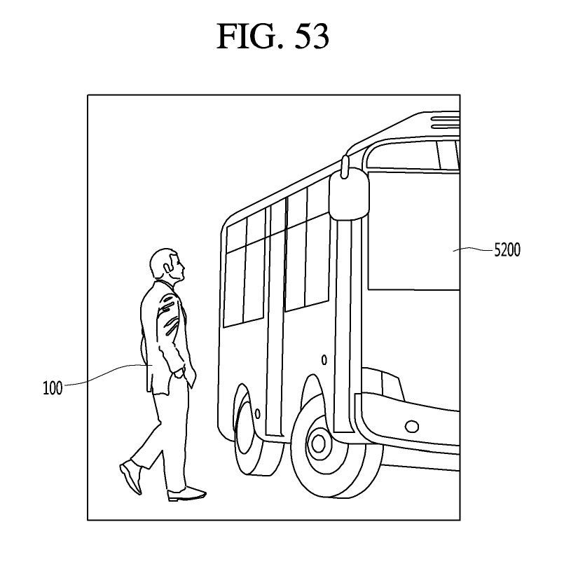

FIG. 53 is a view illustrating a user of the mobile terminal 100 boarding the transportation means 5200.

A communication unit (not shown) for transmitting a variety of information to the mobile terminal 100 and receiving information from the mobile terminal 100 may be mounted in the transportation means 5200. Additionally, the communication unit (not shown) of the transportation means 5200 may transmit a wireless signal for requesting a payment to the mobile terminal 5200.

Moreover, as a user of the mobile terminal 100 boards the transportation means 5200, when the mobile terminal 100 receives a wireless signal for requesting a payment from the mobile terminal 100, the control unit 180 may transmit payment information for provisional approval transaction to the communication unit (not shown) mounted in the transportation means 5200. In this case, the transportation means 5200 may transmit the payment information to the card company server (not shown) to request a provisional approval payment from the card company server (not shown).

Moreover, the control unit 180 may determine whether a user boards a transportation means moving through a path selected by a user.

In more detail, when a path selected by a user is identical to a path that the mobile terminal 100 moves, by using location information of the mobile terminal 100, the control unit 180 may determine that the user uses a transportation means that moves through the path selected by the user.

As another example, a wireless signal transmitted from the transportation means 5200 may include identification information of the transportation means 5200 and the control unit 180 may obtain information on a moving path of the transportation means 5200 by using the identification information of the transportation means 5200. In this case, when a moving path of the transportation means 5200 is identical to a path selected by a user, the control unit 180 may determine that the user uses a transportation means that moves through the path selected by the user

Moreover, when a path selected by a user is not identical to a path that the mobile terminal 100 moves, the control unit 180 may output a notification for notifying that another transportation means is required be used.

Moreover, although it is set that a user moves to a specific destination through a specific path, the user who changes his thought may board another transportation means in order to move to another path or another destination.

Accordingly, when a path selected by a user is not identical to a path that the mobile terminal 100 moves, the control unit 180 may display a screen for allowing a user to select a new destination or a new path. Moreover, when a path for a moving path of the transportation means 5200 is obtained by using identification information of the transportation means 5200, the control unit 180 may display information on a moving path of the transportation means 5200 and display a UI for selecting a new destination.

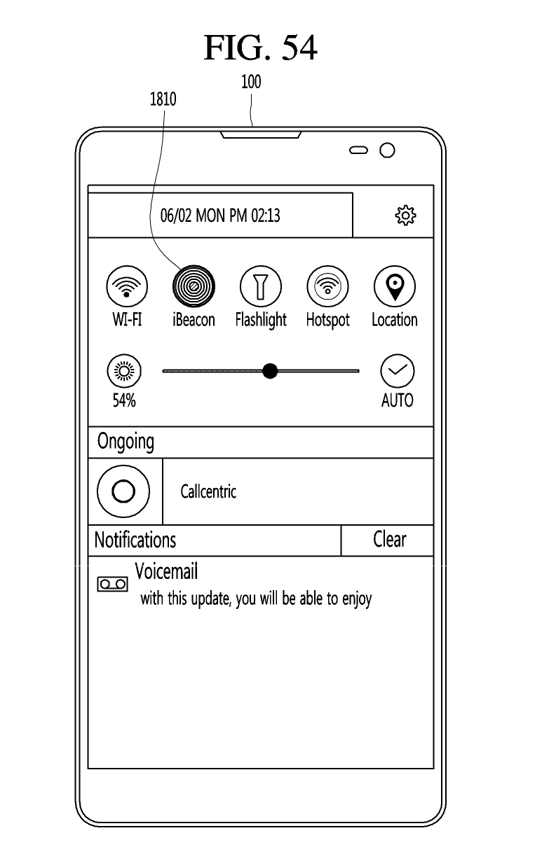

FIG. 54 is a view illustrating an operating method when a user of a mobile terminal boards the transportation means 5200.

It is described with reference to FIG. 52 that before a user boards the transportation means 5200, an itinerary management application is executed to guide a moving path to a user. However, the present invention is not limited thereto, and when a user boards the transportation means 5200, an itinerary management application may be executed.

The control unit 180 may determine that a user boards the transportation means 5200. In more detail, when a signal transmitted from a communication unit (not shown) of the transportation means 5200 is received, the control unit 180 may determine that a user of the mobile terminal 100 boards the transportation means 5200. However, the present invention is not limited thereto, and when a signal transmitted from a communication unit (not shown) of the transportation means 5200 is received and a movement of the mobile terminal 100 is not detected (for example, when a user holds a specific position in a vehicle and does not move), the control unit 180 may determine that a user of the mobile terminal 100 boards the transportation means 5200.

Moreover, when a user of the mobile terminal 100 boards the transportation means 5200, the control unit 180 may execute the itinerary management application and display the execution screen of the itinerary management application.

Additionally, when a signal transmitted from a communication unit (not shown) of the transportation means 5200 is received, the control unit 180 may activate a communication protocol to exchange information with the transportation means 5200.

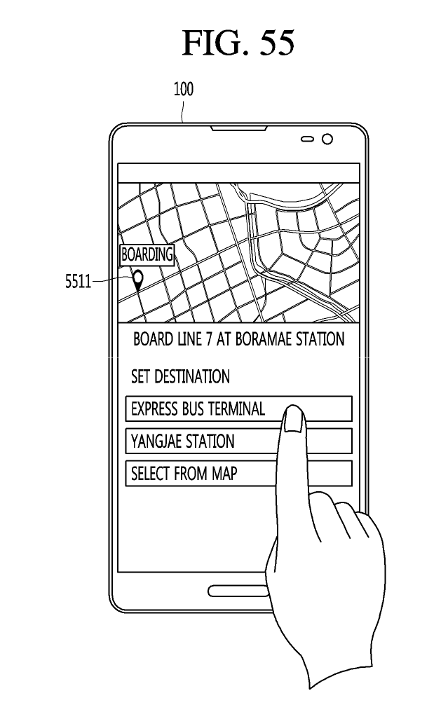

FIG. 55 is a view illustrating a destination setting method when an itinerary management application is executed after a user boards a transportation means according to an embodiment of the present invention.

When a user boards the transportation means 5300, the control unit 180 may obtain location information of the mobile terminal 100 to display a UI 5511 corresponding to a departure on a map.

For example, the control unit 180 may obtain location information of a user by obtaining coordinates information of the mobile terminal 100 through the wireless communication unit 110. As another example, the transportation means 5200 may obtain location information of the transportation means 5200 by using its navigation system, and transmit the location information to the mobile terminal 100 through a communication unit (not shown) of the transportation means 5200. In this case, the control unit 180 may obtain the location information of the mobile terminal 100 by obtaining the location information of the transportation means 5200 through the wireless communication unit 110.

Moreover, the control unit 180 may receive an input for setting a destination. In this case, the above-described destination setting method is applied as it is and thus its detailed description is omitted.

Moreover, when the transportation means 5200 is a bus, it is driven on the same path and thus, the control unit 180 may display at least one destination on a moving path of the transportation means 5200. Moreover, when an input for selecting a specific destination from at least one destination on a moving path is received, the control unit 180 may determine that the specific destination is a destination of a user of the mobile terminal 100. In this case, the moving path of the transportation means 5200 may be provided from a server (not shown).

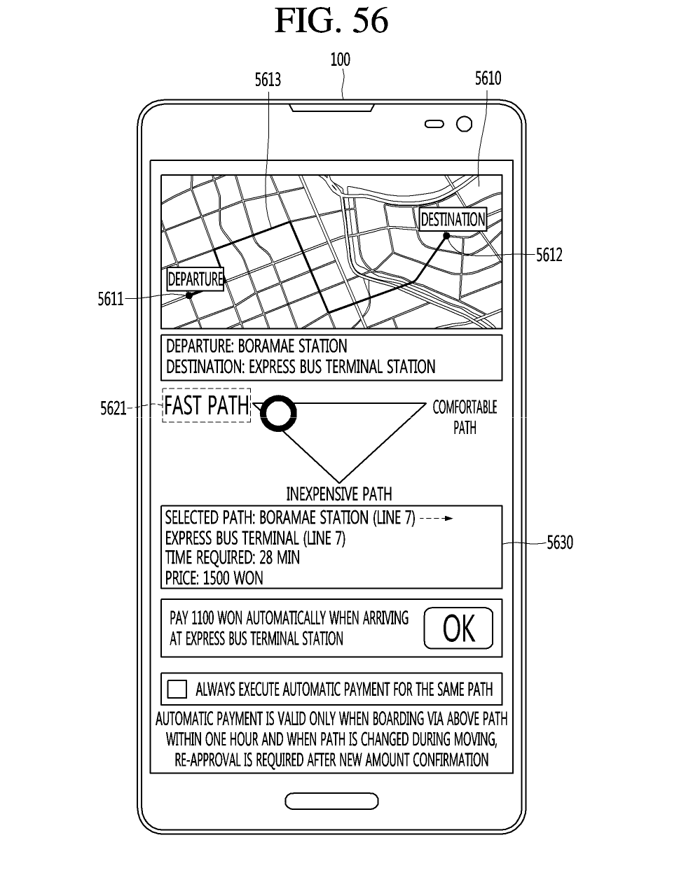

FIG. 56 is a view illustrating a method of providing information relating to a movement to a destination according to an embodiment of the present invention.

The control unit 180 may obtain information on the moving path of the transportation means 5200.

In more detail, when a wireless signal transmitted from the transportation means 5200 includes identification information of the transportation means 5200, the control unit 180 may transmit the identification information of the transportation means 5200 to a server and obtain information on a moving path of the transportation means 5200 by receiving the moving path of the transportation means 5200 from the server.

As another example, the transportation means 5200 may transmit information on a moving path through a communication unit (not shown) included in the transportation means 5200 and the control unit 180 may obtain information on the moving path transmitted from the transportation means 5200.

Moreover, the control unit 180 may display a moving path 5613 from a departure 5611 to a destination 5612 on a map 5610.

Additionally, the control unit 180 may display the current location of the transportation manes 5200, that is, the current location of a user of the mobile terminal 100, on the map 5610.

Additionally, the control unit 180 may display property information 5621 on the current moving path and display detail information 5630 on the current moving path. Herein, the detail information 5630 on a moving path may include at least one of a departure, a destination, a required time to destination, and a cost to destination.

Furthermore, the control unit 180 may receive an input for changing a destination of the transportation means 5200. In this case, the control unit 180 may display a UI for representing a location of the changed destination on a map. Additionally, the control unit 180 may display information on at least one of an elapse time after start, an expected required time to a changed destination, and an expected usage fee.

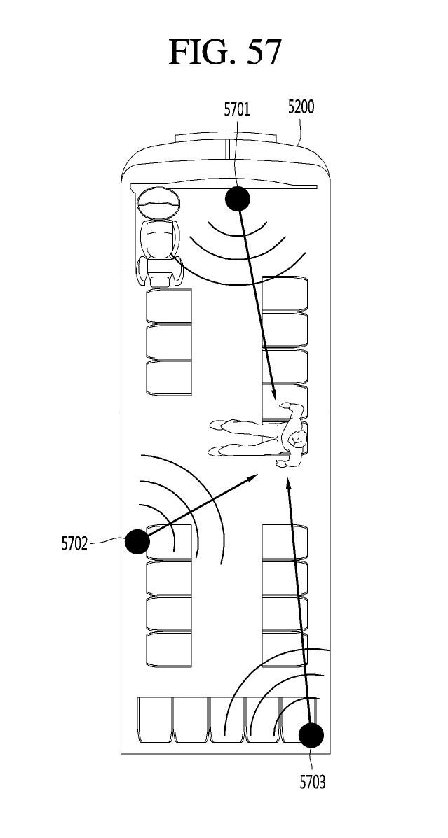

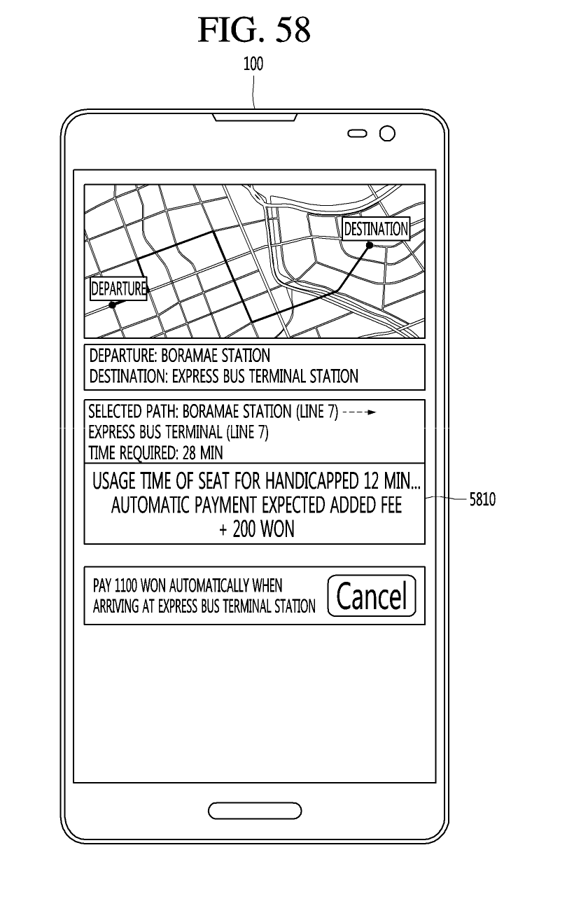

FIGS. 57 and 58 are views illustrating a method of charging an additional fee according to an embodiment of the present invention.

The transportation means 5200 may include at least one sensing unit 5701, 5702, and 5703 for identifying the location of a user of the mobile terminal 100. Moreover, the sensing units 5701, 5702, and 5703 may be mounted at seats.

Furthermore, the transportation means 5200 may include a plurality of seats and some seats may be general seats and some seats may be seats for handicapped persons. Herein, the seats for handicapped persons are seats prepared to care for handicapped persons, and if an ordinary person seats on the seats for handicapped persons, an additional fee may be charged.

Moreover, the transportation means 5200 may determine whether a user of the mobile terminal 100 seats on the seats for handicapped persons on the basis of a detection result of the sensing units 5701, 5702, and 5703. Moreover, when an ordinary person instead of a handicapped person seats on the seats for handicapped persons, the transportation means 5200 may charge an additional fee to a user of the mobile terminal 100. In this case, the additional fee may be charged in proportional to a time of seating on the seats for handicapped persons.

Moreover, as shown in FIG. 58, the transportation means 5200 may transmit information 5810 on an additional fee charged to a user of the mobile terminal 100 to the mobile terminal 100, and the control unit 180 may display the information 5810 on an additional fee charged to a user of the mobile terminal 100. Herein, the information 5810 on an additional fee may include information on at least one of a usage time of seats for handicapped persons and an additional fee charged by using seats for handicapped persons.

Moreover, the transportation means 5200 may transmit the information 5810 on an additional fee charged to a user of the mobile terminal 100 to the mobile terminal 100 by a specific time unit, and the control unit 180 may also display the information 5810 on an additional fee by a specific time unit.

However, the present invention is not limited thereto, after the information 5810 on an additional fee charged to a user of the mobile terminal 100 is displayed, when an input that confirms the additional fee is received, information on an additional fee, which is increased later, may not be additionally displayed.

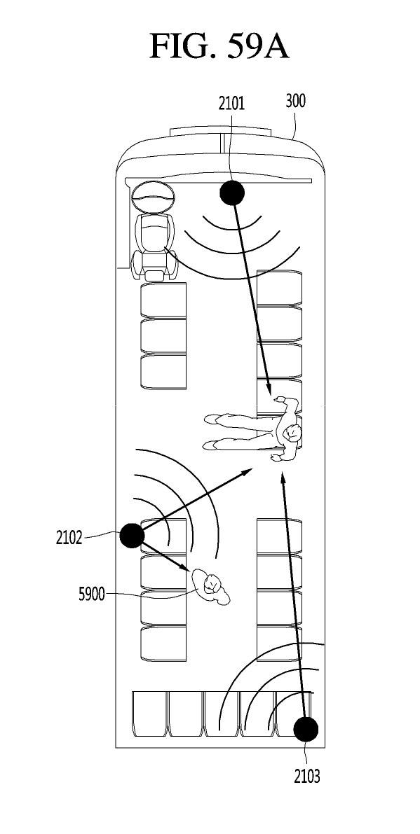

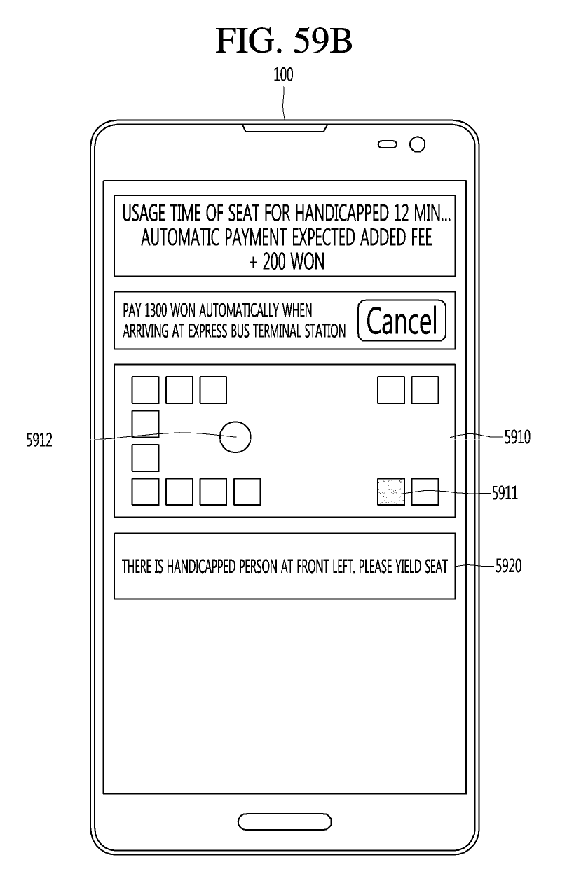

FIGS. 59A and 59B are views illustrating a method of providing a notification when a handicapped person boards according to an embodiment of the present invention.

Referring to FIG. 59A, a mobile terminal of another user 5900 registered as a handicapped person may transmit a wireless signal including information that the other user 5900 is a handicapped person to the transportation means 5200. In this case, the transportation means 5200 may obtain information on the location of the mobile terminal of the other user 5900 and transmit the obtained information on the location to the mobile terminal 100.

In this case, the control unit 180 may display handicapped person related information by using the information received from the transportation means 5200.

For example, the control unit 180, as shown in FIG. 59B, may display a seat map 5910 in the transportation means 5200 and display a seat 5911 where a user of the mobile terminal 100 seats differently.

Additionally, the control unit 180 may display a UI 5912 corresponding to a location of a handicapped person. Additionally, the control unit 180 may display a window 5920 including a text that there is a handicapped person at a specific location and please! yield a seat.

Moreover, this embodiment describes that an example of a handicapped person but the present invention is not limited thereto.

A different usage fee may be charged at each seat in a transportation means such as a train. For example, when a user of the mobile terminal 100, who performs a provisional approval payment for a second class fee, seats on a first class seat, an additional fee may be charged through the above method.

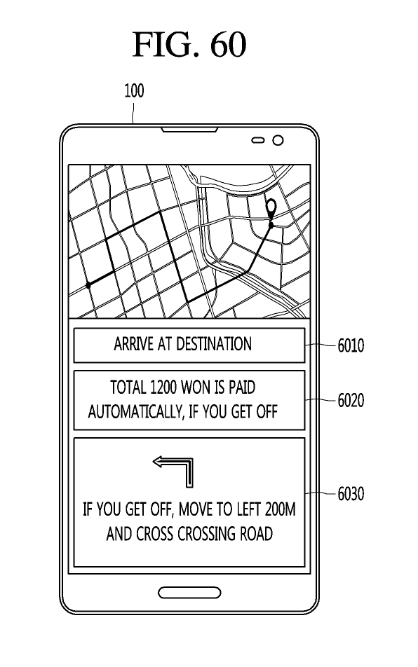

FIG. 60 is a view illustrating a display screen of a mobile terminal when the transportation means 5200 arrives at a destination according to an embodiment of the present invention.

The control unit 180 may obtain information that the transportation means 5200 arrives at a destination. In more detail, the control unit 180 may obtain information that the transportation means 5200 arrives at a destination on the basis of GPS coordinates information received through the wireless communication unit 110 and information on a destination stored in the storage unit 170. However, the present invention is not limited thereto, the control unit 180 may obtain the information that the transportation means 5200 arrives at the destination on the basis of the location information of the transportation means 5200 received from the transportation means 5200.

Moreover, when the transportation means 5200 arrives at the destination, the control unit 180 may display a UI 6010 for representing that the user arrives at the destination. Additionally, the control unit 180 may display an UI 6020 including information on an expected payment amount when getting off.

In this case, the information on an expected payment amount when getting off may be displayed when a user is disposed at an exit. In more detail, the transportation means 5200 may include a communication unit (not shown) at an exit of the transportation means 5200 and when a user of the mobile terminal 100 moves to the exit and the terminal 100 receives a wireless signal of the communication unit (not shown) mounted at the exit of the transportation means 5200, the control unit 180 of the mobile terminal 100 may display information on an expected payment amount when getting off.

Additionally, when a user gets up from a seat, the information on an expected payment amount may be displayed when getting off.

Furthermore, the control unit 180 may output a notification for inducing the getting off of a user of the mobile terminal 100. For example, when the mobile terminal 100 is close to a destination but a movement of a user of the mobile terminal 100 is not sensed as sensing a movement of the mobile terminal 100, the control unit 180 may output a notification for inducing the getting off of a user of the mobile terminal 100. As another example, when the mobile terminal 100 is close to a destination but a wireless signal is not received from a communication unit (not shown) mounted at the exit of the transportation means 5200, the control unit 180 may output a notification for inducing the getting off of a user of the mobile terminal 100.

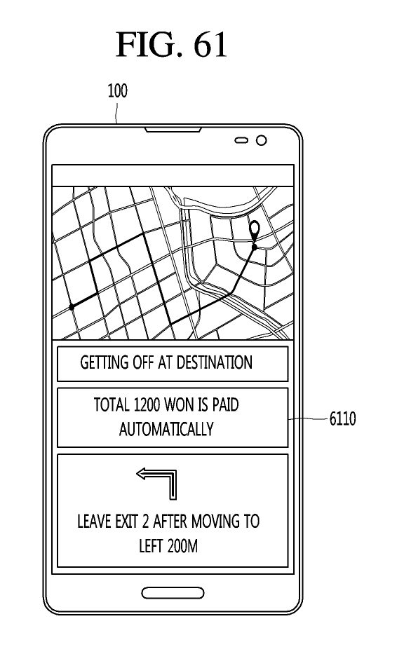

FIG. 61 is a view illustrating a method of detecting the getting off of the mobile terminal 100 and calculating a fee according to an embodiment of the present invention.

The transportation means 5200 may obtain information that a user of the mobile terminal gets off on the basis of a detection result from at least one sensing unit included in the transportation means 5200.

Moreover, the transportation means 5200 may request the cancellation of a provisional approval payment and the actual transaction approval from a card company server (not shown).

When a provisional approval payment is performed as a user of the mobile terminal 100 boards the transportation means 5200, a payment for guarantee amount is approved.

In this case, the transportation means 5200 may request the cancellation of a payment for guarantee amount (for example, the cancellation of a provisional approval payment) and the approval of a transaction for usage fee to a destination (for example, an actual transaction approval) from a card company server (not shown). Herein, a usage fee to a destination may include an additional fee charged to a user of the mobile terminal 100 in addition to a transfer fee to a destination.

In this case, the card company server (not shown) cancels the payment for guarantee amount and approves the actual transaction for a usage fee to a destination.

Moreover, when a provisional approval transaction is completed, that is, after a provisional approval payment is approved, when the provisional approval payment is cancelled and an actual transaction for usage fee to a destination is approved, the card company server (not shown) may transmit information on a usage fee to a destination where an actual transaction is approved, to the mobile terminal 100.

In this case, the control unit 180 may display information 6110 on a usage fee through which an actual transaction is approved.

Moreover, a transportation fee payment system including a mobile terminal, a transportation fee, and a server according to an embodiment of the present invention is described.

A mobile terminal (not shown) may transmit payment information for a provisional approval transaction to the transportation means 3900 or 5200.

In this case, the transportation means 3900 or 5200 may transmit payment information for a provisional approval transaction to a server, and request the approval of a payment for guarantee amount from a server.

Moreover, a server (not shown) that receives payment information for a payment approval transaction and receives a request for approving a payment for a guarantee amount may approve the payment for a guarantee amount on the basis of the payment information for a provisional approval transaction, and transmit information on a result obtained by approving the payment for a guarantee amount, to the transportation means 3900 or 5200.

Moreover, the transportation means 3900 that receives information on the result obtained by approving the payment for a guarantee amount may move to the transportation means 3900 or 5200.

Moreover, when the getting off of a user of a mobile terminal is detected, the transportation means 3900 or 5200 may request the cancellation of a payment for guarantee amount and the approval of an actual transaction for a usage fee to a destination from a server (not shown).

Moreover, a server (not shown) that receives a request of the cancellation of a payment for guarantee amount and the approval of an actual transaction for a usage fee to a destination may cancel a payment for a guarantee amount, approve an actual transaction for a usage fee to a destination, and transmit information on the usage fee to the destination to the mobile terminal 100.

Furthermore, the mobile terminal 100 that receives the information on the usage fee to the destination may display information on the usage fee to the destination.

Moreover, the embodiments of FIGS. 39 to 61 describe a method of performing a payment through a provisional approval transaction method. However, the present invention is not limited thereto and a payment may be performed through a general transaction method. Moreover, when a payment is performed through a general transaction method, as described above, embodiments in which a payment is performed through a fixed transaction method may be applied.

Moreover, when a user boards the transportation means 3900, the control unit 180 may transmit first payment information to the transportation means 3900 or 5200.

Moreover, as described with reference to FIG. 51, when a destination, a transition, and a moving path are set before a user boards a transportation means, the control unit 180 may transmit the first payment information to the transportation means 3900 (for example, an unmanned taxi) in addition to information on at least one of a destination, a transition, and a moving path of the transportation means 3900.

Moreover, when the transportation means 3900 or 5200 receives the first payment information, the transportation means 3900 or 5200 may transmit payment information and information on a fee to a card company server (not shown). Herein, the fee may be a basic fee for using the transportation means 3900 or 5200.

Moreover, the card company server (not shown) may approve a transaction for a basic fee by using the first payment information. In this case, the card company server (not shown) may transmit a basic fee and information that a transaction for the basic fee is approved to the mobile terminal 100, and the mobile terminal 100 may display information on the basic fee.

Additionally, the card company server (not shown) may transmit the information that the transaction for the basic fee is approved to the transportation means 3900 (for example, an unmanned taxi) and in this case, and in this case, the transportation means 3900 (for example, an unmanned taxi) may unlock the door to allow a user to board.

Moreover, the transportation means 3900 or 5200 may calculate an additional fee (for example, a transfer fee that is additionally charged as a transportation means moves in addition to a basic fee that is initially charged when boarding a transportation means, a fee that is additionally charged as a user seats on a seat for handicapped persons, and a fee that is additionally charged as a user in a second class seats on a seat in a first class) charged to a user of the mobile terminal 100. Additionally, the transportation means 3900 or 5200 may transmit information on an additional fee to the mobile terminal 100.

Moreover, before a user of the mobile terminal 100 gets off, the control unit 180 may transmit second payment information for the payment of an additional fee to the transportation means 3900 or 5200.

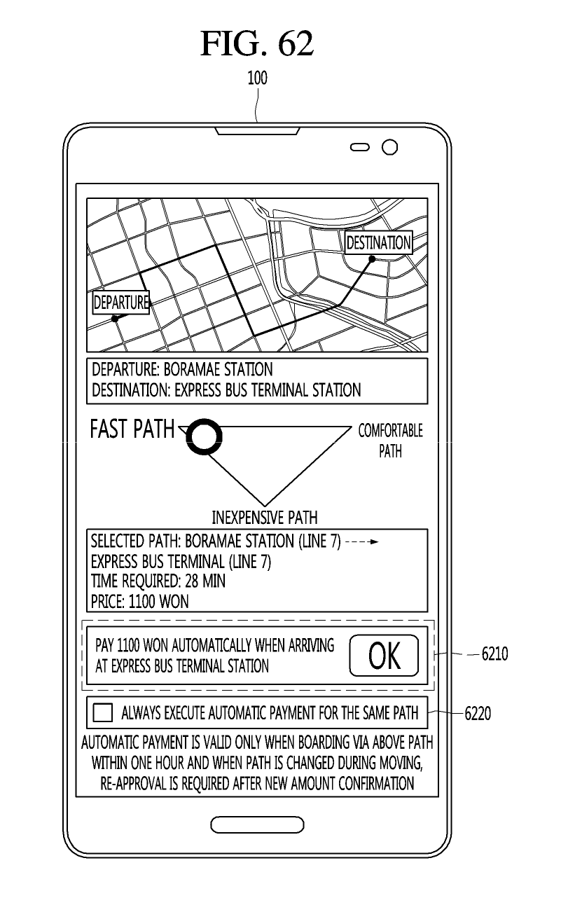

In more detail, FIG. 62 is a view illustrating a screen of a mobile terminal where a UI 6210 for setting an automatic payment is displayed, and when a user selects an option 6210 for performing a payment automatically and the transportation means 3900 or 5200 arrives at a destination, the control unit 180 may transmit second payment information for an additional fee payment to the transportation means 3900 or 5200.

Besides that, when a user selects the UI 6210 for performing a payment automatically and is disposed at the exit of the transportation means 5200, the control unit 180 may transmit second payment information for an additional fee payment to the transportation means 3900 or 5200.

Moreover, when a user does not select the UI 6210 for performing a payment automatically, a payment is performed manually, that is, through a method of transmitting second payment information according to an input of a user of the mobile terminal 100 (or a method of directly tagging the mobile terminal 100 to a payment terminal in the transportation means 3900 or 5200), and when a user does not transmit second payment information, a fine is added later.

Moreover, when the transportation means 3900 or 5200 receives the second payment information, the transportation means 3900 or 5200 may transmit the second payment information and information on a fee to a card company server (not shown). Herein, the fee may be an additional fee charged during the use of the transportation means 3900 or 5200.

Moreover, a card company server (not shown) may approve a transaction of the additional fee by using payment information and transmit information on the amount obtained by finally approving the transaction to the mobile terminal 100. In this case, the card company server (not shown) may transmit the additional fee and information that the transaction for the additional fee is approved, to the mobile terminal 100, and the mobile terminal 100 may display information on the finally approved additional fee.

Moreover, when a payment is performed through a general transaction method, it may be performed by using one-time payment information in a first mode, that is, a mode of general transaction. In more detail, although it is described with reference to FIGS. 39 to 61 that fixed payment information for provisional approval transaction is transmitted from the mobile terminal 100 to the transportation means 3900 or 5200, at least one of the first payment information and the second payment information, transmitted in a first mode, may be one-time payment information for general transaction.

The one-time payment information may include a one-time token and an authentication value linked with a payment time.

Herein, the one-time token is a virtual card number that replaces an actual card number of a card used for a payment and may be provide from a card company server. Additionally, the authentication value, as a virtual authentication value that replaces an actual card number authentication value (for example, a CVV), may be provided from a card company server.

Moreover, the control unit 180 may store a one-time token and an authentication value in the storage unit 170. In this case, the one-time token and the authentication value may be stored in a separated security area in the storage unit 170.

Moreover, the control unit 180 may generate one-time payment information including a one-time token and an authentication value linked with a fingerprint authentication time by using the one-time token and the authentication value stored in the storage unit 170.

Moreover, when the first payment information, i.e., one-time payment information, is transmitted from the mobile terminal 100 to the transportation means 3900 or 5200, the transportation means 3900 or 5200 that receives the one-time payment information may transmit the one-time payment information and information on a fee to a card company server (not shown). Moreover, when a card company server (not shown) compares a one-time token and an authentication value included in one-time payment information with a token and an authentication value stored in the card company server (not shown) and they correspond to each other, a transaction for basic fee may be approved.

Additionally, when the second payment information, i.e., one-time payment information, is transmitted from the mobile terminal 100 to the transportation means 3900 or 5200, the transportation means 3900 or 5200 that receives the one-time payment information may transmit the one-time payment information and information on an additional fee to a card company server (not shown). Moreover, when a card company server (not shown) compares a one-time token and an authentication value included in one-time payment information with a token and an authentication value stored in the card company server (not shown) and they correspond to each other, a transaction for additional fee may be approved.

Additionally, information transmitted from the mobile terminal 100 to the transportation means 3900 or 5200 is not limited to payment information for credit card payment, and may be payment information of a transportation card in which an amount for using the transportation means 3900 or 5200 is charged in advance.

Moreover, information relating to the use of a user's transportation means may be stored in the storage unit 170.

Moreover, the control unit 180 may display a UI 6220 for setting whether to perform an automatic payment on the same path. Moreover, when it is set that an automatic payment is executed by a user input, the control unit 180 may execute an automatic payment without an additional user input when a user moves using the same path to the same destination.

In such a way, the present invention may provide an environment in which a user uses a transportation means without an operation for paying a fee even if a payment is performed through a general transaction method in addition to a provisional approval transaction method.

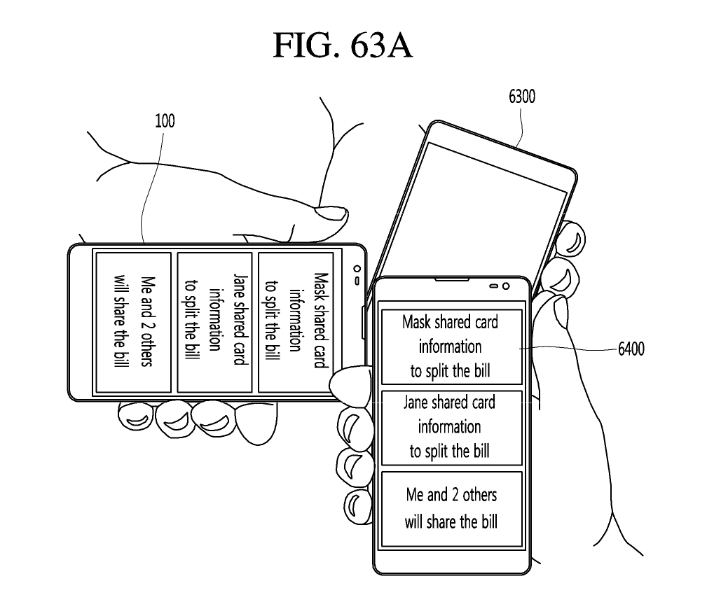

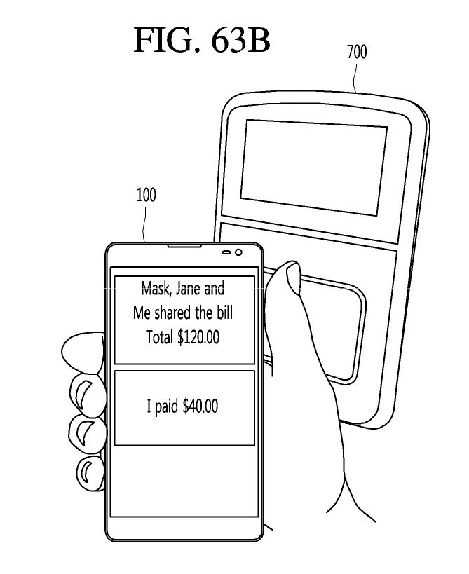

FIGS. 63A and 63B are views illustrating a fee payment method according to another embodiment of the present invention.

As shown in FIG. 63a, a plurality of mobile terminals 100, 6300, and 6400 may share card information with each other.

In more detail, the first mobile terminal 100 among the plurality of mobile terminals 100, 6300, and 6400 may receive card information of the other mobile terminals 6300 and 6400 and store it. In the same manner, the second mobile terminal 200 may also receive card information of the other mobile terminals 100 and 6400 and store it and the third mobile terminal 6400 may also receive card information of the other mobile terminals 100 and 6300 and store it.

In this case, the shared card information may be valid within a specific time, and after the specific time elapses, may be deleted from the storage unit 170.

Moreover, one of the plurality of mobile terminals 100, 6300, and 6400 may transmit payment information to the transportation means 3900 or 5200. Although it is described with reference to FIG. 63B that payment information is transmitted by tagging to the POS terminal 700, the present invention is not limited thereto, and the above-mentioned all methods of transmitting payment information may be applied. Additionally, the present invention is not limited to the transmitting of the payment information to the transportation means 3900 or 5200 and may be applied to all businesses that receive payment information through a POS terminal. Moreover, a mobile terminal that transmits payment information to the transportation means 3900 or 5200 may be determined according to which terminal is tagged to the POS terminal 700 first.

Moreover, when it is assumed that the first mobile terminal 100 transmits payment information to the transportation means 3900 or 5200, the control unit 180 of the first mobile terminal 100 may transmit payment information of the second and third mobile terminal 6300 and 6400 in addition to payment information of the first mobile terminal 100 to the transportation means 3900 or 5200.

In this case, only with a one-time tagging operation, all payment information of the first, second, and third mobile terminals may be transmitted. However, the present invention is not limited thereto, and while a three-times tagging operation is performed, payment information of the first, second, and third mobile terminals may be transmitted separately.

Moreover, when payment information of the first, second, and third mobile terminals is transmitted, a split fee obtained by dividing a total usage fee may be charged to each of the first, second, and third mobile terminals.

Moreover, a deputy payment through sharing card information may be performed only within a predetermined amount range. In this case, a user may set a predetermined range of an amount with which a payment is available through the setting of a marginal cost.

On the other hand, when the POS terminal 700 does not support a split payment, the first mobile terminal 100 may transmit only the payment information of the first mobile terminal 100 to the POS terminal 700. In this case, the card transaction is approved by using only the payment information of the first mobile terminal 100 and the control unit 180 may receive a transferred split amount from the other mobile terminals 6300 and 6400 by using the card information of users of the other mobile terminals 6300 and 6400.

The control unit 180, as a component responsible for controlling a device generally, may be used interchangeably with the term of a central processing device, a micro processor, and a processor.

The invention can also be embodied as computer readable codes on a computer readable recording medium. The computer readable recording medium is any data storage device that can store data which can be thereafter read by a computer system. Examples of the computer readable recording medium include magnetic storage media (e.g., ROM, floppy disks, hard disks, etc.) and optical recording media (e.g., CD-ROMs, or DVDs) and carrier waves (e.g., transmission through the Internet). Additionally, the computer may include the control unit 180 of a terminal. Accordingly, the detailed description is not construed as being limited in all aspects and should be considered as illustrative. The scope of the invention should be determined by reasonable interpretation of the appended claims, and all modifications within equivalent ranges of the present invention are included in the scope of the present invention.

What is claimed is:

1. An operating method of a mobile terminal, the method comprising:
determining a payment mode of the mobile terminal; and
when the payment mode of the mobile terminal is a first mode for general transaction, performing a payment by using one-time payment information and when the payment mode of the mobile terminal is a second mode for provisional approval transaction, performing a payment by using fixed payment information.

2. The method according to claim 1, further comprising, on the basis of at least one of coordinates information of the mobile terminal and signal information received by the mobile terminal, obtaining information on a transaction method at a business where the mobile terminal is disposed.

3. The method according to claim 2, further comprising, on the basis of information on the transaction method at the business where the mobile terminal is disposed, when the transaction method at the business where the mobile terminal is disposed is the provisional approval transaction, outputting a notification for representing that the transaction method at the business where the mobile terminal is disposed is the provisional approval transaction.

4. The method according to claim 1, wherein the determining of the payment mode of the mobile terminal comprises, in a state that the payment mode of the mobile terminal is the first mode, in accordance with an input for switching the payment mode of the mobile terminal to the second mode being received, switching the payment mode of the mobile terminal to the second mode, and the performing of the payment comprises, in accordance with the payment mode of the mobile terminal being switched to the second mode, performing a payment by using the fixed payment information.

5. The method according to claim 1, wherein the performing of the payment comprises:
when the payment mode of the mobile terminal is the first mode, generating one-time payment information including a one-time token and an authentication value linked with a payment time and transmitting the generated one-time payment information to a POS terminal; and
when the payment mode of the mobile terminal is the second mode, generating fixed payment information including a fixed token and transmitting the generated fixed payment information to a POS terminal.

6. The method according to claim 5, wherein the fixed payment information further comprises information on a location of the mobile terminal, and the information on the location of the mobile terminal is obtained based on at least one of coordinates information of the mobile terminal and signal information received by the mobile terminal.

7. The method according to claim 1, wherein the performing of the payment comprises, when a payment is cancelled while the payment is performed in the second mode or a payment being performed in the second mode is completed, renewing the fixed token included in the fixed payment information.

8. The method according to claim 1, wherein the performing of the payment by using the fixed payment information when the payment mode of the mobile terminal is the second mode for provisional approval transaction comprises:
transmitting the fixed payment information to a transportation means;
if the transportation means moves to a destination in accordance with a provisional approval payment using the fixed payment information being approved, obtaining information on a usage fee of the transportation means; and
displaying information on the usage fee of the transportation means.

9. A mobile terminal comprising:
a wireless communication unit to transmit payment information; and
a control unit to determine a payment mode of the mobile terminal; and when the payment mode of the mobile terminal is a first mode for general transaction, perform a payment by using one-time payment information and when the payment mode of the mobile terminal is a second mode for provisional approval transaction, perform a payment by using fixed payment information.

10. The mobile terminal according to claim 9, wherein the control unit obtains information on a transaction method at a business where the mobile terminal is disposed, on the basis of at least one of coordinates information of the mobile terminal received through the wireless communication unit and signal information received through the wireless communication unit.

11. The mobile terminal according to claim 10, further comprising a display unit to display an image,
wherein the control unit controls the display unit to display a UI for representing that, on the basis of information on the transaction method at the business where the mobile terminal is disposed, when the transaction method at the business where the mobile terminal is disposed is the provisional approval transaction, the transaction method at the business where the mobile terminal is disposed is the provisional approval transaction.

12. The mobile terminal according to claim 9, further comprising an input unit to receive an input from a user,
wherein the control unit, in a state that the payment mode of the mobile terminal is the first mode, in accordance with an input for switching the payment mode of the mobile terminal to the second mode being received, switches the payment mode of the mobile terminal to the second mode, and in accordance with the payment mode of the mobile terminal being switched to the second mode, performs a payment by using the fixed payment information.

13. The mobile terminal according to claim 9, wherein the control unit, when the payment mode of the mobile terminal is the first mode, generates one-time payment information including a one-time token and an authentication value linked with a payment time and transmits the generated one-time payment information to a POS terminal through the wireless communication unit; and
when the payment mode of the mobile terminal is the second mode, generates fixed payment information including a fixed token and transmits the generated fixed payment information to a POS terminal through the wireless communication unit.

14. The mobile terminal according to claim 13, wherein the fixed payment information further comprises information on a location of the mobile terminal, and the information on the location of the mobile terminal is obtained based on at least one of coordinates information of the mobile terminal and signal information received by the mobile terminal.

15. The mobile terminal according to claim 9, wherein the control unit, when a payment is cancelled while the payment is performed in the second mode or a payment being performed in the second mode is completed, renews (or changes) the fixed token included in the fixed payment information.

16. The mobile terminal according to claim 9, wherein the control unit, when the payment mode of the mobile terminal is the first mode, generates first one-time payment information, performs a primary payment by transmitting the generated first one-time payment information to a POS terminal, generates second one-time payment information for canceling the primary payment and third one-time payment information for an actual transaction payment, and performs a secondary payment by transmitting the generated second one-time payment information and the generated third one-time payment information to the POS terminal.

17. The mobile terminal according to claim 9, further comprising a display unit to display an image,
wherein the control unit controls the display unit to, when the payment mode of the mobile terminal is the second mode for provisional approval transaction, transmit the fixed payment information to a transportation means through the wireless communication unit, if the transportation means moves to a destination in accordance with a provisional approval payment using the fixed payment information being approved, obtain information on a usage fee of the transportation means, and display information on the usage fee of the transportation means.

18. The mobile terminal according to claim 17, wherein the control unit receives a wireless signal transmitted from the transportation means through the wireless communication unit, and when the wireless signal is received, transmits the fixed payment information to the transportation means.

19. The mobile terminal according to claim 17, further comprising an input unit to receive an input from a user,
wherein the control unit receives an input for setting a destination of a user of the mobile terminal through the input unit, and transmits information on the destination to the transportation means through the wireless communication unit on the basis of the received input.

20. The mobile terminal according to claim 17, wherein the control unit, when the transportation means arrives at the destination and an actual transaction for a usage fee to the destination is approved, obtains and displays information on the usage fee obtained when the actual transaction is approved.
